(19) United States
(12) Patent Application Publication
(10) Pub. No.: US 2005/0247411 A1
(43) Pub. Date: Nov. 10, 2005

(54) Door cover systems and methods

(76) Inventor: Youngtak Shim, Port Moody (CA)

Correspondence Address: Youngtack Shim, 155 Aspenwood Drive, Port Moody, BC, Y3H 5A5, CA

(21) Appl. No.: 10/838,009

(22) Filed: May 4, 2004

(51) Int. Cl. E06B 3/48

(52) U.S. Cl. 160/84.07

(57) ABSTRACT

The present invention generally relates to various door cover systems capable of covering at least a portion of a target space defined in a vicinity of a door opening of an article in order to protect a person or an object disposed in such a portion of the target space from being exposed to weather conditions or precipitations such as rain and snow. The door cover systems of the present invention are also arranged to be removed from and, accordingly, to uncover such a portion of the target space when the person or object leaves the target space. As will be described in greater detail below, such cover systems of the present invention may be practiced by numerous embodiments each of which may include one or more movable door cover members which are arranged to cover and uncover the target space in relation to movements of the doors, paths of such movements, and/or presence of the person or object in the target space. The present invention also relates to various methods of using or providing such cover systems and/or their cover members for covering such a portion of the target space. In addition, the present invention relates to various processes of making such cover systems and/or their cover members. Various door cover systems, methods, and/or processes of the present invention may be advantageously applied to conventional doors of automobiles so as to allow drivers or passengers to get into or out of the automobile without getting wet from the rain or snow. The door cover systems, methods, and/or processes of the present invention may be applied to conventional door-door opening assemblies used for other vehicles and for structures such as houses, buildings, and the like.

The present application claims a benefit of an earlier conception date of a Disclosure Document entitled “Door Cover Systems,” filed on May 17, 2002, and having the Ser. No. 511,797, an entire portion of which is incorporated herein by reference.

### FIELD OF THE INVENTION

The present invention generally relates to various door cover systems capable of covering a target space defined in a vicinity of a door opening of an article and capable of protecting an object disposed in the target space from being exposed to rain and snow. The door cover systems of this invention are also arranged to be removed from and, therefore, to uncover the target space when the object leaves the target space. As will be described in greater detail below, the door cover systems of this invention can be practiced by numerous embodiments each including one or more movable door cover members which are arranged to cover and to uncover the target space in relation to movement of the doors and/or presence of the object in the target space. The present invention also relates to various methods of covering the target space by various door cover systems of the present invention as well as various processes of providing such door cover systems. Various door cover systems, methods, and/or processes of the present invention may be advantageously applied to conventional doors of automobiles to allow drivers or passengers to get into or to get out of the automobile without being wet from the rain or snow. The door cover systems, methods, and/or processes of the present invention may be applied to conventional door-door opening assemblies used for other vehicles such as airplanes, surface vessels, and so on, and also to structures such as houses, buildings, and the like.

### BACKGROUND OF THE INVENTION

Automobiles are equipped with doors capable of isolating their interior (or cabin) spaces from exterior environment. To get in and out of the automobile, however, a driver or passenger is exposed to the exterior environment. This poses a problem during the rain or snow, because the person who wants to stay dry has to depend on motor skills of how fast he or she may open the door and get into the cabin space. Even when the person carries an umbrella, he or she cannot help getting wet while opening the door, folding the umbrella, and closing the door or vice versa. Furthermore, in an ungodly rain or storm accompanied by strong wind, just unfolding or folding up the umbrella may amount to a taunting task, while the wind sprays the rain over the person and carries the rain into the cabin space to wet and damage items stored in a side compartment of the door of the automobile and, even worse, to short electrical equipment disposed therein such as, e.g., window controllers, automatic locks, and so on. Installing rain guards on a body above the door of the automobile may remedy the problem, for such rain guards may provide a temporary cover for the person to escape from precipitation until he or she may successfully unfold or fold the umbrella. However, such guards have to be permanently installed into the body of the automobile and, accordingly, cause various disadvantages such as, e.g., increasing hydraulic resistance of such an automobile, making noise during driving, hitting pedestrians or other objects thereby, and the like. Doors of the houses and buildings suffer from he same problem such that people and objects outside such doors are exposed to the rain or snow without rain guards properly built in front of or above such doors. Providing conventional rain guards, however, does not solve the problem because the guards may not be sturdy to endure strong winds, may not match the aesthetics of the houses or buildings, may require approval from local governments, and the like.

Therefore, there is a need to provide door cover systems and method therefor so as to cover a preset space in front of the doors and to protect persons and objects disposed under such a cover from being directly exposed to the exterior weather conditions and to uncover the target space when the persons and objects are no longer in the target space.

### SUMMARY OF THE INVENTION

The present invention generally relates to various door cover systems capable of covering at least a portion of a target space defined in a vicinity of a door opening of an article in order to protect a person or an object disposed in such a portion of the target space from being exposed to weather conditions or precipitations such as rain and snow. The door cover systems of the present invention are also arranged to be removed from and, accordingly, to uncover such a portion of the target space when the person or object leaves the target space. As will be described in greater detail below, such cover systems of the present invention may be practiced by numerous embodiments each of which may include one or more movable door cover members which are arranged to cover and uncover the target space in relation to movements of the doors, paths of such movements, and/or presence of the person or object in the target space. The present invention also relates to various methods of using or providing such cover systems and/or their cover members for covering such a portion of the target space. In addition, the present invention relates to various processes of making such cover systems and/or their cover members. Various door cover systems, methods, and/or processes of the present invention may be advantageously applied to conventional doors of automobiles so as to allow drivers or passengers to get into or out of the automobile without getting wet from the rain or snow. The door cover systems, methods, and/or processes of the present invention may be applied to conventional door-door opening assemblies used for other vehicles and for structures such as houses, buildings, and the like.

In one aspect of the present invention, a cover system may be provided for various door-door opening assemblies with at least one door and at least one door opening, where the door is movably installed to an article and where the door opening is defined through the article, used as an entrance to an interior of the article and/or an exit to an exterior of the article, defines a target space adjacent thereto.

In one exemplary embodiment, a cover system includes at least one cover member arranged to be installed to the door and/or article, to cover at least a portion of the target space when a person or an object is placed in or passes through the portion of the target space, and to uncover such a portion of the target space when the person or object is no longer in such a portion of the target space.

In another exemplary embodiment, a cover system includes at least one cover member which is arranged to be installed to the door and/or article, where at least a portion of such a cover member is arranged to fold and unfold in order to cover and uncover at least a portion of the target space.

In another exemplary embodiment, a cover system includes at least one cover member which is arranged to be installed to the door and/or article, where at least a portion of such a cover member is arranged to roll and unroll in order to cover and uncover at least a portion of the target space.

In another exemplary embodiment, a cover system includes at least one cover member which is arranged to be installed to the door and/or article, where at least a portion of such a cover member is arranged to stack and unstack in order to cover and uncover at least a portion of the target space.

In another exemplary embodiment, a cover system includes at least one cover member which is arranged to be installed to the door and/or article, where at least a portion of such a cover member is arranged to rotate, pivot, and/or slide between different positions in order to cover and uncover at least a portion of the target space.

In another exemplary embodiment, a cover system includes at least one cover member which is arranged to be installed to the door and/or article, where at least a portion of such a cover member is arranged to deform and restore its original configuration in order to cover and to uncover at least a portion of the target space.

In another exemplary embodiment, a cover system includes at least one cover member which is arranged to be installed to the door and/or article and to provide at least one covering movement in a covering timing and at least one uncovering movement in an uncovering timing in order to cover and to uncover at least a portion of the target space, respectively. Such covering and/or uncovering timings may be arranged to depend at least partially and respectively upon an opening timing and/or a closing timing of movement of the door so as to unobstruct and obstruct at least a portion of the door opening, respectively.

In another exemplary embodiment, a cover system includes at least one cover member which is arranged to be installed to the door and/or article and to generate at least one covering movement along a covering path and at least one uncovering movement along an uncovering path so as to cover and to uncover at least a portion of the target space, respectively. Such covering and/or uncovering paths may be arranged to depend at least partially and respectively upon an opening path and/or a closing path of the door along which the door is arranged to move in order to unobstruct and obstruct at least a portion of the door opening, respectively.

In another exemplary embodiment, a cover system includes at least one cover member which is arranged to be installed to the door and/or article and to provide at least one covering movement by a covering force and at least one uncovering movement by an uncovering force in order to cover and uncover at least a portion of the target space, respectively. At least a portion of such covering and/or uncovering forces may be arranged to be at least partially provided by an opening force and a closing force of the door through which the door is arranged to open and close the door, respectively.

In another aspect of the present invention, a cover system is provided to cover and uncover at least a portion of a target space which is formed adjacent to at least one door opening for at least one door arranged to be movably coupled to an article. Such a door opening is defined through the article as an entrance to an interior of the article and/or an exit to an exterior of the article, while the door is arranged to move between at least one open position and at least one closed position thereof in order to unobstruct and obstruct at least a portion of the door opening, respectively.

In one exemplary embodiment, a cover system includes at least one cover member which may be arranged to be installed to the door and/or article, and to move between at least one on-position for covering the portion of the target space and at least one off-position for uncovering the portion of the target space.

In another exemplary embodiment, a cover system includes at least one cover member which is arranged to be installed to the door and/or article, and to move between at least one on-position for covering the portion of the target space and at least one off-position for uncovering the portion of the target space in a temporal, spatial, and/or complementary relation to the door which moves between the open and closed positions.

In another exemplary embodiment, a cover system includes at least one cover member which is arranged to be installed to the door and/or article and to provide movement between at least one on-position and at least one off-position thereof, where the cover member may be arranged to cover the portion of the target space in the on-position, and to uncover the portion of the target space in the off-position. In one example, at least a portion of the cover member may be arranged to fold and unfold, roll and unroll, stack and unstack, slide, translate, rotate, and/or pivot during the movement thereof. In another example, such a cover member may be arranged to deform at least a portion thereof and/or to change its configuration during the movement thereof.

In another exemplary embodiment, a cover system includes at least one cover member which is arranged to be installed to the door and/or article and to provide movement between at least one on-position and at least one off-position thereof. The movement of the cover member may be arranged to be in a temporal, spatial, and/or complementary relation to the movement of the door between the open and closed positions thereof, where such a cover member may be arranged to cover such a portion of the target space in the on-position and to uncover the portion of the target space in the off-position. In one example, at least a portion of the cover member may be arranged to stack and unstack, roll and unroll, fold and unfold, translate, reciprocate, slide, rotate, and/or pivot during the movement thereof. In another example, the cover member may be arranged to deform at least a portion thereof during the movement thereof.

In another aspect of the present invention, a door-door opening assembly may be provided to include at least one door, at least one door opening, and at least one cover member, where the door may be arranged to be movably installed into an article and where the door opening may be arranged to be defined through the article, to be used as an entrance to an interior of the article and/or an exit to an exterior of the article, and to define a target space adjacent thereto. In one exemplary embodiment, the cover member may be arranged to be installed to the door and/or article, to cover at least a portion of the target space when a person and/or an object Is placed in the target space, and to uncover the portion of the target space when the person moves or the object is removed from the target space. In another exemplary embodiment, such a cover member may also be arranged to be installed to the door and/or article, to move between at least one on-position and at least one off-position, to cover at least a portion of the target space in the on-position, and to then uncover the portion of the target space in the off-position. In another exemplary embodiment, the cover member may be arranged to be installed to the door and/or article and to move between at least one on-position for covering at least a portion of the target space and at least one off-position for uncovering such a portion of the target space in a temporal, spatial, and/or complementary relation to the door which may be arranged to move between at least one open position and at least one closed position, where the door is arranged to unobstruct at least a portion of the door opening in the open position and then to obstruct the portion of the door opening in the closed position.

In another aspect of the present invention, a door-door opening assembly may be provided for a vehicle which includes a body.

In one exemplary embodiment, a door-door opening assembly may include at least one door, at least one door opening, and at least one cover member. Such a door may be arranged to be movably coupled to the body, while the door opening may be arranged to be formed through the body, to define an entrance to an interior of the body and/or an exit to an exterior of the body, and to define a target space which may extend a preset distance into the exterior. The cover member may be arranged to be installed to the body and/or door and to cover and uncover at least a portion of the target space by moving between multiple positions thereof.

In another exemplary embodiment, a door-door opening assembly includes at least one door, at least one door opening, and at least one cover member. The door is arranged to couple with the body and to move between at least one open position and at least one closed position thereof, and the door opening is arranged to be formed through such a body, to define an entrance to an interior of the body and an exit to an exterior of the body, and to define a target space which extends a preset distance into the exterior. The cover member is arranged to operatively couple with the body and to cover and uncover at least a portion of the target space by moving between at least one on-position and at least one off-position in response to the door which moves between the open and closed positions thereof.

In another aspect of the invention, a door-door opening assembly may further be provided for a structure which may be designed for inhabiting persons, storing objects, protecting such persons or objects from weather conditions such as, e.g., rain, snow, and the like.

In one exemplary embodiment, a door-door opening assembly may include at least one door, at least one door opening, and at least one cover member. The door may be arranged to movably couple with the structure, while the door opening may be arranged to be defined through the structure, to be used or define an entrance to an interior of the structure and/or an exit to an exterior of the structure, and to define a target space extending a preset distance into the exterior. The cover member may be arranged to be installed to the door and/or structure, to cover and to uncover at least a portion of the target space by moving between multiple positions.

In another exemplary embodiment, a door-door opening assembly may also include at least one door, at least one door opening, and at least one cover member. The door may be arranged to couple with such structure and to move between at least one open position and at least one closed position thereof, while the door opening may be arranged to be defined through the body, to define or be used as an entrance to an interior of the structure and/or an exit to an exterior of the structure, and to form a target space extending a preset distance into the exterior. The cover member may also be arranged to be operatively coupled to the structure, and to cover and to uncover at least a portion of the target space while moving between at least one on-position and at least one off-position in response to the door moving between the open and closed positions.

Embodiments of the foregoing aspects of the present invention may include one or more of the following features.

The above cover members may be arranged to have multiple on-positions and/or multiple off-positions so that such members may generate multiple covering and/or uncovering movements along multiple covering and/or uncovering directions along multiple covering and/or uncovering paths. Such a cover member may also be arranged to cover or uncover different portions of the target space in at least two of such on- and off-positions, respectively.

The above cover systems may be installed by various embodiments. For example, the cover members of the cover systems may be fixedly installed onto one or both of the door and article. In the alternative, the cover members of the cover systems may also be releasably and/or movably installed to one or both of the door and article. In addition, the cover members may be installed without having to couple to the door and/or article, depending upon detailed configurations thereof. Accordingly, it is appreciated that detailed modes of installation of the cover systems may not be material to the scope of the present invention, as long as their cover members may properly cover and uncover the preset portion of the target space by moving between their multiple positions.

Such cover systems of the present invention may be installed to the door and/or article either directly or indirectly. For example, the cover system may define at least one first end and at least one second end, where one of the first and second ends may couple with the door and the other of such ends may couple with the article so that the cover system may be fixedly, movably, and/or releasably disposed between the door and article. This embodiment generally offers the benefit of arranging at least a portion of the cover system such as, e.g., its cover member, to move with the door. In another example, only one of the first and second ends may be fixedly, movably, and/or releasably coupled to the door or article, while the other of such ends may be arranged to be movably disposed uncoupled or freely in space and to move between its multiple positions. This embodiment may offer the benefit of arranging such a portion of the cover system such as its cover member to move between multiple positions thereof independent or regardless of movements of the door. It is noted, however, that the cover system of the first example may be modified to move rather independently of the movement of the door and/or that the cover system of the second example may be modified to move in response to the movement of the door.

The cover system may include at least one engaging unit which may be arranged to engage or disengage such a system. The engaging unit may be arranged to manually engage, activate or turn on the cover system to move between their multiple positions and/or to manually disengage, deactivate or turn off the cover system to not move regardless of user commands, door movements, and so on. In the alternative, various sensor members as will be described in greater detail below may be arranged to automatically engage or disengage the engaging unit depending upon weather conditions, presence or absence of the user, and so on. The engaging unit may also be arranged to couple or uncouple the cover system and/or its cover member to the door and/or article which may result in, e.g., engagement or disengagement of the entire cover system, coupling or uncoupling of such a cover system with the door or article, and so on.

The foregoing target space typically refers to a space which is disposed in the exterior of the article and, more specifically, disposed in front of the door opening and extends into the exterior by a first preset distance. Such a target space may optionally include another space which is disposed in the interior of the article or, more specifically, disposed in the back of the door opening and extends into the interior by a 2nd preset distance, where the 2nd distance may be shorter (or longer) than the 1st distance. At least a portion of the cover member may then be disposed above and/or beside such a portion of the target space in its on-position and removed therefrom in its off-position.

As described above, the cover system may be arranged to directly or indirectly generate such a covering and uncovering movement of the cover member. In one example, one or both of the above movements of the cover member may be generated manually by an operator of the door and/or cover system. In another example, the cover system may include at least one actuator member which may also be arranged to provide one or both of such movements of the cover member. Regardless of the source of energy for such movements, the cover system may also include at least one recoil member which may be arranged to absorb and store at least a portion of energy causing one of such covering and uncovering movements of the cover member and to release the stored energy to effect the other of such movements, where the energy absorbed or stored by such a recoil member may or may not be sufficient enough to generate the other of such movements. Such a recoil unit may include at least one elastic unit and/or at least one viscous unit and manipulate patterns of absorbing and/or releasing the energy as well as those of movements of the cover member.

The cover system may include at least one sensor member arranged to sense positions and/or movements of the cover member. In general, the sensor member may be used in conjunction with the actuator member which receives sensing signals from the sensor member and controls movements of the cover member as well as timings and/or durations of the movements, e.g., before, as, and/or after the movement of the door for or within preset periods of time. Various conventional sensors may be included in the sensor member. For example, a first sensor may be arranged to sense at least one of the above movements of the door, while the second sensor may be arranged to sense the presence or absence of the person or object in the target space. The third sensor may be arranged to sense at least one of the open and closed positions of the door, whereas the fourth sensor may be arranged to sense the period of the door in at least one of such positions. The fifth sensor may be arranged to sense the timing of at least one of the movements of the cover member, and the sixth sensor may be arranged to sense the period of the cover member in at least one of the above on- and off-positions. Finally, the seventh sensor may be arranged to sense weather conditions such as, e.g., precipitation, illumination, temp, humidity, and the like, in order to sense presence or absence of the precipitation and the need to engage the cover system as a whole.

The cover system may include at least one guide member arranged to support and to guide the covering and/or uncovering movements of the cover member. The guide member may include at least one fixed guide arranged to fixedly couple with the cover system, cover member, door, and/or article or, in the alternative, at least one movable guide arranged to be movably coupled to the cover system, cover member, door, and/or article and to slide, rotate, extend, and/or retract with the cover member and/or door. The cover system may also include a housing into and out of which at least a portion of the cover member may move to be unexposed and exposed between its off-position and on-position, respectively. Such a housing may be fixedly or movably disposed in the cover member, door, and/or article.

The cover member may be arranged such that its covering and/or uncovering movements may be in the temporal relation with or to the opening and/or closing movements of the door. For example, the cover member may generate the covering movement (or may move from its off-position to its on-position before, as (or when) or after the door may provide the opening movement (or may move from its closed position to its open position). In another example, such a cover member may also generate the uncovering movement (or may move from its off-position to its on-position before, as (or when) or after the door may generate the closing movement (or may move from its open position to its closed position). In both examples, the cover member may be arranged to continue to move from one to the other of its on- and off-positions for a preset period, regardless of the timing of the movements of the door. Alternatively, the cover member may be arranged to continue to move as (or when) or after the door moves from one to the other of its positions in the above examples. The cover system may also include at least one coupling member arranged to mechanically couple the cover member to the door so that the cover member may move at least substantially simultaneously with the door. The coupling member may also include at least one damper unit to allow the cover member to move with the door but with a preset time lag.

The cover member may also be arranged so that its covering and uncovering movements may be in the spatial relation with (or to) the opening and closing movements of the door and/or with (or to) the target space, i.e., the cover member moves along at least one covering (or uncovering) direction along at least one covering (or uncovering) path and that the door moves along at least one opening (or closing) direction along at least one opening (or closing) path, where at least one of such paths of the cover member may be related to the target space and/or at least one of such opening and closing paths of the door. In one example, at least one of the paths of the cover member may be arranged to be similar or identical to at least one of the paths of the door. In another example, at least a portion of at least one of the paths of the cover member may be horizontal or vertical, upward or downward, or at a preset angle with respect to at least one of the paths of the door according to a preset pattern. In another example, at least one of the paths of the cover member may also be arranged to be rotational, pivoting, translating, extending, and/or retracting with respect to the door, door opening, and/or target space. In another example, at least one of the paths of the cover member may be arranged to pass or intersect the target space according to a preset pattern. In another example, at least one of the paths of the cover member may be arranged to depend upon at least one of the paths of the door so that at least one of the paths of the cover member may be at least partially determined by at least one preset or varying path of the door. When desirable, one or both of such paths of the cover member may be arranged to be different from those of the door and/or none of the paths of the cover member may be arranged to depend upon the paths of the door. The cover member may also be mechanically coupled to the door and move along the covering and/or uncovering paths which may be similar or identical to the paths of the door. By arranging such mechanical coupling, the cover member may be arranged to move along its paths which may be an amplification or attenuation of the paths of the door. The cover system may include at least one convert member which may be arranged to transform at least one of the movements of the door into at least one of the movements of the cover member. Such a convert member may include at least one viscous unit, elastic unit, gear unit, and/or other conventional devices capable of manipulating at least one of the movements of the cover member and/or paths thereof.

The cover member may be arranged such that its covering and/or uncovering movements may be in the complementary relation with (or to) the opening and/or closing movements of the door so that the cover member may move from its off- to on-position by a covering force and move from its off- to on-position by an uncovering force, and that the door may move from its closing to opening position by an opening force and move from its opening to closing position by a closing force, where at least one of the covering and uncovering forces may be in a causal relation with at least one of the opening and closing forces and where such forces may be extension forces, compression forces, torques acting in opposite directions, and so on. In one example, at least one of the covering and uncovering forces may be generated in response to or by at least one of the opening and closing forces, while the other of the covering and uncovering forces may be optionally generated by the cover member and/or user of the door or cover member. In another example, at least one of the covering and uncovering forces may be generated by the actuator member, whereas the other of the covering and uncovering forces may be generated by the user, cover member or actuator member. The cover system may include the recoil member arranged to absorb and store at least a portion of energy from one of the covering and uncovering forces and then to release the stored energy in order to provide the other of the covering and uncovering forces, where the stored energy may or may not be sufficient enough the other of the forces. The recoil member may also include at least one viscous unit and/or at least one elastic unit in order to manipulate operational characteristics of the recoil member.

In the foregoing three aspects of this invention, the covering and uncovering movements of the cover member may not be in the above temporal, spatial, and/or complementary relation to the opening and closing movements of the door. Therefore, the cover member may generate one or both of such movements at least partially independent of the timings of the covering and/or uncovering movements of the door, at least partially independent of geometric disposition or configurations of the target space and/or paths of the door, at least partially independent of the mechanism of generation of the opening and/or closing forces of the door, and the like.

The cover member may also be arranged such that at least a portion thereof may be arranged to deform between multiple positions, where deformation may include any change in its configuration examples of which may include, but not be limited to, a length, width, height, thickness, elevation, inner or outer radius, inner or outer diameter, angle, curvature, slope, overlap, arrangement, microscopic or molecular structure, and the like. It is noted that such configuration may be measured as a curvilinear (i.e., linear or curved) dimension along a contour of the cover member, as a linear dimension between two points, as a dimension of an exposed or unexposed portion of the cover member, and the like.

The cover member may be arranged to generate such covering and/or uncovering movements in a variety of embodiments, e.g., to roll and unroll, to fold and unfold, to stack and unstack, to slide, to rotate, to pivot, to deform, and the like.

In one exemplary embodiment, the cover member may be arranged such that at least a portion thereof may be arranged to unfold and to cover at least a portion of the target space, and then to fold and to uncover such a portion of the target space. In general, the cover member includes at least one foldable cover unit and an optional housing. The foldable cover unit also includes at least one foldable cover sheet which is arranged to unfold out of the housing along a covering direction and then to fold into the housing along an uncovering direction, where the covering and uncovering directions may be an upward direction and a downward direction, respectively. The foldable cover sheet may include multiple top and bottom curvilinear lines, where multiple curvilinear polygonal sections may be defined between such lines. Such lines may extend along similar or identical directions, while such polygonal sections may also have uniform or varying dimensions such as, e.g., lengths, widths or heights along at least one of such lines. In particular, the foldable cover sheet may be arranged such that its folding and/or unfolding directions may be transverse to at least one of the lines, that cross-sectional shape defined along at least one of the covering and/or uncovering directions may change between multiple positions of the cover member, foldable cover unit, and/or foldable cover sheet. The foldable cover unit may also include multiple foldable cover sheets connected to each other in a direction which may be transverse to at least one of such lines. Such foldable cover sheets may be connected by elastic connectors which may be arranged to be stretched and unstretched in the covering and uncovering positions, respectively. The foldable cover unit may be arranged to have dimensions with a first value in its on-position and a second value in its off-position, where the first dimension is generally greater than the second dimension when such dimension is the length, width, angle, elevation, and the like, and where the first dimension is less than the second dimension when such dimension is a thickness, elevation, curvature, slope, overlap, and the like. The foldable cover member may include at least one guide unit which may be arranged to support and guide the foldable cover sheet between its multiple positions. Such a guide unit may be fixedly disposed in the cover member, door, and/or article or, in the alternative, may be arranged to extend and retract along with the cover sheet moving between its on- and off-positions.

In another exemplary embodiment, the cover member may also be arranged such that at least a portion thereof may be arranged to unstack and cover at least a portion of the target space and then to stack and uncover such a portion of the target space. The cover member may include at least one stackable unit and an optional housing. Such a stackable cover unit includes at least one cover shed and is arranged to unstack out of the housing along a covering direction and then to stack into such a housing along an uncovering direction, where such covering and uncovering directions may be either opposing vertical or horizontal directions. The stackable cover sheds may be arranged to overlap or stack one over the other and to form a stack in the off-position, and to unstack or to be disposed apart from each other in the on-position. Such cover sheds may have uniform or varying dimensions such as, e.g., lengths, widths, heights, radii, diameters, and angles, and may have cross-sectional shapes which may be defined with respect to the covering and/or uncovering directions and arranged to be uniform or varying between multiple positions of the cover member, stackable cover unit, and/or cover sheds. The stackable cover unit may also include multiple cover sheds connected to each other in a direction which is parallel with or along the direction of the covering and/or uncovering movements of the cover member. Such stackable cover sheds may be connected by elastic connectors which may be arranged to be stretched and unstretched in the covering and uncovering positions, respectively. In the alternative, at least some of the sheds may be made of and/or include elastic materials in order to be stretched and unstretched in such positions. Such a stackable cover member may also include multiple sets of cover sheds disposed and/or connected in a direction transverse to the movement of the cover member. The stackable cover unit may be arranged to have dimensions with a first value in its on-position and a second value in its off-position, where such a first dimension is generally greater than the second dimension when the dimension is the length, width, radius, diameter, elevation, angle, number of cover sheds exposed in their on-position, and the like, and where the first dimension is less than the second dimension when such dimension is the height, elevation, extent of overlap, number of sheds unexposed or stacked in their off-position, and the like. The stackable cover member may also include at least one guide unit which may be arranged to support and guide the cover sheds between their multiple positions. Such a guide unit may be fixedly disposed in the cover member, door, and/or article or, in the alternative, may be arranged to extend and retract along with the cover sheet moving between its on- and off-positions.

In another exemplary embodiment, the cover member may also be arranged such that at least a portion thereof may be arranged to roll out and to cover at least a portion of the target space, and then to roll in and to uncover such a portion of the target space. In general, such a cover member includes at least one rollable cover unit and an optional roller. The rollable cover unit also includes at least one rollable cover sheet which is arranged to roll out of the roller along a covering direction and to roll onto the roller along an uncovering direction, where such covering and uncovering directions may be either horizontal or vertical. Such a roller may be typically disposed in the cover member, door, and/or article and may have an uniform or varying perimeter along a curvilinear axial direction thereof. The rollable cover sheet may be arranged to roll out and exposed in its on-position, and to roll in and unexposed in its off-position. In addition, the rollable cover sheet may be arranged to conform to dimensions of the roller such as, e.g., its rotation axis, length, perimeter, cross-sectional shape, and the like. When such a roller may define multiple sections with different shapes, sizes, and/or axes of rotation, the rollable cover sheet may be arranged to conform to such multiple sections of the roller. Such a rollable cover sheer may further be arranged to have cross-sectional shapes defined with respect to the covering and/or uncovering directions and arranged to be uniform or to vary between multiple positions of the cover member. The rollable cover unit may include multiple cover sheets connected to each other in a direction which is parallel with or along the direction of the covering and/or uncovering movements of the cover member. Such rollable cover sheets may be connected by elastic connectors which may be arranged to be stretched and unstretched in the covering and uncovering positions, respectively. In the alternative, at least some of the sheets may be made of and/or include elastic materials in order to be stretched and unstretched in such positions. Such a rollable cover member may also include multiple sets of cover sheets disposed and/or connected in a direction transverse to the movement of the cover member. The rollable cover unit may be arranged to have dimensions with a first value in its on-position and a second value in its off-position, where the first dimension may be greater than the second dimension when the dimension is the length, width, radius, diameter, elevation, angle, length of the cover sheet exposed in its on-position, and the like, and where the first dimension is less than the second dimension when such a dimension is the height, elevation, length of the sheet unexposed or rolled in its off-position, and the like. The rollable cover member may further include at least one guide unit which may be arranged to support and guide the cover sheet between its multiple positions. The guide unit may be fixedly disposed in the cover member, door, and/or article or, in the alternative, may be arranged to extend and retract along with the rollable cover sheet moving between its on- and off-positions.

In another exemplary embodiment, the cover member may also be arranged such that at least a portion thereof may be arranged to slide out and cover at least a portion of the target space, and then to slide in and uncover the portion of the target space. In general, the cover member includes at least one slidable cover unit and an optional holder. Such a slidable cover unit includes at least one slidable cover sheet which is arranged to slide out of the holder along a covering direction and to slide into the holder along an uncovering direction, where the covering and uncovering directions may be vertical or horizontal. Such a holder may be typically disposed in the cover member, door, and/or article and may have an uniform or varying perimeter along its curvilinear axial direction so as to hold the cover sheet along at least one curvilinear direction. The holder may include multiple subholders in order to hold the slidable cover sheet along multiple similar or different directions as well. The slidable cover sheet may be arranged to slide out of the holder and exposed in its on-position, and to slide in through the holder and unexposed in its off-position. The slidable cover sheer may be arranged to have cross-sectional shapes defined with respect to the covering and/or uncovering directions and arranged to be uniform or to vary between multiple positions of the cover member. The slidable cover unit may have multiple cover sheets connected to each other in a direction which is parallel with or along the direction of the covering and/or uncovering movements of the cover member. The slidable cover sheets may also be connected by elastic connectors stretched and unstretched in the covering and uncovering positions, respectively. Alternatively, the slidable cover sheet may be made of and/or include elastic materials in order to be stretched and unstretched in such positions. The slidable cover sheet may include multiple sets of slidable cover sheets disposed and/or connected in a direction transverse to the movement of the cover member. The slidable cover unit may also be arranged to have dimensions with a first value in its on-position and a second value in its off-position, where the first dimension may be greater than the second dimension when the dimension is the length, width, radius, diameter, angle, length of such a cover sheet sliding out and exposed in its on-position, and the like, and where the first dimension is less than the second dimension when the dimension is the height, elevation, length of the cover sheet unexposed or sliding into its off-position, and the like. The slidable cover member may further include at least one guide unit arranged to support and guide the cover sheet between its multiple positions. The guide unit may be fixedly disposed in the cover member, door, and/or article or, alternatively, may be arranged to extend and retract along with the slidable cover sheet moving between its on- and off-positions.

In another exemplary embodiment, the cover member may also be arranged such that at least a portion thereof may be arranged to be made of and/or include at least one elastic material. Thus, such a cover member may be stretched to cover at least a portion of the target space in its on-position, and unstretched (or returned to its unstressed position) to uncover the same portion of the target space in its off-position. In the alternative, such a cover member may be compressed to uncover the portion of the target space in its off-position, and then returned to its unstressed position to cover such a portion of the target space. The cover member may rather include at least one elastic unit with an unstressed value greater (or less) than an stressed value. Such an elastic unit may have shapes of, e.g., elastic sheet, rod, band or net, spring, coil, and the like. Such a cover member may also include at least one guide unit described heretofore.

In another aspect of the present invention, a method may be provided to cover and uncover a target space defined adjacent to a door opening of a door-door opening assembly having at least one door.

In one exemplary embodiment, a method includes the steps of covering at least a portion of the target space by disposing a cover member thereon, and uncovering the portion of the target space by removing the cover member therefrom.

In another exemplary embodiment, a method includes the steps of movably disposing at least one cover member, moving at least a portion of such a cover member above, over or adjacent to the target space, thereby covering at least a portion of the target space, and removing the cover member away from the target space, thereby uncovering the portion of the target space.

In another exemplary embodiment, a method may include the steps of movably disposing at least one cover member, covering at least a portion of the target space by moving the cover member thereon, and uncovering the portion of the target space by removing such a cover member therefrom, while performing the above covering and/or uncovering in a complementary, temporal, and/or spatial relation to the door, door opening, and/or target space.

In another exemplary embodiment, a method includes the steps of movably disposing at least one cover member, covering at least a portion of the target space by moving such a cover member thereover in a complementary, spatial, and/or temporal relation to the door, door opening, and/or target space, and uncovering the portion of the target space by removing the cover member therefrom in the complementary, spatial, and/or temporal relation to the door, door opening, and/or target space.

In another exemplary embodiment, a method includes the steps of movably disposing at least one cover member, covering at least a portion of the target space by moving such a cover member thereabove in a first relation to a timing of the door moving from a closed position to an open position thereof, and uncovering the portion of the target space by removing the cover member therefrom in a second relation to another timing of the door moving from the open position to the closed position.

In another exemplary embodiment, a method includes the steps of movably disposing at least one cover member, covering at least a portion of the target space by moving such a cover member thereabove in a first relation to disposition of the target space, door opening, and/or door moving from a closed position to an open position thereof, and then uncovering the portion of the target space by removing the cover member therefrom in a second relation to the disposition of the target space, door opening, and/or door moving from the open position to the closed position.

In another exemplary embodiment, a method includes the steps of movably disposing at least one cover member, moving at least a portion of such a cover member toward or away from at least a portion of the target space by applying energy thereto, storing at least a portion of the energy during such moving, and moving the portion of such a cover member away from or toward the portion of the target space by using the portion of the energy.

In another exemplary embodiment, a method includes the steps of movably disposing at least one cover member, operatively coupling the cover member with the door, moving the door between its open and closed positions by applying energy thereto, moving at least a portion of the cover member to respectively cover and uncover at least a portion of the target space, while using at least a portion of the energy.

In another exemplary embodiment, a method may also include the steps of disposing at least one movable cover member over to a target space through which a person may pass through such a door-door opening assembly, opening the door while manually moving at least a portion of the cover member over at least a portion of the target space and covering at least a portion of the target space before such opening by a first preset period, immediately before the opening, simultaneously with the opening, immediately after the opening or after the opening by a second preset period, and closing the door while manually removing the portion of such a cover member away from the target space and uncovering the portion of such a target space thereafter before such closing by a third preset period, immediately before the closing, simultaneous with the closing, immediately after the closing or after the closing by a fourth preset period.

In another exemplary embodiment, a method may also include the steps of disposing at least one sensor member for detecting precipitations, disposing at least one movable cover member over the target space through which a person passes through the door-door opening assembly, moving at least a portion of the cover member over at least a portion of the target space, thereby covering such a portion of a target space as the person passes through the assembly and when the sensor member detects the precipitations, and removing the portion of the cover member away from the portion of the target space, thereby uncovering the portion of the target space thereafter.

In another aspect of the present invention, a method is provided for moving at least one cover member for covering and uncovering at least a portion of a target space defined over or adjacent to a door opening of a door-door opening assembly which includes at least one door and is installed to an article.

In another exemplary embodiment, a method may include the steps of movably installing at least one cover member to the door and/or article, moving at least a portion of the cover member toward the portion of the target space in a complementary, spatial, and/or temporal relation to such a door, target space, door opening, and/or article, and then removing the portion of such a cover member therefrom in the complementary, spatial, and/or temporal relation to the door, door opening, article, and/or target space.

In another exemplary embodiment, a method may include the steps of movably installing at least one cover member to the door and/or article, moving at least a portion of the cover member toward the portion of the target space in a first relation to a timing of the door moving from a closed position to an open position thereof, and moving such a portion of the cover member away from the target space in a second relation to another timing of the door moving from the open position to the closed position.

In another exemplary embodiment, a method may include the steps of movably installing at least one cover member to the door and/or article, moving at least a portion of the cover member toward the portion of the target space in a first relation to a disposition of the article, target space, door opening, and/or door moving from a closed position to an open position thereof, and moving the portion of the cover member away from the target space in a second relation to the disposition of the article, target space, door opening, and door moving from the open position to the closed position.

In another exemplary embodiment, a method may include the steps of movably installing at least one cover member to the door and/or article, operatively coupling the cover member with such a door, moving the door between its open and closed positions by applying energy thereto, saving at least a portion of the energy, and moving at least a portion of the cover member to cover and uncover at least a portion of the target space, while using such a portion of the energy.

In another exemplary embodiment, a method may include the steps of movably installing at least one cover member to the door and/or article, moving at least a portion of the cover member toward or away from at least a portion of the target space by applying energy thereto, storing at least a portion of the energy during the moving, and moving the portion of the cover member away or toward such a portion of the target space by using the portion of the energy.

In another exemplary embodiment, a method may include the steps of movably installing at least one cover member to the door and/or article, opening such a door, manually moving at least a portion of the cover member away from such an article before, simultaneously or after the opening, thereby covering at least a portion of the target space, closing the door, and manually moving back the portion of the cover member adjacent to such an article before, simultaneously or after the closing, thereby uncovering the portion of the target space.

In another exemplary embodiment, a method may include the steps of movably installing at least one cover member to the door and/or article, disposing at least one sensor member with at least one sensor for detecting precipitations, moving at least a portion of the cover member away from such an article and covering at least a portion of the target space when a person is passing through the door-door opening assembly and when the sensor member detects the precipitations, and moving back the portion of such a cover member toward the article, thereby uncovering the portion of the target space thereafter.

In another aspect of the present invention, a method is provided for covering and uncovering a target space defined adjacent to a door opening of a door-door opening assembly having at least one door, where the door movably couples with an article and the door opening which is defined through the article, to be used as an entrance to an interior of the article and/or an exit to an exterior of such an article, and to define a target space adjacent thereto.

In one exemplary embodiment, a method includes the steps of installing at least one movable cover member to the door and/or article, covering at least a portion of the target space when a person is disposed in such a portion of the target space, and then uncovering the portion of the target space when the person is no longer in the portion of the target space.

In another exemplary embodiment, a method may also have the steps of installing at least one movable cover member to the door and/or article, unfolding at least a portion of such a cover member above at least a portion of the target space, thereby covering such a portion of the target space, and then folding such a portion of the cover member away from the portion of the target space, thereby uncovering the portion of the target space.

In another exemplary embodiment, a method may also have the steps of installing at least one movable cover member to the door and/or article, unrolling at least a portion of the cover member from a roll above at least a portion of the target space, thereby covering such a portion of the target space, and rolling such a portion of the cover member away from the portion of the target space and onto the roll, thereby uncovering the portion of the target space.

In another exemplary embodiment, a method may also have the steps of installing at least one movable cover member to the door and/or article, unstacking at least a portion of the cover member from a stack over at least a portion of the target space, thereby covering such a portion of the target space, and stacking the portion of the cover member away from the portion of the target space and onto the stack, thereby uncovering the portion of the target space.

In another exemplary embodiment, a method may also have the steps of installing at least one movable cover member to the door and/or article, rotating, pivoting, and/or sliding at least a portion of the cover member toward at least a portion of the target space, thereby covering the portion of such a target space, and then rotating, pivoting, and sliding the portion of the cover member away from the portion of the target space, thereby uncovering the portion of the target space.

In another exemplary embodiment, a method may also have the steps of installing at least one movable cover member to the door and/or article, deforming (or restoring) at least one configuration of at least a portion of the cover member toward at least a portion of the target space, thereby covering the portion of the target space, and deforming (or restoring) such configuration of the portion of such a cover member away from the portion of the target space, thereby uncovering such a portion of the target space.

In another exemplary embodiment, a method may also have the steps of installing at least one movable cover member to the door and/or article, moving at least a portion of such a cover member toward at least a portion of the target space, thereby covering such a portion of the target space in a covering timing, removing the portion of the cover member away from the portion of the target space, thereby uncovering the portion of the target space in an uncovering timing, and rendering such moving and/or removing depend at least partially and respectively on opening and closing of the door, thereby rendering the covering and/or uncovering timings of the cover member depend at least partially and respectively on an opening timing and a closing timing of the door.

In another exemplary embodiment, a method may also have the steps of installing at least one movable cover member to the door and/or article, moving at least a portion of such a cover member toward at least a portion of the target space along at least one covering path and covering the portion of the target space, removing such a portion of the cover member away from the portion of the target space along at least one uncovering path and thereby uncovering the portion of the target space, and rendering such moving and/or removing depend at least partially and respectively upon opening and/or closing of the door, thereby rendering the covering and/or uncovering paths depend at least partially and respectively upon an opening path and a closing path of the door along which the door moves to unobstruct and obstruct at least a portion of the door opening, respectively.

In another exemplary embodiment, a method may also have the steps of installing at least one movable cover member to the door and/or article, moving at least a portion of such a cover member toward at least a portion of the target space by at least one covering force and covering the portion of the target space, removing such a portion of the cover member away from the portion of the target space by at least one uncovering force and thereby uncovering the portion of the target space, and rendering such moving and/or removing depend at least partially and respectively upon opening and/or closing of the door, thereby rendering the covering and/or uncovering forces depend at least partially and respectively upon an opening force and a closing force which cause such opening and closing of the door.

In another aspect of the present invention, a method is provided for protecting a person from precipitations while the person is getting out of and/or into a vehicle including a body and at least one door.

In another exemplary embodiment, a method includes the steps of covering at least a portion of the person by disposing a cover member thereover when the person is getting out of and/or into such a vehicle, and uncovering the portion of the person thereafter.

In another exemplary embodiment, a method includes the steps of covering at least a portion of a target space by disposing a cover member thereover, where the person is getting out of and/or into the vehicle through the target space, and uncovering the portion of the target space thereafter.

In another exemplary embodiment, a method has the steps of disposing at least one movable cover member adjacent to the body, moving at least a portion of the cover member away from such a body, thereby covering at least a portion of a target space through which the person is getting out of and/or into the vehicle when the person is getting out of and/or into the vehicle, and moving the portion of the cover member toward the body, thereby uncovering the portion of the target space thereafter.

In another exemplary embodiment, a method has the steps of disposing at least one movable cover member adjacent to the body, moving at least a portion of the cover member away from such a body according to a temporal, spatial, and/or complementary relation to opening of the door, thereby covering at least a portion of a target space through which the person is getting out of and/or into the vehicle, and moving the portion of the cover member adjacent to the body according to the temporal, spatial, and complementary relation to closing of the door, thereby uncovering the portion of the target space thereafter.

In another exemplary embodiment, a method may also include the steps of coupling at least one movable cover member to the door, then opening the door while moving at least a portion of the cover member away from the body, thereby covering at least a portion of a target space through which the person is getting out of and/or into the vehicle through the door, and closing the door while moving the portion of the cover member toward the body, thereby uncovering the portion of the target space.

In another exemplary embodiment, a method may also have the steps of disposing at least one movable cover member adjacent to the body, then opening the door while manually moving at least a portion of the cover member away from such a body before, simultaneously, and/or after the opening, thereby covering at least a portion of a target space through which the person is getting out of and/or into the vehicle, and closing the door while manually moving such a portion of the cover member back toward the body before, simultaneously, and/or after such closing, thereby uncovering the portion of the target space after the person gets out of and into the vehicle.

In another exemplary embodiment, a method has the steps of disposing at least one sensor member for detecting the precipitations, disposing at least one movable cover member adjacent to the body, moving at least a portion of the cover member away from the body, thereby covering at least a portion of a target space through which the person is getting out of and/or into the vehicle when such a person gets out of and/or into the vehicle and when the sensor member detects such precipitations, and moving the portion of the cover member back toward the body, thereby uncovering the portion of the target space thereafter.

In another exemplary embodiment, a method has the steps of disposing at least one movable cover member adjacent to the body, moving at least a portion of the cover member away from such a body by applying a first energy thereto, thereby covering at least a portion of a target space through which the person is getting out of and/or into the vehicle when the person is getting out of and/or into the vehicle, storing at least a portion of the first energy by the cover member during the moving, and moving the portion of the cover member back toward such a body by releasing the portion of the first energy, thereby uncovering the portion of the target space thereafter.

In another aspect of the present invention, a method is provided for protecting a person from precipitations while the person is getting out of and/or into a structure including at least one door and defining at least one door opening.

In another exemplary embodiment, a method includes the steps of covering at least a portion of the person by disposing a cover member thereover when the person is getting out of and/or into such a structure, and uncovering the portion of the person thereafter.

In another exemplary embodiment, a method includes the steps of covering at least a portion of a target space by disposing a cover member thereover, where the person is getting out of and/or into the structure through the target space, and uncovering the portion of the target space thereafter.

In another exemplary embodiment, a method has the steps of disposing at least one movable cover member adjacent to the structure, moving at least a portion of the cover member away from the structure, thereby covering at least a portion of a target space through which the person is getting out of and/or into the structure when the person is getting out of and/or into the structure, and moving the portion of the cover member back toward the structure, thereby uncovering the portion of the target space thereafter.

In another exemplary embodiment, a method may include the steps of disposing at least one movable cover member adjacent to the structure, moving at least a portion of the cover member away from the structure in a temporal, spatial, and/or complementary relation to opening of the door, thereby covering at least a portion of a target space through which the person is getting out of and/or into the structure, and moving the portion of the cover member toward the structure in the temporal, spatial, and/or complementary relation to closing of the door, thereby uncovering such a portion of the target space thereafter.

In another exemplary embodiment, a method may also include the steps of coupling at least one movable cover member to the door, opening the door while moving at least a portion of such a cover member away from the structure, thereby covering at least a portion of a target space through which the person gets out of and/or into the structure through such a door, and then closing the door while moving the portion of the cover member back toward the structure, thereby uncovering the portion of the target space.

In another exemplary embodiment, a method may further include the steps of disposing at least one movable cover member adjacent to the structure, opening the door while manually moving at least a portion of the cover member away from the structure before the opening within a first preset period, immediately before the opening, simultaneously with the opening, immediately after the opening, and/or after the opening within a second preset period, thereby covering at least a portion of a target space through which the person gets out of and/or into the structure, and closing the door while manually moving such a portion of the cover member toward the body before the closing within a third preset period, immediately before such closing, simultaneous with the closing, immediately after the closing, and/or after the closing within a fourth preset period, thereby uncovering such a portion of the target space thereafter.

In another exemplary embodiment, a method may further include the steps of disposing at least one sensor member for detecting such precipitations, disposing at least one movable cover member adjacent to the structure, moving at least a portion of such a cover member away from the structure, thereby covering at least a portion of a target space through which the person gets out of and/or into the structure when the person gets out of and/or into the structure and when such a sensor member detects the precipitations, and moving the portion of the cover member back adjacent to or toward the structure, thereby uncovering the portion of the target space thereafter.

In another exemplary embodiment, a method may also have the steps of disposing at least one movable cover member adjacent to the structure, moving at least a portion of the cover member away from the structure by applying energy thereto, thereby covering at least a portion of a target space through which the person gets out of and/or into such a structure when the person gets out of and/or into the structure, storing at least a portion of the energy by the cover member during the moving, and moving the portion of the cover member back toward the structure by releasing such a portion of the energy, thereby uncovering the portion of the target space thereafter.

Embodiments of the foregoing aspects of the present invention regarding various methods may also include one or more features of manufacturing, providing, installing, utilizing, and/or applying such features of the cover systems and/or their cover members which have been described in conjunction with various aspects of the foregoing apparatus claims heretofore.

In another aspect of the present invention, a cover system may be provided for a door-door opening assembly installed to an article and including at least one door and at least one door opening defining a target space adjacent thereto.

In one exemplary embodiment, a cover system may be made by a process including the steps of installing at least one cover member to the door and/or article, arranging at least a portion of such a cover member to move toward at least a portion of the target space so as to cover the portion of the target space, and arranging such a portion of the cover member to move away from the portion of the target space in order to uncover the portion of the target space.

In another exemplary embodiment, a cover system is made by a process including the steps of installing at least one cover member to the door and/or article, arranging at least a portion of the cover member to unfold in order to cover at least a portion of the target space, and arranging such a portion of the cover member to fold back so as to uncover the portion of the target space.

In another exemplary embodiment, a cover system is made by a process including the steps of installing at least one cover member to the door and/or article, arranging at least a portion of the cover member to unroll in order to cover at least a portion of the target space, and arranging such a portion of the cover member to roll back so as to uncover the portion of the target space.

In another exemplary embodiment, a cover system is made by a process including the steps of installing at least one cover member to the door and/or article, arranging at least a portion of the cover member to unstack from its stack in order to cover at least a portion of the target space, and arranging the portion of the cover member to stack back to the stack in order to uncover the portion of the target space.

In another exemplary embodiment, a cover system is made by a process including the steps of installing at least one cover member to the door and/or article, arranging at least a portion of the cover member to rotate, pivot, translate, and/or slide in order to cover at least a portion of the target space, and arranging the portion of the cover member to rotate, pivot, translate, and/or slide back in order to uncover the portion of the target space.

In another exemplary embodiment, a cover system is made by a process including the steps of installing at least one cover member to the door and/or article, arranging at least a portion of the cover member to deform (or restore) at least one of its configurations in order to cover at least a portion of such a target space, and then arranging the portion of the cover member to restore (or deform) such a configuration in order to uncover the portion of the target space.

In another exemplary embodiment, a cover system is made by a process including the steps of installing at least one cover member to the door and/or article, arranging at least a portion of the cover member to move over at least a portion of the target space in a covering timing which is arranged to at least partially depend on an opening timing of the door, and arranging the portion of the cover member to move away from the portion of the target space in an uncovering timing arranged to at least partially depend up a closing timing of the door.

In another exemplary embodiment, a cover system is made by a process including the steps of installing at least one cover member to the door and/or article, arranging at least a portion of the cover member to generate a covering movement toward (or over) at least a portion of the target space along a covering path arranged to at least partially depend upon an opening path of the door, and arranging the portion of the cover member to generate an uncovering movement away from the portion of the target space along an uncovering path arranged to at least partially depend upon a closing path of the door.

In another exemplary embodiment, a cover system is made by a process including the steps of installing at least one cover member to the door and/or article, arranging at least a portion of the cover member to move over at least a portion of the target space by a covering force, and arranging such a portion of the cover member to move away from such a portion of the target space by an uncovering force, where at least a portion of one of the covering and uncovering forces is arranged to be at least partially and respectively provided by an opening force and a closing force of the door through which the door is arranged to open and close, respectively.

More product-by-process claims may be provided by modifying the preambles of the foregoing apparatus claims of the cover systems and/or their cover members and combine them with the above claim bodies of the foregoing method claims.

Embodiments of the foregoing aspects of the present invention regarding various processes may also include one or more features generated by combining preambles of the foregoing apparatus claims with bodies of the foregoing method claims. In addition, embodiments of these aspects of the present invention regarding such processes may include one or more of the foregoing features which have been described in conjunction with various cover systems, their cover members, and/or various methods for manufacturing, providing, installing, utilizing, and/or applying various aspects of the cover systems and/or their cover members of the present invention.

As used herein, a “target space” refers to a preset space defined in a vicinity of, in proximity to, and/or adjacent to at least one door opening which is to be covered and uncovered by at least one cover member of the present invention. The definition of the “target space” generally depends upon, e.g., orientation of the door opening, movement of at least one door which may be movably coupled to the door opening, direction and/or path of the movement of the door, and the like. For example, when the door is arranged to open and close laterally (either arcuately or linearly), such a “target space” is typically defined in front of the door opening. However, when the door is arranged to open and close vertically, however, such a “target space” is defined in front of and along sides of the door opening. In addition, the “target space” is generally defined external to an article in which the door opening may be defined. However, the “target space” may also include a space which may be immediately inside the door opening and/or may extend an arbitrary preset distance which may range only a fraction of a dimension of the door opening or may extend another preset distance which is a few or several times thereof. Unless otherwise specified, however, the “target space” minimally includes the space which is encompassed by the door moving between its open and closed position and preferably includes the space in which the person or object may be disposed to get through the door opening.

A term “direction” generally represents a two- and/or three-dimensional vector, while another term “path” refers to a two and/or three-dimensional trajectory generally without a dimensional sense. Unless otherwise specified, however, the terms “direction” and “path” are to be used interchangeably within the scope of the present invention. Accordingly, a “covering direction” and/or a “covering path” refer to a direction and/or path along which the Cover member and/or its cover sheet may move so as to cover a preset portion of the target space. Both of the terms “direction” and “path” may be used for various cover members, various units thereof (such as, e.g., foldable, stackable, rollable, slidable, and elastic units), various cover sheets thereof (such as, e.g., foldable, stackable, rollable, slidable, and elastic cover sheets), and the like.

As used herein, a “door opening” generally refers to an opening which is defined in or through an article and which is used as an entrance to an interior of the article and/or as an exit to an exterior of the article, where such an article may include any vehicles (such as, e.g., land vehicles, airplanes, surface vessels, and the like), any habitable structures (such as, e.g., buildings, houses, and the like), any inhabitable structures (such as, e.g., warehouses, chambers, barns, and the like). A “door” may be preferably disposed adjacent to the “door opening” and moves between at least one close position and at least one open position thereof in order to obstruct and unobstruct (or clear) at least a portion of such a door opening, respectively.

A “door-door opening assembly” includes at least one door and at least one door opening, and provides both an entrance to and an exit from the article into which the door opening is defined and to which the door is movably coupled. The “door-door opening assembly” may typically have a proper shape and/or size to allow a person to go into and to come out of the article such as the vehicle and structure as described herein. In this context, the “door” is to be distinguished from a window within the scope of the present invention, as the “door-door opening assembly” is to be distinguished from a “window-window opening assembly.”

A phrase “between a door and a door opening” generally means a position, an area, and/or a space which may be disposed between a door and a door opening for the door. The phrase includes a position, an area, and/or a space encompassed by the door which moves between the above open and closed positions, in which such a position, area, and/or space may be defined in the above target space. The phrase, however, may also include another position, area, and/or space which may not be disposed in the space encompassed by the movable door and/or which may not be included in the target space, but which may seem to be disposed between such a door and door opening when seen from a plane defined arbitrarily by an observer in an arbitrary position. Therefore, a position, an area, and/or a space disposed above the target space and/or in the space encompassed by the door may be “between the door and door opening” when seen from above the target space. More particularly, when a cover member or its cover sheet or sheds of the present invention is referred to be disposed “between a door and a door opening,” the cover member or its cover sheet or shed may be deemed to be disposed in the space encompassed by the door, in the target space, and/or in at least one of such spaces.

As used herein, the terms “on-position” and “off-position” are used for various cover systems and/or their members and units. Accordingly, a cover system, its cover sheet and/or cover shed may be referred to be disposed in the same “on-position” and “off-position” respectively when the cover system, its cover sheet, and/or cover shed may be disposed in order to cover at least a portion of the target space and to uncover the same portion of the target space. The “on-position” and “off-position” may be used for other members of the cover system as well with the reference to the cover system, cover sheet, and/or cover shed. For example, a guide member, recoil member, and coupling member of the cover system may also be referred to operate between their “on-positions” and “off-positions,” where such positions correspond to the position of the guide, recoil, and coupling members when the cover system, cover member, cover sheet, and/or cover shed may be in their “on-positions” and “off-positions,” respectively.

Unless otherwise defined in the following specification, all technical and scientific terms used herein have the same meaning as commonly understood by one of ordinary skill in the art to which the present invention belongs. Although the methods or materials equivalent or similar to those described herein can be used in the practice or in the testing of the present invention, suitable methods and/or materials are described herein. All publications, patent applications, patents, and/or other references mentioned herein are incorporated by reference in their entirety. In case of any conflict, the present specification, including definitions, will control. In addition, the materials, methods, and examples are exemplary and illustrative only, and not intended to be limiting the scope of the present invention.

Other features and advantages of the present invention will be apparent from the following detailed description and/or from the claims.

### BRIEF DESCRIPTION OF THE DRAWING

FIG. 1 is a schematic diagram of an exemplary cover system for a pair of doors of a building according to the present invention;

FIG. 2 is a schematic diagram of an exemplary cover system for a door of a vehicle according to the present invention;

FIG. 3A is a schematic view of an exemplary foldable cover member including a foldable cover sheet according to the present invention;

FIG. 3B is a schematic view of another exemplary foldable cover member including a truncated arcuate foldable cover sheet according to the present invention;

FIG. 3C is a schematic view of another exemplary foldable cover member including an arcuate foldable cover sheet according to the present invention;

FIG. 3D is a schematic view of yet another exemplary foldable cover member including a three-dimensional foldable cover sheet according to the present invention;

FIG. 3E is a schematic view of an exemplary composite foldable cover member having multiple foldable cover sheets coupled to each other according to the present invention;

FIG. 3F is a schematic view of another exemplary foldable cover member including a housing and a guide unit according to the present invention;

FIG. 4A is a schematic view of an exemplary stackable cover member including multiple cover sheds stacked one over the others according to the present invention;

FIG. 4B is a schematic view of another exemplary stackable cover member including multiple truncated arcuate cover sheds according to the present invention;

FIG. 4C is a schematic view of another exemplary stackable cover member including multiple arcuate cover sheds according to the present invention;

FIG. 4D is a schematic view of another exemplary stackable cover member including multiple three-dimensional cover sheds according to the present invention;

FIG. 4E is a schematic view of an exemplary composite stackable cover member including two sets of cover sheds according to the present invention;

FIG. 4F is a schematic view of another exemplary stackable cover member including a housing and a guide unit according to the present invention;

FIG. 5A is a schematic view of an exemplary rollable cover member including a rollable cover sheet according to the present invention;

FIG. 5B is a schematic view of another exemplary rollable cover member including a truncated arcuate rollable cover sheet according to the present invention;

FIG. 5C is a schematic view of yet another exemplary rollable cover member including a three-dimensional rollable cover sheet according to the present invention;

FIG. 5D is a schematic view of an exemplary composite rollable cover member having multiple rollable cover sheets according to the present invention;

FIG. 5E is a schematic view of another exemplary rollable cover member having a housing and a guide unit according to the present invention;

FIG. 6A is a schematic view of an exemplary slidable cover member including a slidable cover sheet according to the present invention;

FIG. 6B is a schematic view of another exemplary slidable cover member including a truncated arcuate slidable cover sheet according to the present invention;

FIG. 6C is a schematic view of another exemplary slidable cover member with a slidable cover sheet rollable at one corner thereof according to the present invention;

FIG. 6D is a schematic view of yet another exemplary slidable cover member including a three-dimensional slidable cover sheet according to the present invention;

FIG. 6E is a schematic view of another exemplary slidable cover member having a housing and a guide member according to the present invention;

FIG. 7 is a series of schematic diagrams for exemplifying temporal relations or synchronization between movements of exemplary cover members and movements of doors according to the present invention;

FIG. 8A is a schematic view of an exemplary force regenerating member which may exhibit an exemplary complementary relation or synchronization according to the present invention;

FIG. 8B is a schematic view of another exemplary force regenerating member to show another exemplary complementary relation or synchronization according to the present invention;

FIG. 8C is a schematic view of yet another exemplary force regenerating member to exhibit yet another exemplary complementary relation or synchronization according to the present invention;

FIG. 9A is a schematic view of an exemplary guide member having horizontally and arcuately sliding guides disposed in their off-position according to the present invention;

FIG. 9B is a schematic view of the guide member of FIG. 9A moved to its on-position according to the present invention;

FIG. 9C is a schematic view of an exemplary guide member having horizontally and arcuately moving antenna guides in their off-position according to the present invention;

FIG. 9D is a schematic view of the guide member of FIG. 9C moved to its on-position according to the present invention;

FIG. 9E is a schematic view of an exemplary guide member with horizontally extending guides in their off-position according to the present invention;

FIG. 9F is a schematic view of the guide member of FIG. 9E moved to its on-position according to the present invention;

FIG. 9G is a schematic view of an exemplary guide member having vertically extending guides in their off-position according to the present invention;

FIG. 9H is a schematic view of the guide member of FIG. 9G moved to its on-position according to the present invention;

FIG. 9I is a schematic view of an exemplary guide member with vertically and upwardly sliding guides in their off-position according to the present invention; and

FIG. 9J is a schematic view of the guide member of FIG. 9I moved to its on-position according to the present invention.

### DETAILED DESCRIPTION OF THE PREFERRED EMBODIMENTS

The present invention generally relates to various door cover systems capable of covering at least a portion of a target space defined in a vicinity of a door opening of an article in order to protect a person or an object disposed in such a portion of the target space from being exposed to weather conditions or precipitations such as rain and snow. The door cover systems of the present invention are also arranged to be removed from and, accordingly, to uncover such a portion of the target space when the person or object leaves the target space. As will be described in greater detail below, such cover systems of the present invention may be practiced by numerous embodiments each of which may include one or more movable door cover members which are arranged to cover and uncover the target space in relation to movements of the doors, paths of such movements, and/or presence of the person or object in the target space. The present invention also relates to various methods of using or providing such cover systems and/or their cover members for covering such a portion of the target space. In addition, the present invention relates to various processes of making such cover systems and/or their cover members. Various door cover systems, methods, and/or processes of the present invention may be advantageously applied to conventional doors of automobiles so as to allow drivers or passengers to get into or out of the automobile without getting wet from the rain or snow. The door cover systems, methods, and/or processes of the present invention may be applied to conventional door-door opening assemblies used for other vehicles and for structures such as houses, buildings, and the like.

Various exemplary aspects and/or embodiments of the cover systems, their cover members, methods thereof, and processes of making such of the present invention will now be described more particularly with reference to accompanying drawings and text. It is appreciated, however, that such aspects and embodiments may only represent different forms and that the cover systems, their cover members, methods, and processes of the present invention may be embodied in many other different forms. Accordingly, the exemplary aspects and/or embodiments described heretofore and hereinafter should be interpreted to not be limiting but to be provided such that this disclosure will be thorough and complete and fully convey the scope of the present invention to one skilled in the relevant art.

Unless otherwise specified, it is to be understood that various members, elements, units, and parts of the cover systems are not generally drawn to scales and proportions for ease of illustration. It is also understood that the members, elements, units, and/or parts of such cover systems which are designated by the same numerals generally represent the same, similar, and/or functionally equivalent members, elements, units, and parts thereof, respectively.

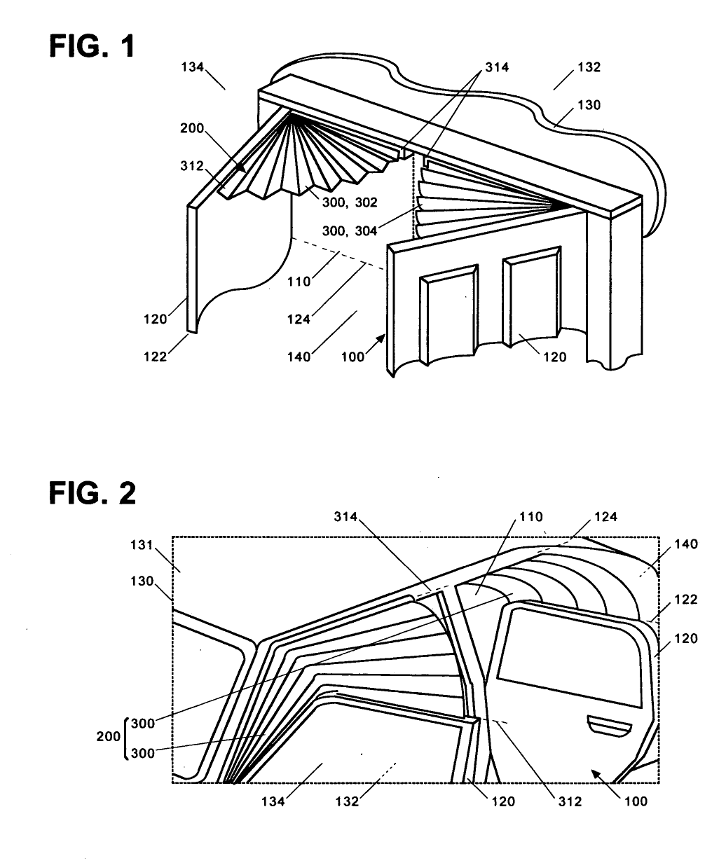

In one aspect of the present invention, an exemplary cover system is installed to a commercial and/or residential structure, activated to protect a person or an object from being exposed to external weather conditions such as rain and snow when such a person or object is disposed inside at least a portion of a target space defined over, above or adjacent to a door opening of a door-door opening assembly, and deactivated when the person or object moves out or is no longer in the portion of the target space. FIG. 1 shows a schematic diagram of an exemplary cover system for a pair of doors of a building according to the present invention, where a conventional door-door opening assembly 100 includes a pair of doors 120 installed for obstructing and unobstructing a door opening 110. The door opening 110 is generally formed through an article 130 such as a commercial or residential structure (e.g., a house, building, storage, barn, warehouse, and the like) and used as an entrance to an interior 132 of the article 130 and an exit from such an interior 132 to an exterior 134 of the article 130. The doors 120 are movably coupled to the article 130 and moves between at least one open position 122 and at least one closed position 124 to respectively unobstruct and to obstruct at least a portion of the door opening 110. A target space 140 is defined in the exterior 134 of the article 130 and adjacent to or in front of the door opening 110, where such a target space 140 typically corresponds to a path for a person to get into and/or out of the article 130 therethrough.

An exemplary cover system 200 includes two different cover members 300 (more specifically, a first cover member 302 and second cover member 304 as will be described in greater detail below) which are movably coupled to the article 130 and/or doors 120. The cover members 300 are typically arranged to be disposed over or above at least a portion of the target space 140 in their on-positions and to be removed therefrom in their off-positions. Accordingly, such cover members 300 may move between at least one “on-position” 312 and at least one “off-position” 314 thereof, optionally in relation to movements of the doors 120 respectively between the open and closed positions 122, 124 thereof, in relation to geometric dispositions and/or arrangements of the doors 120, article 130, target space 140, and the like. Therefore, the cover system 200 may cover and uncover the portion of the target space 140 in its on- and off-positions, 312, 314, respectively. Contrary to the doors 120 which have to move through the target space 140 during the movements between their open and closed positions 122, 124, the cover system 200 and/or their cover members 300 may or may not move between their on- and off-positions 312, 314 without having to traverse such a target space 140. As shown in the figure, the exemplary cover system 200 may include different cover members 300 for each door 120, where an exemplary foldable cover member 302 is movably coupled to the left door 120 (when seen from front), while an exemplary stackable cover member 304 is movably coupled to the right door 120. Details of such cover members 302, 304 will be described in greater detail below.

In operation, the cover members 300 are preferably disposed in their (fully) off-positions 314 when the doors 120 are in their closed positions 124. When the doors 120 begin to move from their closed positions 124 to their open positions 122 by an user or operator, the cover members 300 may be activated by the cover system 200 and/or operator and begin to move from their off-positions 314 toward their on-positions 312, thereby covering at least a small portion of the target space 140. When the doors 120 move to their (fully) open positions 122, the cover system 200 and cover members 300 move to their (fully) on-positions 122, thereby covering the operator or object disposed in the portion of the target space 140 from the rain and snow. When the doors 120 begin to move away from their (fully) open positions 122, the cover system 200 and their cover members 300 also begins to move away from their (fully) on-positions 312. As the doors 120 move to their (fully) closed positions 124 and the operator or object may no longer be disposed in the target space 140, the cover system 200 and their cover members 300 also move back to their (fully) off-positions 314, thereby uncovering the portion of the target space 140.

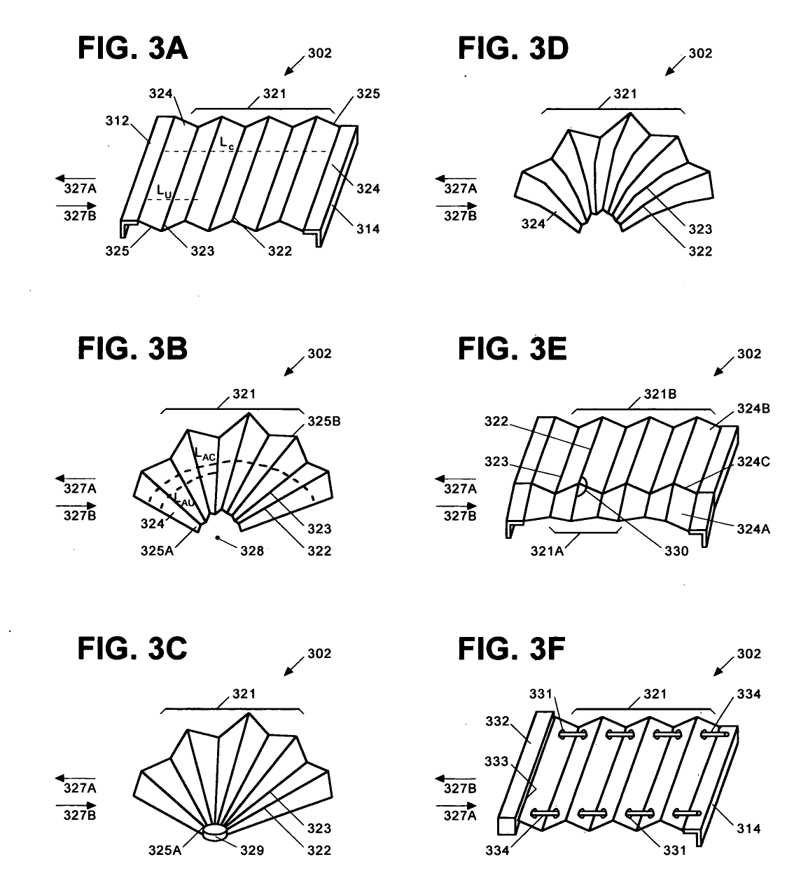

In another aspect of the present invention, another exemplary cover system is installed into a vehicle, activated to protect a driver or passenger from being exposed to external weather conditions such as rain and snow when such a person is disposed in at least a portion of a target space defined over, above or adjacent to a door opening of a door-door opening assembly of the vehicle, and then deactivated when such a person is no longer in the portion of the target space. FIG. 2 is a schematic diagram of an exemplary cover system incorporated into a door of a vehicle according to the present invention. Similar to the embodiment of FIG. 1, a door-door opening assembly 100 also includes a door opening 110 and a pair of doors 120. The door opening 110 is generally provided through a body 131 of the article 130 such as a conventional automobile and used as an entrance to an interior 132 of the article 130 and an exit from such an interior 132 to an exterior 134 of the article 130. The doors 120 are movably coupled to the body 131 and moves between at least one open position 122 and at least one dosed position 124 to respectively unobstruct and obstruct at least a portion of the door opening 110. A target space 140 is defined in the exterior 134 of the article 130 and adjacent to or in front of the door opening 110, where such a target space 140 typically corresponds to a path for a driver or a passenger to get into and/or out of the automobile 130 therethrough.

An exemplary cover system 200 includes two different cover members 300 (more specifically, a third cover member 304 and a fourth cover member 306 as will be described in greater detail below) which are movably coupled to the body 131 and/or doors 120 of the article 130. The cover members 300 are typically arranged to be disposed over or above at least a portion of the target space 140 in their on-positions and to be removed therefrom in their off-positions. Accordingly, the cover members 300 move between at least one “on-position” 312 and at least one “off-position” 314 thereof, optionally in relation to movements of such doors 120 between the open and closed positions 122, 124 thereof, respectively, and/or in relation to geometric dispositions and/or arrangements of the doors 120, article 130, body 131, target space 140, and so on. Thus, the cover system 200 may cover and uncover the portion of the target space 140 in its on- and off-positions, 312, 314, respectively. In contrary to such doors 120 which move through the target space 140 during their movements between their open and closed positions 122, 124, the cover system 200 and/or cover members 300 may be disposed outside the target space 140 and, therefore, may move between their on- and off-positions 312, 314 without having to traverse such a target space 140. As shown in the figure, the exemplary cover system 200 may also include different cover members 300 for each door 120, where another exemplary stackable cover member 304 is movably coupled to the front door 120, and an exemplary slidable cover member 306 is movably coupled to the rear door 120, where details of such cover members 304, 306 will also be described in greater detail below. Operational characteristics of the cover system 200 and cover members 300 thereof are similar or identical to those described in conjunction with FIG. 1.

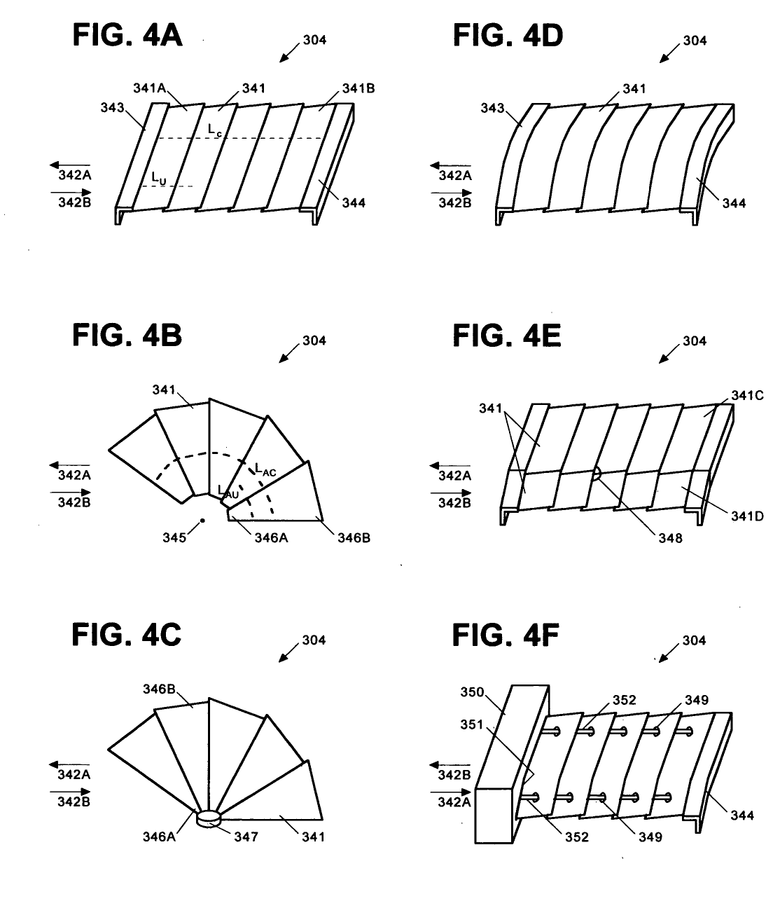

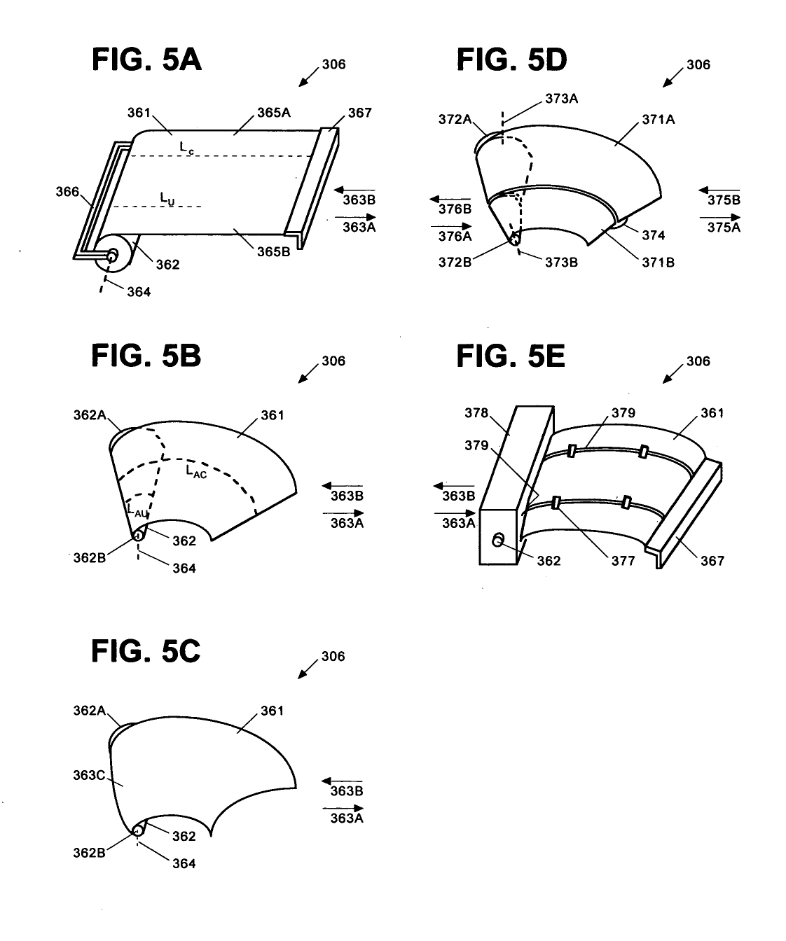

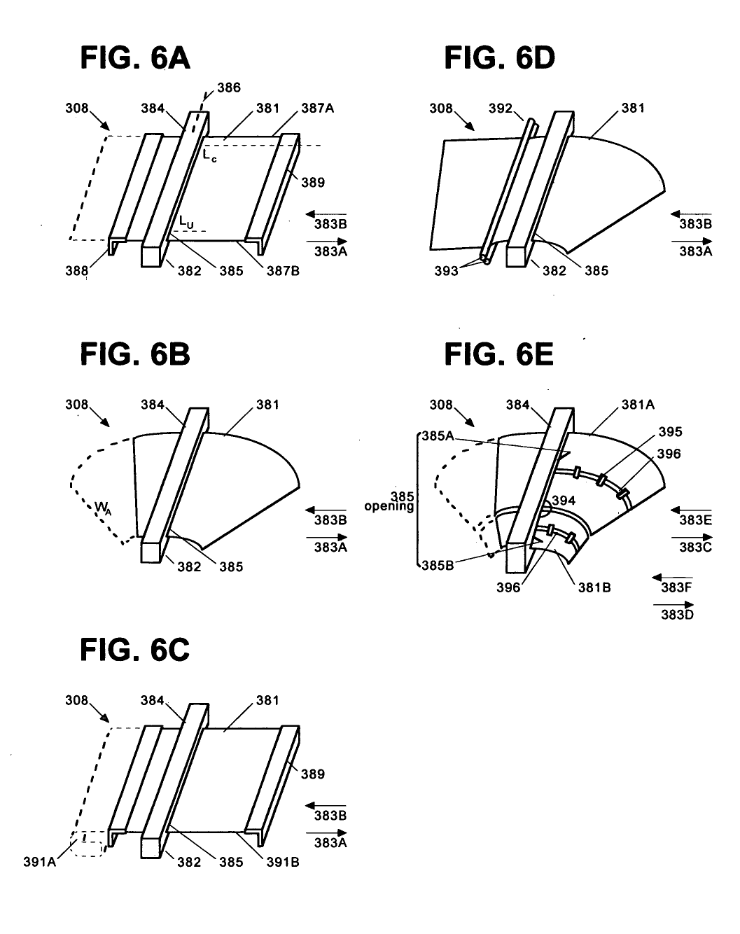

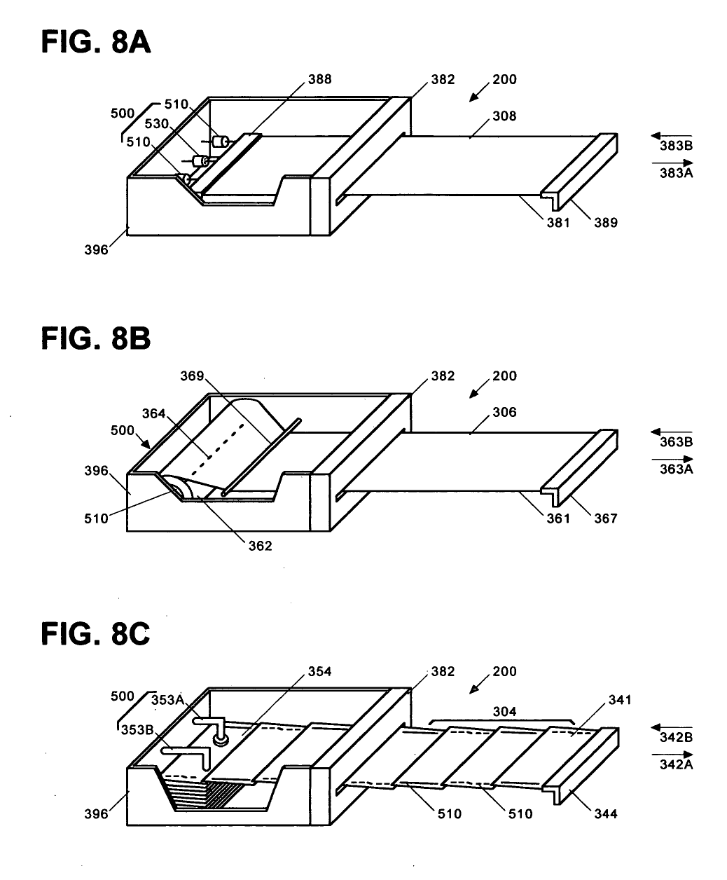

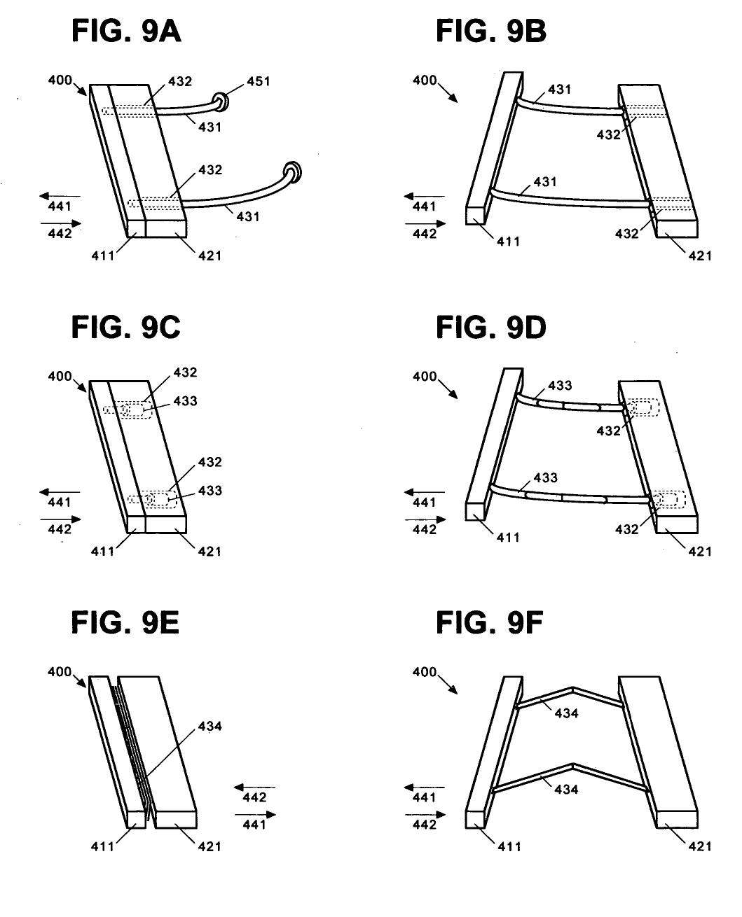

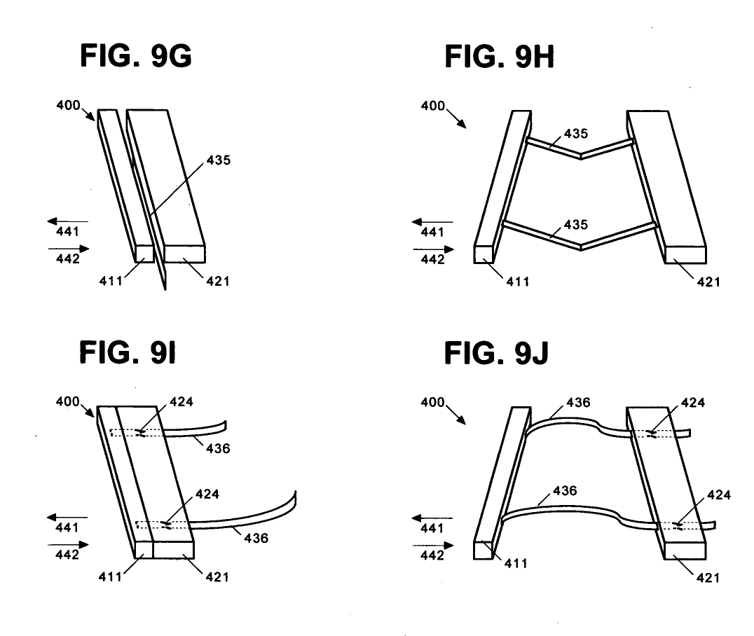

The cover members of the present invention are generally arranged to change at least one of its configurations such as its dimension, shape, and/or orientation during its movements between the on- and off-positions so as to cover and uncover at least a portion of the target space, respectively. Detailed examples of such configurations may include, but not be limited to, a length, a width, a height, a thickness or elevation, a radius or diameter, an angle, a slope, a curvature or contour, an orientation, an arrangement thereof and/or therebetween, an overlap thereover and/or therebetween, a molecular or microscopic structure, a combination thereof, and so on. Details of configurations of various cover systems and their cover members, various methods thereof, and/or various processes therefor will now be described with reference to FIGS. 3 to 9. More particularly, FIGS. 3A to 3F show exemplary embodiments of foldable cover members and their cover sheets, FIGS. 4A to 4F represent exemplary embodiments of stackable cover members and their cover sheds, FIGS. 5A to 5E describe exemplary embodiments of rollable cover members and their cover sheets, and FOGs. 6A to 6E show exemplary embodiments of slidable cover members and their cover sheets according to the present invention. In addition, FIGS. 7A through 7J denote exemplary embodiments of guide members for exemplary spatial relations of the cover member, FIG. 8A through 8C are exemplary embodiments of force regenerating members for exemplary complementary relations of the cover member, and FIG. 9 represents various exemplary embodiments for temporal relations of the cover member with respect to the door opening, door, and/or target space according to the present invention.

In one aspect of the present invention, an exemplary cover system may include an exemplary cover member arranged to unfold and fold so as to cover and uncover at least a portion of the target space, respectively, where FIGS. 3A through 3F are exemplary embodiments of such foldable cover members and their cover sheets according to the present invention.

In one exemplary embodiment, FIG. 3A represents a schematic view of an exemplary foldable cover member including a foldable cover sheet according to the present invention, where a foldable cover member 302 includes a cover sheet 321 defining alternating top lines 322 and bottom lines 323 thereon and forming curvilinear polygonal sections 324 therebetween. Because such top and bottom lines 322, 323 of the figure are formed at equal distances along sides 325 of the foldable cover sheet 321, each polygonal section 324 of the cover sheet 321 may have a at least substantially rectangular shape. The foldable cover sheet 321 is generally made of and/or includes at least one material having at least minimal flexibility enough to be bent along the top and bottom lines 322, 323. Therefore, such a cover sheet 321 may fold to have a (fully) uncovering length (Lᵤ) in its (fully) off-position and unfold to a (fully) covering length (L_{c}) in its (fully) on-position. Configurational characteristics of the folding and unfolding of such a cover sheet 321 may be described by an index such as, e.g., a degree of folding which may be defined in any arbitrary scale but preferably range from 0.0 (i.e., when all sections 324 are unfolded and spread apart from each other) to 1.0 (i.e., when all sections 324 are folded to touch or contact each other). Thus, such a foldable cover sheet 321 may be folded to have the uncovering length and a high degree of folding in its off-position, while being unfolded to have the covering length and a low degree of folding in its on-position. The foldable cover sheet 321 may define a first end 312 arranged to couple with the door (not shown in the figure) and a second end 314 arranged to couple with the article (not shown in the figure) such as the vehicle and/or structure as described above.

In operation, the cover member 302 is kept in its (fully) off-position to its uncovering length, Lᵤ, when the door is in its closed position. As the door opens, the first end 312 moves with the door but the second end 314 is fixedly coupled to the stationary article. Accordingly, the foldable cover sheet 321 begins to unfold and increase its length while unfolding along a covering (or unfolding) direction (or path) 327A which generally traverses the top and bottom lines 322, 323 thereof. When the door moves to its (fully) open position, the cover sheet 321 also moves to its (fully) on-position, attaining its covering length, L_{c}, and covering a preselected portion of the target space (not shown in the figure) which is generally disposed thereunder. When the door begins to close, such a door begins to push the foldable cover sheet 321 through its first end 312, and the cover sheet 321 decreases its length along an uncovering (or folding) direction (or path) 327B which also generally traverses the top and bottom lines 322, 323 thereof. When the door is completely shut to its full closed position, the cover sheet 321 is also folded back to its fully off-position and to its uncovering length, Lᵤ, thereby allowing the cover member 302 to uncover the preselected portion of the target space.

In another exemplary embodiment, FIG. 3B is a schematic view of another exemplary foldable cover member including a truncated arcuate foldable cover sheet according to the present invention, where an exemplary foldable cover member 302 includes a foldable cover sheet 321 with alternating top and bottom lines 322, 323 and having polygonal sections 324 defined therebetween. Contrary to the previous embodiment, the cover sheet 321 shown in FIG. 3B is arranged to fold and unfold along a curved unfolding (or folding) direction (or path). Therefore, the top and bottom lines 322, 323 may be provided radially on the cover sheet 321 about a center 328 of rotation. In order to accommodate such arcuate or angular unfolding and unfolding directions 327A, 327B, the cover sheet 321 generally has a shape of a truncated arc whose arcuate length of an inner or lower side 325A is shorter than that of an outer or upper side 325B. The cover sheet 321 may also have other shapes and/or sizes such that square or rectangular cover sheets such as that of FIG. 3A may unfold and fold along the curved directions 327A, 327B about the center 328 of rotation. Therefore, the curvilinear polygonal sections 324 may have a variety of shapes as well such as, e.g., truncated arcs, truncated cones, trapezoids, rectangles, squares, and so on. The foldable cover sheet 321 may also include a first and/or second end as described in FIG. 3A, and may be made of and/or include at least one elastic material similar to that of FIG. 3A. The cover member 321 may be operated to have an arcuate covering length (L_{c}) in its on-position and another arcuate uncovering length (Lᵤ) in its of-position in order to cover and uncover a preset portion of the target space, respectively. Other configurational or operational characteristics of the foldable cover member 302 of FIG. 3B are similar or identical to those of FIG. 3A.

In another exemplary embodiment, FIG. 3C is a schematic view of another exemplary foldable cover member including an arcuate foldable cover sheet according to the present invention, where an exemplary cover member 302 is generally similar to that of FIG. 3B, except that the cover member 302 includes a collector 329 to which an entire length of a lower side 325A of a foldable cover sheet 321 may be coupled and about which the cover sheet 321 may rotate between its on- and off-positions. Other configurational or operational characteristics of the foldable cover member 302 of FIG. 3C are similar or identical to those of FIGS. 3A and 3B.

In another exemplary embodiment, FIG. 3D is a schematic view of another exemplary foldable cover member including a three-dimensional foldable cover sheet according to the present invention, where an exemplary cover member 302 includes a cover sheet 321 which is similar to that of FIG. 3B but preferably curved to have curved top and bottom lines 322, 323 as well as curved sections 324. Accordingly, such a foldable cover member 302 may unfold and fold along the curved top and bottom lines 322, 323 along covering and uncovering directions (or paths) 327A, 327B, respectively. Other configurational or operational characteristics of the foldable cover member 302 of FIG. 3D are similar or identical to those of FIGS. 3B and 3C.

In another exemplary embodiment, FIG. 3E describes a schematic view of another exemplary foldable cover member having multiple foldable cover sheets coupled to each other according to the present invention, where an exemplary foldable cover member 302 has a lower foldable cover sheet 321A and an upper foldable cover sheet 321B connected to each other. Accordingly, top and bottom lines 332, 333 of the lower and upper cover sheets 321A, 321B meet each other along a border 324C at a preset angle 330 vertically, and curvilinear sections 324A, 324B of such sheets 321A, 321B also meet each other along the border 324C. Configurational and operational characteristics of such lower and upper cover sheets 321A, 321B are typically identical to those of FIGS. 3A through 3D. However, because the top and bottom lines 322, 323 of the lower and upper foldable cover sheet 321A, 321B extend in different directions, such sheets 321A, 321B may unfold and fold in different directions and may cover and uncover the target space at different angles. Thus, such a cover member 302 may be preferable to cover the preset portion of the target space at multiple angles, as exemplified in FIG. 2. Other configurational or operational characteristics of the foldable cover member 302 of FIG. 3E may be similar or identical to those of FIGS. 3A through 3D.

In another exemplary embodiment, FIG. 3F is a schematic view of another exemplary foldable cover member including a housing and a guide unit according to the present invention. An exemplary foldable cover member 302 includes a foldable cover sheet 321, a housing 332, and a guide member. The cover sheet 321 is generally similar to that shown in FIG. 3A but includes apertures provided on a top portion and a bottom portion of each polygonal section 324 thereof. The housing 332 is disposed on one end opposite to a second end 314 of the cover sheet 321 and defines along its axis a slit or an opening 333 shaped and sized to receive and release the foldable cover sheet 321 therethrough. The housing 332 is also shaped and sized to retain a preset portion of the cover sheet 321 therein when the cover sheet 321 is disposed in its off-position. The cover member 302 does not require a first end because the housing 332 is disposed instead. When the housing 332 is arranged to be installed at the door, the cover member 302 needs the second end 314 to couple the cover member 302 to the article. The exemplary guide member includes a pair of guides 334 which couple with the housing 332 along a direction transverse to a longitudinal axis of the housing 332, extend along covering and uncovering directions 327A, 327B, and extend through the apertures 331 provided in the top and bottom portions of the polygonal sections 324. Therefore, the foldable cover sheet 321 may move in the covering and uncovering directions 327A, 327B while being supported and/or guided by the guides 334 which may be fixedly placed along preset paths or, in the alternative, which may extend out of and retract into the housing 332 along with the cover sheet 321.

In operation, the foldable cover member 302 is folded to its uncovering length (Lᵤ) and retained in the housing 332 when the door is in its closed position. When the door begins to open, the housing 332 which is coupled to the door also begins to move with the door. Because the second end 314 is fixedly coupled to the stationary article, the cover sheet 321 begins to unfold by being pulled out of the housing 332. As the cover sheet 321 unfolds, the guides 334 may also extend out of the housing 332 and support and guide the cover sheet 321 therealong. As the door moves to its (fully) open position, the cover member 302 also moves to its (fully) on-position in which at least a substantial portion of the cover sheet 321 is pulled or unfolded out of the housing 332 to its covering length (L_{c}), while at most a minimal portion thereof remains inside the housing 332. Therefore, the cover member 302 may cover the preset portion of the target space in its (fully) on-position, thereby protecting the person or object from the rain and snow. As the door begins to close, the guides 334 begin to retract into the housing 332, while the cover sheet 321 is gradually folded toward its off-position. As the door is completely shut to its (fully) closed position, the guides 334 also fully retract into the housing 332, the cover sheet 321 is folded to its (fully) off-position, and the cover member 302 may uncover such a preset portion of the target space.

In one aspect of the present invention, an exemplary cover system may include an exemplary cover member arranged to unstack and stack in order to cover and uncover at least a portion of such a target space, respectively, where FIGS. 4A to 4F depict exemplary embodiments of such stackable cover members and their cover sheets (or sheds) according to the present invention.

In one exemplary embodiment, FIG. 4A describes a schematic view of an exemplary stackable cover member including multiple cover sheds which are stacked one over the others according to the present invention, where an exemplary stackable cover member 304 may include multiple cover sheds 341 aligned in a row and movably coupled to each other. It is appreciated that such cover sheds 341 are a kind of the cover sheet having a characteristic that its length is generally shorted than its height. Such cover sheds 341 may preferably be arranged to be stacked one over another by overlapping at least a substantial portion of each other and to form a stack when the stackable cover member 304 is disposed in its off-position, and unstacked from the stack and spread apart from each other when the cover member 304 is disposed in its on-position. Operational characteristics of such cover shed 341 may be characterized by indices such as, e.g., a degree of stacking, a degree of overlap, and so on, where the former may be defined in any arbitrary scale but preferably range from 0.0 (i.e., all cover sheds 341 are spaced apart from each other, optionally with minimal overlaps therebetween) to 1.0 (i.e., all cover sheds 341 are stacked one over the other to form the stack), and where the latter may be defined in any arbitrary scale but preferably range from 0.0 (i.e., all cover sheds 341 are spread apart from each other, optionally with minimal overlaps therebetween) to 1.0 (i.e., all adjacent cover sheds 341 are completely overlapping each other). It is appreciated that the degree of stacking may be applied to an entire stack of sheds 341, while the degree of overlap may be defined for individual cover sheds 341. Therefore, when at least a substantial number of the cover sheds 341 are stacked one over the other, the stackable cover member 304 has an uncovering length, Lᵤ, with a high degree of stacking (e.g., up to 1.0) and overlap (e.g., up to 1.0) in its off-position. Conversely, when at least a substantial number of the cover sheds 341 are spaced apart from each other, the stackable cover member 304 has a covering length, L_{c}, with a low degree of stacking (e.g., down to 0.0) and overlap (e.g., down to 0.0) in its on-position. It is appreciated that, when the cover sheds 341 have identical dimensions, all cover sheds 341 may be stacked one over the other in their off-position and have the uncovering length (Lᵤ) which may be substantially equal to or only slightly greater than a width of a single cover shed 341. In general, such stackable cover sheds 341 may be movably coupled to each other by a string or strings as commonly seen in conventional blades of a blind, and such a stackable cover member 304 may include at least one guide member and/or recoil member as will be described in greater detail below. The stackable cover member 304 may include at least one first end 343 which may be arranged to couple one end of a top (or bottom) cover shed 341A of the stack with the door (or the article, neither included in the figure) and at least one second end 344 which may be arranged to couple one end of a bottom (or top) cover shed 341B of the stack with the article (or door).

In operation, the stackable cover member 304 is disposed in its off-position when the door is in its closed position such that the cover sheds 341 of such a member 304 form the stack having a high degree of stacking and overlap, while keeping the uncovering length (Lᵤ). As the door begins to open, the first end 343 moves with the door, while the second end 344 is maintained to be fixedly coupled to the stationary article. Therefore, the cover sheds 341 are pulled out from the stack and slide one over the other along a covering direction (or path) 342A, while the cover member 304 increases its length therealong. When the door reaches its (fully) open position, at least a substantial portion of the cover sheds 341 are pulled out of the stack (i.e., a minimum degree of stacking) and also spaced apart from each other (i.e., a minimum degree of overlap) such that the cover member 304 may attain its covering length (Lᵤ) in its (fully) on-position, thereby covering a preset portion of the target space. As the door begins to close, the cover member 304 may begin to retract the cover sheds 341 along an uncovering direction (or path) 342B, while building the stack by disposing one cover shed 341 over the other and decreasing its length therealong. Depending upon the stacking and/or unstacking modes, such cover sheds 341 may be arranged to be sequentially stacked one after another or, in the alternative, at least a substantial number of the cover sheds 341 may be uniformly pushed closer to each other. As the door is completely shut in its (fully) closed position, the cover sheds 341 are stacked back again to the highest degrees of stacking and overlap, while the cover member 304 returns to its uncovering length, thereby uncovering the preset portion of the target space in its off-position. Other configurational and operational characteristics of such a stackable cover member 304 of FIG. 4A are similar or identical to those of FIG. 3A.

In another exemplary embodiment, FIG. 4B is a schematic view of another exemplary stackable cover member having multiple truncated arcuate cover sheds according to the present invention. An exemplary stackable cover member 304 is generally similar to that of FIG. 4A, except that cover sheds 341 of FIG. 4B are arranged to be unstacked along a curved covering direction (or path) 342A, and to be stacked back along another curved uncovering direction (or path) 342B. In order to accommodate the arcuate or radial movements, the cover sheds 341 may preferably be shaped as, e.g., trapezoids, truncated arcs, and other curved shapes as long as such sheds 341 may be stacked and unstacked while generating the arcuate covering or uncovering movements. Because of its rotating and/or radial covering and uncovering movements about a center of rotation 345, such a curved stackable cover member 304 may respectively attain an arcuate covering length (L_{c}) and an uncovering length (Lᵤ) in its on- and off-positions. It is appreciated, however, that such covering and uncovering lengths may differ when measured near an inner portion 346A or an outer portion 346B of the sheds 341. Thus, it is preferred that such lengths be measured along a preset distance from the center of rotation 345 in order to be compared on an equal basis. Further configurational and/or operational characteristics of the stackable cover member 304 of FIG. 4B are generally similar or identical to those of FIGS. 3A and 3B and/or FIG. 4A.

In another exemplary embodiment, FIG. 4C is a schematic view of another exemplary stackable cover member having multiple arcuate cover sheds according to the present invention. An exemplary stackable cover member 304 of FIG. 4C is generally similar to that of FIG. 4B, except that such a cover member 304 includes a collector 347 which may be arranged to movably couple with inner portions of every cover shed 341 and to serve as a center of rotation for such cover sheds 341 moving between their on- and off-positions. Other configurational or operational characteristics of the stackable cover member 304 of FIG. 4C generally are similar or identical to those shown in FIGS. 3A through 3C and/or FIGS. 4A and 4B.

In another exemplary embodiment, FIG. 4D is a schematic view of another exemplary stackable cover member having multiple three-dimensional cover sheds according to the present invention. An exemplary stackable cover member 304 is generally similar to that shown in FIG. 4A, except that such a cover member 304 includes curved and desirably three-dimensional cover sheds 341 which may be unstacked and stacked along curved and desirably three-dimensional covering and uncovering paths (or directions) 342A, 342B in order to respectively cover and uncover a preset portion of the target space. Other configurational or operational characteristics of the stackable cover member 304 of FIG. 4D are generally similar or identical to those of FIGS. 3A through 3D and/or FIG. 4A through 4C.

In another exemplary embodiment, FIG. 4E describes a schematic view of another exemplary composite stackable cover member with two sets of cover sheds according to the present invention. An exemplary stackable cover member 304 includes two sets of cover sheds such as upper cover sheds 341C and lower cover sheds 341D coupling to each other along a direction which is generally transverse to covering and/or uncovering directions (or paths) 342A, 342B of the cover member 304, where other configurational and/or operational characteristics of such cover sheds 341C, 341D may be similar or identical to those of other cover sheds described in FIGS. 4A to 4D. Because such two sets of cover sheds 341C, 341D may unstack and stack along different directions at a preset angle 348, such a composite cover member 304 may cover a preset portion of the target space In different angles and, therefore, may offer benefits similar to those described in conjunction with FIG. 3E. The upper and lower cover sheds 341C, 341D may be coupled to each other by various means such as, e.g., direct coupling therebetween, indirect coupling using conventional connectors or couplers (not shown in the figure), and the like. Other configurational or operational characteristics of the stackable cover member 304 of FIG. 4E are generally similar or identical to those of FIGS. 3A through 3E and/or FIGS. 4A through 4D.

In another exemplary embodiment, FIG. 4F represents a schematic view of another exemplary stackable cover member including a housing and a guide unit according to the present invention. An exemplary stackable cover member 304 includes multiple stackable cover sheds 341 and a housing 350. The cover sheds 341 are generally similar to those of FIG. 4D but each shed 341 define a pair of apertures 349 on its top and bottom portions. The housing 350 is shaped and sized to retain at least a substantial portion of the cover sheds 341 in their off-position and includes an opening 351 on its side to receive and release the stackable cover sheds 341 therethrough. The guide member has a pair of guides 352 which may be fixedly coupled to the door and/or article or, in the alternative, to extend and retract similar to that described in conjunction with FIG. 3E. Further configurational and/or operational characteristics of the stackable cover member 304 of FIG. 4F are generally similar or identical to those of FIGS. 3A through 3F and/or FIGS. 4A through 4E.

In operation, the cover sheds 341 are stacked to its uncovering length (Lᵤ) and retained in the housing 350 when the door is kept in its closed position. When the door begins to open, the housing 350 which is coupled to the door also begins to move with the door. Because the second end 344 is fixedly coupled to the stationary article, the cover sheds 341 begin to unstack and to be pulled out of the housing 350. As the cover sheds 341 unstack, the guides 352 may also extend out of the housing 350 and support and guide the cover sheds 341 therealong. When the door moves to its (fully) open position, the cover member 304 also moves to its (fully) on-position and at least a substantial portion of the cover sheds 341 are pulled or unstacked out of the housing 350 to its covering length (L_{c}), and at most a minimal portion thereof remains inside the housing 350. Accordingly, the cover member 304 may cover the preset portion of the target space in its (fully) on-position and may protect the person or object from the rain and snow. As the door begins to close, the guides 352 begin to retract into the housing 350, while the cover sheds 341 are gradually stacked toward their off-position. As the door is completely closed to its (fully) closed position, the guides 352 fully retract into the housing 350, the cover sheds 341 are stacked to its (fully) off-position, and the cover member 304 may uncover such a preset portion of the target space.

In another aspect of the present invention, an exemplary cover system may further include an exemplary cover member arranged to be rolled out and rolled in in order to cover and uncover at least a portion of the target space, respectively, where FIGS. 5A through 5E show exemplary embodiments of rollable cover members and their cover sheets according to the present invention.

In one exemplary embodiment, FIG. 5A represents a schematic view of an exemplary rollable cover member having a rollable cover sheet according to the present invention. An exemplary rollable cover member 306 has at least one rollable cover sheet 361 and an optional roller 362 therefor. Such a rollable cover sheet 361 may be arranged to be unrolled from (or rolled out of) the roller 362, and to extend along a covering direction (or path) 363A when the roller 362 rotates in a clockwise direction. Conversely, the cover sheet 361 may be arranged to be rolled unto (or around) the roller 362, and to retract along an uncovering direction (or path) 363B when the roller 362 rotates in a counterclockwise direction. In the exemplary embodiment of FIG. 5A, the rollable cover sheet 361 is a rectangular strip, and the roller 362 is a cylinder having an axial length which may be slightly greater than a length of the cover sheet 361. In this example, such covering and uncovering directions 363A, 363B are generally transverse to a longitudinal axis 364 of the roller 362 and parallel with an upper portion 365A and/or a lower portion 365B of the cover sheet 361. Characteristics of rolling (or covering) and/or unrolling (or uncovering) of such a cover sheet 361 may be characterized by an index such as, e.g., a degree of rolling which may be defined in an arbitrary scale but preferably range from 0.0 (i.e., an entire portion of the cover sheet 361 is unrolled out of the roller 362) to 1.0 (i.e., the entire cover sheet 361 is rolled around the roller 362). Therefore, the rollable cover member 306 has an uncovering length, Lᵤ, with a high degree of rolling in its off-position, and a covering length, L_{c}, with a low degree of rolling in its on-position. The rollable cover member 306 may also include at least one first end 366 and at least one second end 367, where the former couples the cover sheet 361 to the door (or article) and the latter couples such a sheet 361 to the article (or door).

In operation, the rollable cover member 306 is kept to its uncovering length (Lᵤ) and rolled onto the roller 362 when the door is in its closed position. When the door begins to open, the first end 366 which is coupled to the door also begins to move with the door, whereas the second end 314 fixedly coupled to the article does not move. Therefore, the cover sheet 361 begins to be unrolled and pulled out of the roller 362, while extending along the covering direction (or path) 363A. Optional guides (not shown in the figure) may also extend to support and guide the cover sheet 361 therealong. When the door moves to its (fully) open position, the cover sheet 361 moves to its (fully) on-position in which at least a substantial portion thereof may be pulled or unrolled out of the roller 362 to its covering length (L_{c}), thereby covering the preset portion of the target space and protecting the person or object from the rain and snow. When the door begins to close, the optional guides begin to retract, and the cover sheet 361 is gradually pulled into and/or rolled around the roller 362 along the uncovering direction (or path) 363B. When the door is completely shut to its (fully) closed position, the guides also fully retract and the cover sheet 361 is also rolled onto the roller 362 to its (fully) off-position, thereby uncovering the preset portion of the target space. Other configurational and/or operational characteristics of the rollable cover member 306 of FIG. 4A are similar or identical to those of FIGS. 3A and 4A.

In another exemplary embodiment, FIG. 5B represents a schematic view of another exemplary rollable cover member having an arcuate rollable cover sheet according to the present invention. An exemplary rollable cover member 306 also includes at least one rollable cover sheet 361 as well as a roller 362 which is arranged to have a shape of a truncated cone having a diameter linearly increasing along its axis 364 in a direction from its lower portion 362B to its upper portion 362A. Therefore, such a rollable cover sheet 361 may preferably be shaped as a truncated arc and/or an arc having multiple revolutions in order to match configurations of the roller 362 such as, e.g., a length of the roller 362, slope or inclination angle thereof, contour of a surface thereof, and the like. Such a cover sheet 361 attains a covering arcuate length, L_{c}, in its on-position by rolling out and exposing at least a substantial portion of the cover sheet 361 out of the roller 362 in a covering direction (or path) 363A, and attains an uncovering arcuate length, Lᵤ, in its off-position by rolling in and unexposing at least a substantial portion of the cover sheet 361 around the roller 362 along an uncovering direction (or path) 363B. It is to be understood that the rollable cover sheet 361 may have different shapes such as, e.g., triangles, squares, rectangles, and other curvilinear polygons having at least one curved side, as long as such a cover sheet 361 matches the configurations of the roller 362 and is capable of being rolled onto and out of the roller 362. The rollable cover sheet 361 may also include or be made of at least one elastic or flexible material in order to facilitate rolling of such a sheet 361 onto the roller 362 such that detailed configurations of the sheet 361 do not exactly match those of the roller 362. Other configurational or operational characteristics of the rollable cover member 306 of FIG. 5B are similar or identical to those of FIGS. 3A and 3B, FIGS. 4A and 4B, and/or FIG. 5A.

In another exemplary embodiment, FIG. 5C represents a schematic view of another exemplary rollable cover member having another three-dimensional rollable cover sheet according to the present invention. An exemplary rollable cover member 306 is generally similar to that of FIG. 5B, except that a roller 362 has a diameter increasing along its longitudinal axis 364 in a direction from its lower portion 362B to its upper portion 362A in a nonlinear fashion such that its middle portion 362C bulges out than the counterpart of FIG. 5B. In order to conform to such a contour of the roller 362, the rollable cover sheet 361 may preferably be formed as, e.g., a three-dimensional arc, and may move along a two- or three-dimensional covering or uncovering direction 363A, 363B so as to cover and uncover the preset portion of the target space, respectively. As described above, such a cover sheet 361 may include or be made of at least one elastic or flexible material as well. Other configurational and/or operational characteristics of the rollable cover member 306 of FIG. SC are similar or identical to those of FIGS. 3A to 3D, FIGS. 4A to 4D, and/or FIGS. 5A and 5B.

In another exemplary embodiment, FIG. 5D is a schematic diagram of an exemplary composite rollable cover member including multiple rollable cover sheets according to the present invention. An exemplary rollable cover member 306 includes multiple sets of rollable cover sheets such as, e.g., an upper rollable cover sheet 371A and a lower rollable cover sheet 3718, and multiple sets of rollers such as, e.g., an upper roller 372A and a lower roller 372B, where each of such cover sheets 371A, 371B is similar or identical to those of FIGS. 5A to SC and where each of such rollers 372A, 372B is similar or identical to those of FIGS. 5A to SC. In such an embodiment, the rollers 372A, 372B may be arranged to extend along different longitudinal axes 373A, 373B at a preset angle 374. In addition, the upper cover sheet 371A is arranged to roll out and in along a covering and uncovering direction (or paths) 375A, 375B, respectively, while the lower cover sheet 371B is arranged to roll in and out along another covering and uncovering direction (or path) 376A, 376B, respectively, which may be similar to or different from those of the upper cover sheet 371A. Because such cover sheets 371A, 371B may extend along different directions, they may be unrolled in different directions as well to cover a preset portion of the target space at different angles. Accordingly, the composite cover member 306 may be suitable for covering the selected portion of the target space, as exemplified in FIG. 2. As described above, the cover sheets 371A, 371B may be fixedly or movably coupled or connected to each other in various ways such as, e.g., by direct coupling, at least one conventional connector, and so on. Such cover member 306 may also include and/or made of at least one elastic material and/or configuration in order to accommodate various covering and/or uncovering movements thereof. Other configurational and/or operational characteristics of the rollable cover member 306 of FIG. 5D are similar or identical to those of FIGS. 3A through 3E, FIGS. 4A through 4E, and/or FIGS. 5A to 5C.

In another exemplary embodiment, FIG. 5E is a schematic view of another exemplary rollable cover member with a housing and a guide member according to the present invention. An exemplary rollable cover member 306 includes at least one rollable cover sheet 361, a housing 378, and a guide member. The cover sheet 361 is generally similar to that of FIG. 5B, except that multiple couplers 377 are installed according to a preset pattern on a surface thereof. The housing 378 includes a roller 362 therein and forms an opening 379 on its side through which such a rollable cover sheet 361 may roll onto and out of the roller 362. Accordingly, the housing 378 is preferably shaped and sized to retain at least a substantial portion of the cover sheet 361 when the rollable cover member 306 is in its off-position. The cover member 306 may include a first end (not shown in the figure) and/or second end 367 depending upon the mode of coupling to the door and/or article. The guide member 380 includes a pair of guides 379 which are typically similar to those of FIGS. 3F and 4F and arranged to support and guide the cover sheet 361 by fixedly or movably coupling with the couplers 377 of the rollable cover sheet 361. Further configurational or operational characteristics of the rollable cover member 306 of FIG. 5E may be similar or identical to those of FIGS. 3A through 3F, FIGS. 4A through 4F, and/or FIGS. 5A to 5D.

In operation, the rollable cover member 306 is kept to its uncovering length (Lᵤ) and retained in the housing 378 around the roller 362 when the door is in its closed position. When the door begins to open, the housing 378 coupling with the door begins to move with the door, while the second end 314 fixedly coupled to the article does not move. Therefore, the cover sheet 361 begins to be unrolled and pulled out of the roller 362 and housing 378 while extending along a covering direction (or path) 363A. The guides 379 may support and guide the cover sheet 361 during such a covering movement. When the door moves to its (fully) open position, the rollable cover sheet 361 moves to its (fully) on-position in which at least a substantial portion thereof is pulled or unrolled out of the housing 378 and roller 362 to its covering length (L_{c}), thereby covering the preset portion of the target space and protecting the person or object from the rain and snow. When the door begins to close, the rollable cover sheet 361 is gradually pulled into the housing 378 and rolled around the roller 362 along an uncovering direction (or path) 363B, while being guided by the guides 379. When the door is completely shut to its (fully) closed position, the cover sheet 361 is also rolled onto the roller 362 to its (fully) off-position, thereby uncovering the preset portion of the target space. Other configurational or operational characteristics of the rollable cover member 306 of FIG. 4A are similar or identical to those of FIGS. 3A and 4A.

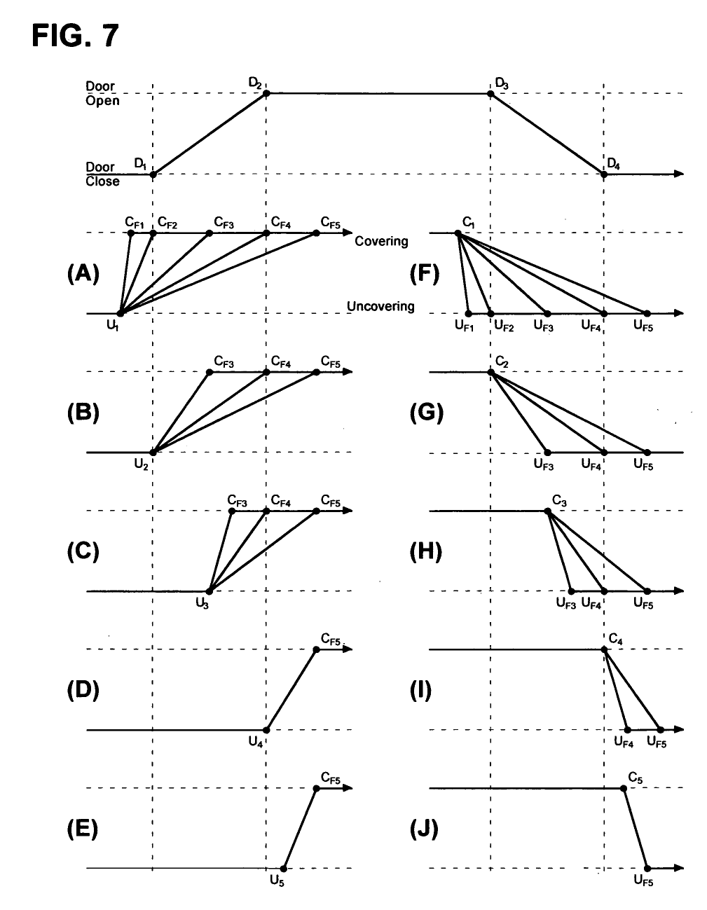

In another aspect of the present invention, an exemplary cover system may further include an exemplary cover member arranged to slide out and in so as to cover and uncover at least a portion of the target space, respectively, where FIGS. 6A to 6E show exemplary embodiments of slidable cover members and their cover sheets according to the present invention.

In one exemplary embodiment, FIG. 6A represents a schematic view of an exemplary slidable cover member with a slidable cover sheet according to the present invention. An exemplary slidable cover member 308 includes at least one slidable cover sheet 381 and at least one holder 382 through which such a slidable cover sheet 381 may be arranged to slide sideways in order to be exposed and unexposed with respect to one side of such a holder 382, thereby covering and uncovering a preset portion of the target space respectively along a covering direction (or path) 383A and an uncovering direction (or path) 383B. In the embodiment of FIG. 6A, the slidable cover sheet 381 has a rectangular shape and is made of a rigid material, while the holder 382 includes a frame 384 and an opening 385 defined through the frame 384 along a longitudinal axis 386. The covering and uncovering directions 383A, 383B are typically transverse to the longitudinal axis 386 of the holder 382 and parallel with an upper and lower portion 387A, 387B of the cover sheet 381. Characteristics of sliding movements of the slidable cover sheet 381 may be analyzed by an index such as, e.g., a degree of exposure which may be defined in an arbitrary scale but preferably range from 0.0 (i.e., an entire portion of the cover sheet 381 is disposed inward the holder 382 and unexposed) to 1.0 (i.e., the entire cover sheet 381 is disposed outside the holder 382 and exposed). Thus, the slidable cover member 308 is unexposed to have an uncovering length, Lᵤ, with a low degree of exposure in its off-position, and exposed to have a covering length, L_{c}, with a high degree of exposure in its on-position. Such a slidable cover member 308 includes at least one first end 388 and at least one second end 389 to couple the cover sheet 381 to the door and/or article.

In operation, the slidable cover member 308 is kept to its uncovering length (Lᵤ) and retained on the left side of the holder 382 when the door is in its closed position. As the door begins to open, the first end 388 coupling with the door begins to move with the door, while the second end 389 which is fixedly coupled to the article does not move. Therefore, the cover sheet 381 begins to be pulled to the right side of the holder 382 and exposed along the covering direction (or path) 383A. The guides (not shown in the figure) may also extend therealong to support and guide the cover sheet 381 during the covering movement. As the door moves to its (fully) open position, the slidable cover sheet 361 may slide to its (fully) on-position in which at least a substantial portion thereof may be pulled outward the holder 382 to its covering length (L_{c}) and the cover member 308 covers a preset portion of the target space, thereby protecting the person or object from the rain and snow. As the door begins to close, the slidable cover sheet 381 is gradually pulled to the right side of the holder 382 along the uncovering direction (or path) 383B, while being guided by the guides. As the door is completely shut to its (fully) closed position, the cover sheet 381 also slides to its (fully) off-position to the uncovering length (L_{c}), thereby uncovering the preset portion of the target space. Further configurational and/or operational characteristics of such a slidable cover member 308 of FIG. 4A may be similar or identical to those of FIGS. 3A, 4A, and/or 5A.

In another exemplary embodiment, FIG. 6B is a schematic view of another exemplary slidable cover member including a truncated arcuate slidable cover sheet according to the present invention. An exemplary slidable cover member 308 also includes at least one slidable cover sheet 381 as well as a holder 382 defining an opening 385 along a longitudinal axis of the holder 382. The cover sheet 381 of such an embodiment is typically similar to that of FIG. 6A, except that the cover sheet 381 has an arcuate shape with a radial dimension, Lᵤ, and moves arcuately with respect to or pivots about a center of rotation (not shown in the figure) defined in a lower portion of the holder 382. Accordingly, such a slidable cover sheet 381 may attain an arcuate covering length by rotating or pivoting along an arcuate covering direction 383A to its on-position where at least a substantial portion of the slidable cover sheet 381 is disposed in an exposed side of the holder 382. Such a cover sheet 381 may attain an arcuate uncovering length (Lᵤ) as well by rotating or pivoting along an arcuate uncovering direction 383B to its off-position where at least a substantial portion thereof may be disposed in an unexposed side of the holder 382. The slidable cover sheet 381 may be arranged to have different shapes and may also include or be made of at least one elastic or flexible material. Further configurational and/or operational characteristics of the slidable cover member 308 of FIG. 6B are similar or identical to those of FIGS. 3A and 3B, FIGS. 4A and 4B, FIGS. 5A and 5B, and/or FIG. 6A.

In another exemplary embodiment, FIG. 6C is a schematic view of another exemplary slidable cover member including a slidable cover sheet rollable at one corner thereof according to the present invention, where an exemplary slidable cover member 308 includes at least one slidable cover sheet 381 and a holder 382 both of which may be generally similar to those of FIG. 6A. However, at least a portion 391A of the slidable cover sheet 381 is arranged to be rollable or foldable in its off-position so that the unexposed portion 391A of the cover sheet 381 may be rolled or folded in an unexposed side of the holder 382, while an exposed portion 391B may be arranged to be flat or curved. Such a cover sheet 381 may also be arranged to be elastic or flexible in its entire portion or, alternatively, only in the portion 391A which is to be unexposed in its off-position. In another alternative, the cover sheet 381 may be made of essentially rigid materials but arranged to form multiple segments which are movably coupled to each other in order to be folded or rolled in its off-position, as exemplified in FIGS. 3A to 3F and FIGS. 4A to 4F. Other configurational or operational characteristics of the slidable cover member 308 of FIG. 6C are similar or identical to those of FIGS. 3A through 3D, FIGS. 4A through 4D, FIGS. 5A through 5C, and/or FIG. 6A and 6B.

In another exemplary embodiment, FIG. 6D shows a schematic view of yet another exemplary slidable cover member including a three-dimensional curvilinear slidable cover sheet according to the present invention. An exemplary slidable cover member 308 includes at least one slidable cover sheet 381, a holder 382, and a deforming unit 392. Contrary to the two-dimensional cover members of FIGS. 6A to 6C, the cover member 308 of FIG. 6D is arranged to be three-dimensional, i.e., its slidable cover sheet 381 is generally curved along its length and/or width, while the holder 382 preferably defines a curved opening 385 therein in order to accommodate movements of the cover sheet 381 therethrough. Such a cover sheet 381 is typically suitable for covering a preset portion of the target space disposed adjacent to vehicle doors having curved edges as exemplified in FIG. 2. The cover sheet 381 moves between its on- and off-positions and is arranged to attain curved covering and uncovering lengths by respectively moving along three-dimensional covering and uncovering directions (or paths) 383A, 383B. The deforming unit 392 is arranged to be disposed on an unexposed side of the slidable cover sheet 381 and to change its surface contour or curvature, slope, elevation, and so on. The exemplary deforming unit 392 includes a pair of rotors 393 installed immediately above and below the covering or uncovering paths 383A, 383B and defining a small gap therebetween so that the cover sheet 381 may be pressed or pushed by the rotors 393 and deform from an unexposed configuration to an exposed configuration along the covering direction 383A and from the exposed configuration to the unexposed configuration along the uncovering direction 383B. Thus, such a cover sheet 381 may be arranged to have different configurations in its on- and off-positions. Such an embodiment may offer the benefit of disposing the cover sheet 381 in its off-position in the unexposed configuration which may readily be foldable, stackable, rollable, and so on, thereby reducing a space required to retain the unexposed portion of the slidable cover sheet 381. The three-dimensional slidable cover sheet 381 and its holder 382 may have a variety of configurations, and may be made of or include any rigid, flexible or elastic materials, as long as the cover 381 and holder 382 may be able to perform the above functions. Other configurational or operational characteristics of the slidable cover member 308 of FIG. 6D are similar or identical to those of FIGS. 3A through 3E, FIGS. 4A through 4E, FIGS. 5A through 5D, and/or FIG. 6A to 6C.

In another exemplary embodiment, FIG. 6E is a schematic view of another exemplary slidable cover member with a housing and a guide member according to the present invention. An exemplary slidable cover member 308 may include multiple slidable cover sheets 381A, 381B and a holder 382, where an upper cover sheet 381A may fixedly or movably couple with a lower cover sheet 381B and where such upper and lower cover sheets 381A, 381B may be any slidable cover sheets of FIGS. 6A through 6D which are arranged to move between their on- and off-positions along similar or different covering directions or paths 383C, 383D and uncovering directions or paths 383E, 383F. The holder 382 defines multiple opening 385A, 385B formed at a preset angle 394 and to receive and release the upper and lower cover sheets 381A, 381B therethrough, respectively. Alternatively, the holder 382 may define a single opening 385 with multiple sections 385A, 385B arranged at the angle 394 as well. Accordingly, such cover sheets 381A, 381B may also be disposed at the same angle 394 in their on-positions, they may cover a greater portion of the target space at multiple angles as exemplified in FIG. 2. In order to ensure simultaneous covering and/or uncovering movements, such cover sheets 381A, 381B may be coupled to each other by a variety of conventional connectors or couplers. However, the cover sheets 381A, 381B may also be installed separate from each other and move independently of the other. The cover sheets 381A, 381B may also include multiple couplers 395 incorporated onto a surface thereof and arranged to fixedly or movably couple with guides 396 of a guide member so as to be supported and/or guided thereby. The cover member 308 may also include an optional housing (not shown in the figure) shaped and sized to retain at least a substantial portion of the cover sheet 381 in its off-position. Further configurational and/or operational characteristics of the slidable cover member 308 of FIG. 6E may be similar or identical to those of FIGS. 3A to 3F, FIGS. 4A to 4F, FIGS. 5A to 5E, and/or FIG. 6A to 6D.

Configurational and/or operational variations and/or modifications of the above embodiments of the exemplary cover systems and various cover members thereof described in FIGS. 3A through FIG. 6E also fall within the scope of this invention.

The target space is generally defined as a space which lies in the vicinity of, in proximity to or adjacent to the door opening and which is to be covered and uncovered by various cover systems of the present invention. In this context, the target space may be alternatively defined as a space which encompasses the paths through which the person or object may get into and/or out of the article. A precise dimension and/or shape of such a target space, therefore, is generally determined by various factors such as, e.g., a dimension, shape, and/or orientation of the door opening, a dimension, shape, and/or orientation of the door, a direction and/or path of movement of such a door with respect to the door opening and/or target space, and the like. Such characteristics of the target space may affect various configurational and/or operational characteristics of the cover system and/or cover member thereof such as, e.g., its dimension, shape, arrangement, orientation, installation mode and/or location, movement direction and/or path, disposition of its on- and/or off-positions, and the like. For example, when the door opens and closes laterally, the target is preferably defined in front of the door opening in order to include a space encompassed by the door moving between its open and closed positions. The cover member may be advantageously disposed over or above at least a portion of such a target space so as to protect the person or object from the rain and snow. However, when the door opens and closes vertically, the target space may be preferably defined in front of and/or along sides of the door opening, and the cover member may be disposed above and/or along the target space in order to protect the person or object from the rain and snow. Accordingly, the target space within the scope of this invention is defined to encompass the path for the person or object to get into and/or out of the article, and the cover member may be disposed adjacent to at least a portion of such a target space as far as the cover member may cover and protect such a person or object from weather conditions such as the rain and snow.

The doors of the door-door opening assemblies may be arranged to move or operate between multiple open and/or dosed positions such as, e.g., a fully closed position, at least one partially closed position, at least one partially open position, a fully open position, and so on. Movements of the doors between such positions may be continuous or incremental, gradual or instantaneous, and so on. The movements of the doors may be effected by the operator or by a conventional electrical or mechanical device of which the operation is based upon au user command, presence or absence of the operator, and so on. The cover members may similarly move between multiple on- and/or off-positions such as, e.g., a fully off-position, at least one partially off-position, at least one partially on-position, a fully on-position, and the like. The cover members may also generate various movements between the above positions, where such movements may also be continuous or incremental, gradual or instantaneous, and the like. It is noted, however, that instantaneous uncovering movements of the cover members may not necessarily be desirable or achievable due to hardware limitations as described above.

The above cover members or, more particularly, their cover sheets including cover sheds may be arranged to have various shapes and/or sizes as described above. More particularly, such cover sheets may be arranged to have different shapes and/or sizes in their on- and off-positions. As long as the cover members may move between such positions and cover the preset portion of the target space in their on-positions, such cover members may have almost any arbitrary shapes and/or sizes. In addition, the cover sheets may be made of, may include, and/or may be treated to be water proof or water repellant in order to prevent the rain and snow to seep therethrough. Furthermore, such cover sheets may be transparent, translucent, and/or opaque in order to improve visibility therethrough or to block transmission of light therethrough.

It is appreciated that all of the above exemplary cover members share a common feature, i.e., they may change at least one of its configurations and/or have at least one different configuration between their on- and off-positions. Examples of such configurations may include, but not be limited to, a length, width, and/or height measured along a longitudinal and/or vertical axis of of such a cover sheet, a thickness and/or elevation measured across the cover sheet, a radius or diameter measured about a center of rotation of the cover sheet, a curvature or contour measured along a surface of the cover sheet, an arrangement of and/or between the cover sheets, an overlap over the cover sheets, an angle formed along the cover sheet, a slope of along the surface of the cover sheer, a molecular or microscopic structure of the cover sheet, and so on. In addition, the radius or diameter may include the inner and outer dimensions, while the length, width, height, thickness, and elevation may include those measured along the linear, arcuate, and/or curved covering or uncovering paths or directions. When the cover member may include a housing, these configurations may also include those retained inside the housing and/or those exposed out of such a housing. Therefore, such configurations may include the foregoing configurations of the cover sheet retained inside the housing by being, folded, stacked, and/or rolled therein as well as those configurations of the cover sheet exposed out of the housing by being unfolded, unstacked, and/or unrolled therefrom. It is appreciated that each of such configurations has at least one covering value in the on-position and at least one uncovering value in the off-position. Depending upon a definition of a given configuration, such a covering value may be arranged to be greater than or less than its uncovering counterpart. For example, the covering value of the configurations such as the length, width, radius, diameter, and angle are typically greater than their uncovering values. In contrary, the covering values of such configurations such as the height, thickness, elevation, curvature, and slope are generally less than their uncovering values. It is to be understood, however, that the magnitudes of the covering and uncovering values may depend upon how a specific configuration may be defined. For example, the cover sheet of the cover member of FIG. 3D may unfold along the covering direction which is arcuately counterclockwise and downward. Thus, the elevation of the entire cover member measured between the downwardly moving section and the stationary section may increase as the cover sheet unfolds, while the elevation of a pair of adjoining polygonal sections may decrease during a covering movement of the foldable cover member. In this context, the covering values may be greater than, equal to or less than the uncovering values for the configurations such as, e.g., the arrangements of or between the cover sheets, macroscopic or microscopic structures of the cover sheet, overlap between the sections or cover sheets, angles, and so on, depending upon their definitions.

The foregoing cover members may be directly or indirectly coupled to the door and/or article by various embodiments. For example and as exemplified in some of the figures, the cover member may include at least one first end and at least one second end on its opposing ends, where the first end is coupled to the door (or article), while the second end is coupled to the article (or door). Such first and second ends may be fixedly coupled to the cover member or form an unitary article therewith, or may be releasably coupled thereto so that the user may first install the first and/or second ends to the door or article and install the cover member therebetween thereafter. Alternatively, the door and/or article may be arranged to form one or both of such ends, while the cover member may include only one or none of such ends. It is appreciated that, as long as the cover member may be installed between the movable door and stationary article, detailed coupling configuration and inclusion of such ends are not material to the scope of the present invention.

At least a portion of the foregoing cover sheets may be made of or include at least one elastic or flexible material, e.g., such that the cover sheet may bend along the top and/or bottom lines or other curvilinear lines along which the sheet may fold and unfold, that such a sheet may change its slope, curvature, contour, and/or angle during its movements between the on- and off-positions, and so on. Such an embodiment may prove beneficial when at least a portion of the cover sheet is arranged to be folded, stacked, rolled, and/or sled into the housing having dimensions different from those of the cover sheet, e.g., by allowing such a cover sheet to deform and to be retained inside such a housing. The cover sheet may also include multiple segmental sheets which are fixedly and/or movably coupled to each other. Such segmental sheets may also be arranged to have different configurations and/or mechanical properties such as, e.g., elasticity, transparency, and so on, in order to accommodate the covering and/or uncovering movements of the cover member, to enhance visibility therethrough, and the like. In addition, the cover sheets may include one or both of the first and second ends in order to be coupled to the door and/or article. However, when the connectors or couplers are to be installed to the door and/or article, the cover member itself may not include none of the first and second ends. It is appreciated that such elastic or flexible cover member may also be made of rigid materials which are movably coupled to each other in order to exhibit apparent elasticity or flexibility.

The foregoing cover member may include multiple cover sheets of the same or different kinds. For example and as shown in FIGS. 3E, 4E, 5D, and 6E, multiple cover sheets of the same kind may be movably coupled at preset angles and arranged to move between their on- and off-positions in order to cover the preset portion of the target space at multiple angles. Alternatively, multiple cover sheets of different kinds may be coupled at preset angles and arranged to move between their on- and off-positions as well. Whether they may be of the same or different kinds, multiple cover sheets may be coupled or connected to each other in a direction transverse to or in parallel with the covering and/or uncovering directions, with or without any gap therebetween. Such multiple cover sheets may also be directly connected to each other or, in the alternative, indirectly connected to each other by using conventional rigid or elastic couplers or connectors which may or may not provide any slack between a top, bottom, and/or side of such multiple cover sheets, where such couplers or connectors may be arranged to accommodate different movements of the cover sheets in their covering and uncovering directions. In addition, the multiple cover sheets may have identical or different configurations and/or mechanical properties such as, e.g., elasticity, transparency, and the like.

The foregoing cover sheets may also be arranged to change the cross-sections defined along the covering and/or uncovering directions and/or along directions normal or angled with respect to the covering and/or uncovering directions between their on- and off-positions. For example, such cover sheets may change their cross-sections by including a rigid structure having a stressed, flat shape in its off- or on-position and an unstressed, extended shape in its on- or off-position. Alternatively, such cover sheets may include a shape-memory material capable of changing its cross-section in response to changes in humidity and/or temperature.

The above cover systems may include various optional guide members arranged to support or guide the cover members and/or their cover sheets during their covering and uncovering movements. Such guide members generally include one or more guides which may be fixedly installed to the door and/or article and define a preset path along which the cover members and/or sheets movably travel. In the alternative, such guides may be arranged to extend and retract along with the movements of the cover member between the on- and off-positions thereof and to guide such movements of the cover member. Detailed configurations and operations of such guide members are generally not material to the scope of the present invention as far as such guide members may support and/or guide the cover member during the covering and/or uncovering movements thereof.

The foldable cover members may be arranged to have configurations which are different from those exemplified in FIGS. 3A through 3F. For example, such top and bottom lines may be provided on the cover sheet at least substantially parallel with each other or in different directions to form angles, and may be two- or three-dimensional. Because the top and bottom lines may be formed in almost any configurations, the curvilinear polygonal sections defined therebetween may also be arranged to have a variety of configurations such that each section may have a length, width, height, thickness, radius, diameter, elevation, and/or angle which may be uniform or varying along its longitudinal and/or vertical axes or along the covering and/or uncovering paths. In addition, such a polygonal section may have a symmetric or asymmetric shape. Multiple polygonal sections may also be arranged to have uniform or different shapes and/or sizes, to be disposed according to a symmetric or asymmetric arrangement, to be two- or three-dimensional, and the like. When desirable, such cover sheets may be arranged to be folded and unfolded not along the top and/or bottom lines. In addition, such cover sheets may also be arranged to be folded and unfolded along or at a preset angle with the covering and/or uncovering directions.

The foldable cover sheets move along the covering and uncovering directions or paths which are generally normal or transverse to the top and/or bottom lines thereof, where such covering paths or directions are typically be identical to the uncovering paths or directions but in opposite directions. Alternatively, such covering paths or directions may be arranged to be different from the uncovering paths or directions. In addition, the covering and uncovering paths or directions may be linear and/or curved (e.g., circular, oval, angular or arcuate), two or three-dimensional, and so on. Such paths or directions may also be horizontal or vertical, angles, upward or downward, arcuate, rotational, and/or extending outwardly or retracting inwardly in relation to the door, door opening, target space, and/or article.

Depending upon the covering and/or uncovering patterns, the polygonal sections of the cover sheet may be arranged to be sequentially fold and/or unfold one after another from left to right or vice versa, where the degree of folding may incrementally decrease or increase when the cover member respectively covers or uncovers the portion of the target space. Alternatively, the cover sheet may be unfolded and folded uniformly throughout the entire portion of the cover sheet, where the degree of folding may uniformly decrease or increase as the cover member respectively covers or uncovers such a portion of the target space.

The stackable cover members may be arranged to have configurations different from those of FIGS. 4A through 4F. First of all, it is appreciated that the stackable cover members may be deemed to be generally similar to the foldable cover members, except that the polygonal sections of the foldable cover sheets of the foldable cover members are contiguous, while the cover sheds of the stackable cover members are not. Accordingly, all of the foregoing variations and/or modifications regarding the top lines, bottom lines, and polygonal sections of the foldable cover members equally apply to each of the cover sheds of the stackable cover members.

The cover sheds may be arranged to have an identical shape and size so that they may form a stack of sheds having the same length and width as the individual cover sheds. In the alternative, the cover sheds may also have different shapes and/or sizes, e.g., their lengths and/or widths increasing (or decreasing) from a top cover shed to a bottom cover shed, increasing (or decreasing) from such a top shed to a middle shed and then decreasing (or increasing) to the bottom shed, and so on. When desirable, the cover sheds may also have different shapes and/or sizes without any preset pattern in order to cover the selected portion of the target space having irregular shapes and/or sizes.

Such cover sheds may be connected or coupled to each other by various embodiments. For example, at least a substantial number of the sheds may be connected to each other sequentially by at least one string or other conventional connectors or, alternatively, each pair of the adjacent sheds may be separately connected to each other by such strings or connectors. In both embodiments, the cover sheds may be arranged to form protrusions and matching grooves, depressions or indentations in order to facilitate coupling of the adjacent cover sheds, while optionally restraining such sheds from moving beyond preset ranges. Alternatively and as exemplified in FIG. 4E, the cover sheds may have the apertures through which the string or other connectors are inserted to fixedly or movably couple the sheds. Regardless of the coupling mechanism, such strings or other connectors may be made of or include at least one elastic material so as to provide elasticity to the cover member. In addition, the above protrusions, grooves, and/or apertures may be provided in any desirable locations on the cover sheds such as, e.g., in their top, middle or bottom portions, as long as they may allow the cover sheds to move between their on- and off-positions.

Similar to the foldable cover sheets, the above cover sheds of the stackable cover sheet may be arranged to be sequentially unstacked (or stacked) one after another from top to bottom (or vice versa). In such an embodiment, the degree of stacking may decrease (or increase) gradually, and the degree of overlap may become lower (or higher) for the top cover sheds and higher (or lower) for the bottom cover sheds, while the cover sheds may cover (or uncover) the selected portion of the target space. Alternatively, the cover sheds may be unstacked (or stacked) uniformly throughout the entire portion of the cover sheet, while both of the degree of stacking and degree of overlap may uniformly decrease (or increase) as the cover member may cover (or uncover) the preset portion of the target space.

Such stackable cover sheets generally move along the covering and uncovering directions (or paths) which may be generally similar or identical to those for the foldable cover sheets as described above. In addition, the cover shed of the cover sheet may be comprised of multiple segments which are coupled to each other vertically, horizontally or at angles. When desirable, some cover sheds or their segments may have different mechanical or chemical properties from the rest thereof in order to generate various covering or uncovering movements along various covering or uncovering directions (or paths) which may identical to or different from the covering directions. In addition, such covering and uncovering directions (or paths) may also be linear and/or curved (e.g., circular, oval, angular or arcuate), two or three-dimensional, and so on. Such paths or directions may be horizontal or vertical, angles, upward or downward, arcuate, rotational, and/or extending outwardly or retracting inwardly in relation to the door, door opening, target space, and/or article.

The rollable cover members may be arranged to have configurations which are different from those exemplified in FIGS. 5A through 5E. For example, the rollable cover sheet may have almost any shapes and/or sizes as far as such a sheet may be rolled onto and out of the matching roller between its on- and off-positions. Accordingly, the cover sheet may have the shapes of the rectangle, square, triangle, arc, truncated arc, trapezoid, circle, oval, ellipse, hexagon, and/or other curvilinear polygons. The rollable cover sheet may be arranged to have a perimeter and/or cross-section varying along its longitudinal and/or vertical directions. Such a cover sheet may also be arranged to be two- or three-dimensional, and their covering and/or uncovering directions may be identical to or different from each other. The rollable cover sheet may be arranged to be symmetric with respect to the covering and/or uncovering directions thereof or, in the alternative, to be asymmetric in order to cover and uncover the preset portion of the target space. It is appreciated that such a rollable cover sheet and its roller may have to be arranged to match each other when such a cover sheet is generally rigid. However, the cover sheet and/or roller do not have to exactly match each other when such a cover sheet is made of or include at least one elastic or flexible material, because such a sheet may easily conform to the roller during its covering and uncovering movements.

The rollable cover sheet may also include multiple segments coupled to each other horizontally, vertically or at angles. Some segments may be arranged to have different mechanical and/or chemical properties from the rest thereof in order to generate various covering or uncovering movements along various covering or uncovering directions (or paths).

At least a portion of the rollable cover sheet may be arranged to be elastic or flexible such that the cover sheet may change its shape, slope, curvature, contour, and/or angle during its covering and uncovering movements. The cover sheet may also be arranged to change its cross-section by, e.g., elongation or stretching thereof, between its stressed and unstressed states which may correspond to its on- and off-positions, respectively (or vice versa). Alternatively, the cover sheet may include at least one shape-memory material to change its shapes including its cross-section based on external temperature, humidity, and so on.

The slidable cover members may be arranged to have configurations which are different from those exemplified in FIGS. 6A through 6E. For example, the slidable cover sheet may have almost any shape and/or size such as, e.g., a triangle, rectangle, trapezoid, square, arc, truncated arc, and other curvilinear polygons having straight and/or curved sides. Such cover sheets may also be arranged to be symmetric or axisymmetric with respect to the covering and/or uncovering directions or the center of rotation thereof. Therefore, the shapes and/or sizes of the holder and its opening may be arranged to accommodate such cover sheets and to allow the covering and/or uncovering movements thereof.

Similar to other cover members, the slidable cover member may also be arranged to form two- or three-dimensional shapes, and their covering and uncovering directions may be identical to, similar to or different from each other. The slidable cover sheet may also include multiple segments coupled to each other and having identical, similar or different physical and/or chemical properties.

At least a portion of the slidable cover sheet may be made of or include at least one elastic or flexible material in order to change its dimensions, slope, contour, curvature, and/or angle during the movements between its on- and off-positions. The cover sheet may also be arranged to change its cross-section by, e.g., elongation or stretching thereof, between its stressed and unstressed states which may correspond to its on- and off-positions, respectively (or vice versa). Alternatively, such a cover sheet may include at least one shape-memory material to change its shapes including its cross-section based on external temperature, humidity, and so on. Such a slidable cover member may not include the foregoing holder depending upon coupling modes thereof. For example, such a holder may be incorporated into the door and/or article or, in the alternative, a portion of the door and/or structure may be designed to perform similar functions as the holder.

It is to be understood that such a cover member may be constructed by incorporating different configurational and/or operational characteristics from multiple cover members described heretofore. For example, a given cover member may be arranged to adopt the configurations of one of the rollable cover members and the operational characteristics of the slidable cover members. As long as such a cover member may be able to change at least one configuration thereof and to cover and uncover at least a portion of the target space in its on- and off-positions, respectively, detailed configurational or operational characteristics thereof may not be material to the scope of the present invention.

In another aspect of the present invention, the foregoing cover members and/or cover sheets thereof may be arranged to be in at least one temporal relation to (i.e., temporal synchronization with) the movements of the door between its open and closed positions and/or arrangements between the door and door opening. FIG. 7 is a series of schematic diagrams for exemplifying temporal relations or synchronization between movements of the above exemplary cover members and/or doors according to the present invention.

A top diagram represents a status of the door, where an abscissa represents time and where an ordinate is a position of the door between its closed and open positions. An event D₁ is a timing (or moment) when the door begins to move toward its (fully) open position from its (fully) closed position, while an event D₂ is a timing when the door reaches its (fully) open position. Accordingly, a slope of a line connecting these two points, D₁ and D₂, represents a speed of the door opening from its closed position to its open position. Similarly, an event D₃ is a timing when the door begins to close toward its (fully) closed position from its (fully) open position, whereas an event D₄ is a timing when such a door reaches its (fully) closed position. A slope of a line connecting these two points, D₃ and D₄, therefore, represents a speed of the door closing from its open position to its closed position.

In contrary, subsequent diagrams labeled from (A) to (J) denote various states of any of the above exemplary cover members and/or their cover sheets or sheds, where an abscissa is time and where an ordinate represents a position of such cover members, sheets, and/or sheds between their on-positions and off-positions. More particularly, various events designated in the diagrams (A) to (J) are marked along a time frame which is identical to that for marking the foregoing events, D₁ to D₄, of the top diagram, in order to synchronize various events of the door with those of the cover members, sheets, and/or sheds. Therefore, diagrams (A) through (E) represent various events associated with the covering movements of the cover members, sheets, and/or sheds, whereas diagrams (F) through (J) denote various events associated with the uncovering movements thereof.

In the diagram (A), one of the above cover members is arranged to begin to move from its off-position toward its on-position along one of the foregoing covering directions (or paths) in a timing, U₁, and to reach its (fully) on-position in one of timings, C_{F1}, C_{F2}, C_{F3}, C_{F4}, and C_{F5}, where the timing, C_{F1}, is a moment before D₁ (i.e., when the door is kept in its (fully) closed position), where the timing, C_{F2}, is a moment of D₁ (i.e., as the door starts to open from its closed position), where the timing, C_{F3}, denotes a moment after D₁ but prior to D₂ (i.e., after the door begins to move but before the door reaches its (fully) open position), where the timing, C_{F4}, is a moment of D₂ (i.e., when the door reaches its (fully) open position), and lastly where the timing, C_{F5}, is a moment after D₂ but prior to D₃ (i.e., after the door reaches its (fully) open position but before the door begins to close). Because the cover members of the first two examples such as U₁-C_{F1} and U₁-C_{F2} move to their on-positions before the door begins to move, they may cover a preset portion of the target space before a person or object may enter such a target space. To the contrary, the cover members of the following three embodiments, U₁-C_{F3}, U₁-C_{F4} and U₁-C_{F5}, may start to cover the preset portion of the target space but may not reach their (fully) on-positions before the door moves. Accordingly, the cover member of U₁-C_{F3} may cover only a small portion of the target space when the door starts to move, an incrementally greater portion thereof as the door opens and continues to move toward its open position, and the entire preset portion of such a target space before the door moves to its fully open position. Alternatively, the cover member of U₁-C_{F4} may cover only a small portion of the target space when the door starts to move, an incrementally larger portion thereof when the door opens and continues to move toward its fully open position, and the entire preset portion of the target space when the door reaches its fully open position. The cover member of U₁-C_{F5} operates generally similar to that of U₁-C_{F4}, except that such a member may cover the entire portion of the target space after the door reaches its fully open position. Accordingly, such cover members of U₁-C_{F3}, U₁-C_{F4}, and U₁-C_{F5} may not guarantee to cover the entire preset portion of the target space when the person or object enters the target space.

In the diagram (B), the cover member is arranged to start to move from its off-position toward its on-position along one of the above covering directions (or paths) in a timing, U₂, and then to reach its (fully) on-position in one of timings, C_{F3}, C_{F4}, and C_{F5}, which have been defined in the diagram (A). In all of the above embodiments, the cover members are arranged to move from their off-positions to their on-positions simultaneously with or as the door begins to open from its closed position to its open position. Accordingly, such cover members may cover only a small portion of the target space when the door starts to move, an incrementally greater portion thereof as the door opens and continues to move toward its open position, and then the entire preset portion of the target space before the door moves to its fully open position (U₂-C_{F3}), as the door reaches its fully open position (U₂-C_{F4}), or after the door reaches its fully open position (U₂-C_{F5}). Accordingly, such cover members of U₂-C_{F3}, U₂-C_{F4}, and U₂-C_{F5} may not guarantee to cover the entire preset portion of the target space when the person or object enters the target space. The foregoing covering movements of the cover members may be easily practiced, e.g., by mechanically coupling the cover member with the door. Because the cover members of U₂-C_{F3} and U₂-C_{F5} do not reach their fully on-positions precisely as the door reaches its fully open position, such cover members may optionally be moved by the operator or actuator member which may include optional sensor and/or convert members as will be described below.

In the diagram (C), the cover member is arranged to begin to move from its off-position toward its on-position in one of the above covering directions (or paths) in a timing, U₃, and to reach its (fully) on-position in one of timings, C_{F3}, C_{F4}, and C_{F5}, as described heretofore. In all embodiments, the cover members are arranged to move from their off-positions toward their on-positions after the door starts to open from its closed position toward its open position but before such a door reaches its fully open position. Accordingly, the cover members may cover only a small portion of the target space after the door starts to open, an incrementally larger portion thereof as the door moves closer to its fully open position, and then the entire preset portion of the target space before the door moves to its fully open position (U₃-C_{F3}), as the door reaches its fully open position (U₃-C_{F4}), or after the door reaches its fully open position (U₃-C_{F5}). Other operational characteristics of the foregoing exemplary temporal relations are similar or identical to those of the foregoing diagrams (A) and (B).

In the diagrams (D) and (E), the cover members are arranged to begin to move from their off-positions toward their on-positions along the covering directions (or paths) in other timings, U₄ and U₅, and to reach their (fully) on-positions in a timing, C_{F5}, where U₄ is the timing when the door reaches its fully open position, where U₅ is the timing after the door reaches its fully open position, and where C_{F5} has been defined heretofore. In general, the cover members of U₄-C_{F5} and U₅-C_{F5} may not effectively protect the person or object from the precipitations because they may cover the preset portion of the target space some time after the door starts to open. Other operational characteristics of the above exemplary temporal relations are similar or identical to those of the foregoing diagrams (A) to (C).

In the diagram (F), one of the above cover members is arranged to start to close from its (fully) on-position toward its (fully) off-position along one of the foregoing uncovering directions (or paths) in a timing, C₁, and then to reach its fully off-position in one of timings, U_{F1}, U_{F2}, U_{F3}, U_{F4}, and U_{F5}, where the timing, U_{F1}, is a moment before D₃ (i.e., when the door is kept in its fully open position), where the timing, U_{F2}, is a moment of D₃ (i.e., as the door starts to close from its open position), where the timing, U_{F3}, denotes a moment after D₃ but prior to D₄ (i.e., after the door begins to close but before the door reaches its fully closed position), where the timing, U_{F4}, is a moment of D₄ (i.e., as the door reaches its fully closed position), and where the timing, U_{F5}, is a moment after D₄ (i.e., after the door reaches its fully closed position. Because such cover members of the first two embodiments such as C₁-U_{F1} and C₁-U_{F2} move to their off-positions before the door begins to close, these cover members may tend to uncover the preset portion of the target space even before the person or object may leave the target space. To the contrary, the cover members of the next three embodiments, C₁-U_{F3}, C₁-U_{F4}, and C₁-U_{F5}, similarly start to uncover such a portion of the target space before the door begins to close but reach their fully off-position before the door reaches its fully closed position (C₁-U_{F3}), as the door reaches such a position (C₁-U_{F4}), or after the door reaches such a position (C₁-U_{F5}). Thus, the cover members of C₁-U_{F3}, C₁-U_{F4}, and C₁-U_{F5} may still expose the person or object to the rain and snow, although they may not completely uncover such a portion of the target space before the door starts to close.

In the diagram (G), the cover member is arranged to start to move from its on-position toward its off-position along the uncovering direction (or path) in a timing, C₂, (i.e., as the door starts to close) and to reach its (fully) off-position in one of timings, U_{F3}, U_{F4}, and U_{F5}, which have been defined in the diagram (F). Accordingly, the cover members may cover the entire preset portion of the target space as the door starts to close, uncover incrementally greater portions thereof as the door moves toward its closed position, and uncover the entire preset portion of the target space before the door moves to its fully closed position (C₂-U_{F3}), as the door reaches its fully closed position (C₂-U_{F4}), or after the door reaches its fully closed position (C₂-U_{F5}). Therefore, the cover members according to this embodiment provides better coverage and protection of the person or object leaving the target space than that of the diagram (F), although such cover members may still uncover the target space before the person or object leaves the target space. The above uncovering movements of the cover members may be easily practiced, e.g., by mechanically coupling the cover member with the door. However, because the cover members of C₂-U_{F3} and C₂-U_{F5} may not reach their fully off-positions precisely as the door reaches its fully open position, such cover members may also be moved by the operator or actuator member including optional sensor and/or convert members as will be described below.

In the diagram (H), the cover member is arranged to begin to move from its on-position toward its off-position along one of the above uncovering directions (or paths) in a timing, C₃, and to reach its (fully) off-position in one of timings, U_{F3}, U_{F4}, and U_{F5}, as described heretofore. In all embodiments, the cover members are arranged to move from their on-positions toward their off-positions after the door starts to move from its open position toward its closed position, but before the door reaches its fully closed position. In addition, the cover members may uncover only a small portion of the target space after the door starts to close, an incrementally larger portion thereof as the door moves closer to its fully closed position, and then the entire preset portion of the target space before the door moves to its fully open position (C₃-U_{F3}), as the door reaches its fully closed position (C₃-U_{F4}), or after the door reaches its fully closed position (C₃-U_{F5}). Therefore, the cover members of this embodiment provides better protection of the person or object leaving the target space than those of the diagrams (F) and (G). Other operational characteristics of such exemplary temporal relations are similar or identical to those of the foregoing diagrams (F) and (G).

In the diagram (I), the cover member is arranged to begin to move from its on-position toward its off-position along the uncovering direction (or paths) in another timing, C₄, and to reach its fully off-position in one of timings, U_{F4} and U_{F5}, where C₄ is the timing when the door reaches its fully closed position and where U_{F4} and U_{F5} have been defined heretofore. In the diagram (J), the cover member is arranged to begin to move from its on-position toward its off-position along the uncovering direction (or paths) in another timing, C₄, which is the timing after the door reaches its fully closed position. In general, such cover members of C₄-U_{F4}, C₄-U_{F5}, and C₅-U_{F5} may rather effectively protect the person or object from the precipitations because they may only uncover the preset portion of the target space as or after the door is completely closed and the person or object may leave the target space. Other operational characteristics of such exemplary temporal relations are similar or identical to those of the foregoing diagrams (F) to (H).

Configurational and/or operational variations and/or modifications of the above embodiments of the exemplary temporal relations for the cover systems and various cover members thereof described in FIG. 7 also fall within the scope of this invention.

The foregoing exemplary temporal relations are described with reference to the fully open and closed positions of the door and the fully off- and on-positions of the cover members. Such relations may readily be applied to the doors moving between or through partially open and/or closed positions and/or to the cover members moving between or through partially on- and/or off-positions. The only difference between such doors and/or cover members from those of FIG. 7 is that vertical distances along the ordinates may be shorter for such doors and/or cover members moving between the partial positions.

Various cover members of the present invention may be arranged to employ any of the above covering temporal relations exemplified in the diagrams (A) to (E) and/or any of the above uncovering temporal relations exemplified in the diagrams (F) to (J). Therefore, the cover member may move from its off- to on-position before, as or after the door moves from its closed to open position, and may also move from its on- to off-position before, as or after the door moves from its open to closed position.

In order to provide best protection of the person or object and as described in such foregoing diagrams, such cover members are preferably arranged to move to their fully on-positions before the door starts to open toward its fully open position, and to move back to their fully off-positions after the door moves to its fully closed position. Assuming that the person or object is not present inside such a target space before the door starts to open and/or after the door is completely closed, such cover members may guarantee to protect the person or object from the precipitations. In the alternative, the cover members may generate the covering and/or uncovering movements along with the opening and closing movements of the door, while providing better protection of the person or object. For example, the cover members may be arranged to move from their off- to on-positions along the covering and/or uncovering paths along which the person is expected to get into and/or out of the article. By properly synchronizing such movements of the cover members, such cover members may prove as effective as those described earlier in this paragraph.

The above covering and uncovering movements of the cover members may be generated by numerous modes. In one exemplary embodiment, such movements may be manually generated by an operator of the article such as, e.g., a person getting into or out of a vehicle and/or structure. In one example, the cover system may include at least one handle with which the operator manually moves the cover member from its off-position to its on-position. In another example, the cover system may include at least one switch arranged to activate the actuator member which moves the cover member from its off-position to its on-position. Examples of such actuator members may generally include, but not be limited to, conventional electrical, mechanical, pneumatic, and magnetic motors. In yet another example, the cover system may also include at least one sensor member arranged to monitor various external weather conditions, to generate at least one sensing signal, and then to deliver such a signal to the actuator member in order to engage or disengage such an actuator member. Examples of such sensors may include, but not be limited to, motion sensors for detecting the movements, presence, or absence of the person and/or object disposed in or moving across the target space, motion sensors for detecting the movements of the door, position or displacement sensors for detecting the position of the door, weather sensors for monitoring precipitations such as rain and/or snow, humidity sensors, temperature sensors, light or illumination sensors, sensors for monitoring wind speeds, sensors for detecting the timings of the movements of the door and/or cover member, sensors for measuring the duration of the door in its open or closed position, sensors for monitoring the cover member in its on-or off-position, and the like.

As described above, the cover members may be directly and/or indirectly coupled to the door in order to move at least substantially simultaneously with the door. In this embodiment, the covering and/or uncovering movements of the cover member may be determined by the opening and/or closing movements of the door. In the alternative, the movements of the cover member may be generated by the operator and/or actuator member so as to optionally render the movements of the door to become independent of the movements of the door. For example, the cover member may move between their on- and off-positions at preset timings, at preset intervals, within preset periods from occurrences of preset events such as, e.g., opening and/or closing of the door, appearance or disappearance of the operator or object in the target space, presence of precipitations, and so on. In addition, such a cover members and doors of FIG. 7 may move between their positions at constant speed (as exemplified by straight lines with constant slopes connecting different events) or at variable speeds (not shown in the figure) so that the cover members may move faster or slower than the doors during their covering and/or uncovering movements.

Such cover systems may be arranged to vary the speeds of their covering and/or uncovering movements in order to accommodate various design considerations thereof. For example, when such a cover member is directly coupled to the door, the speeds of the movements of such a cover member are determined by those of the door. Accordingly, when the user happens to abruptly open or close the door with excessive forces or speeds, the cover member may not be able to catch up with such forces or speeds, inflicting mechanical damages onto the cover member. In order to prevent such, the cover system may include at least one viscous unit capable of dissipating at least a portion of energy of mechanical shock and dampening the movements of the cover member compared to the movements of the door. The cover system may include at least one gear assembly for increasing or decreasing the speeds of the movements thereof compared to those of the door. In either embodiment, the cover member may be arranged to reach its off- and/or on-positions before and/or after the door reaches its closed and/or open positions. The cover system may also include at least one mechanical device for providing offsets such that the cover member may not move until the door moves a preset distance, until the covering and/or uncovering forces and/or acceleration may reach a preset value, and so on. Such a mechanical device may also be arranged to provide a preset time lag between the movements of the cover member and those of the door. Alternatively, the cover system may include the actuator member controlled by an electrical controller providing similar offsets, time lags, timing functions, and the like.

The cover system may include at least one convert member arranged to change timings and/or temporal characteristics of such covering and/or uncovering forces and/or movements generated by the operator and/or actuator member. For example, the convert member may be arranged to receive one of such forces from the operator and/or actuator member and then to deliver one of such forces to the cover member at a preset timing and/or after a preset period of time. Examples of such convert members may include, but not be limited to, mechanical devices with offset forces or displacements, mechanical devices including viscous dampers to dissipate energy, mechanical devices providing time lags, electrical devices with control capabilities, and so on. It is appreciated that the actuator member with or without the foregoing optional sensor and/or convert members may also be arranged to move the cover member independent of the movements of the door, i.e., before, simultaneously with or after the door moves from its off- to on-position or vice versa.

In another aspect of the present invention, the foregoing cover members and/or cover sheets thereof may be arranged to be in at least one spatial relation to (i.e., spatial synchronization with) the movements of the door between its open and closed positions and/or the arrangements between the door and door opening.

In one exemplary embodiment, the above covering and/or uncovering movements of the cover member from one to the other of its on- and off-positions may be in the spatial relation with respect to the opening and/or closing movements of the door between its open and closed positions. Therefore, the covering and/or uncovering movements may be arranged to be along a direction identical to, similar to, or different from the opening and/or closing movements of the door by a preselected pattern. Such movements of the cover member may be arranged to have amplitudes such as, e.g., curvilinear length thereof which may be identical to, similar to, or different from those of the door by a preset ratio. It is appreciated that the foregoing spatial relation does not necessarily accompany any temporal relation between the movements of the cover member and door so that the spatial relation between the cover member and door may be practiced one after the other or simultaneously in preset intervals. To this end, the above conversion member may be incorporated to provide the spatial relation with or without accompanying the temporal relation.

In another exemplary embodiment, the above covering and/or uncovering paths (or directions) of the cover member between its on- and off-positions may be in another spatial relation with respect to the opening and/or closing paths (or directions) of the door between its open and closed positions. For example, one end of the cover member may be directly or indirectly coupled to the door such that the cover member may move along the same or similar paths whether simultaneously, before or after the opening and/or closing movements of the door. In such an embodiment, the operator of the door or actuator member may be arranged to provide one or both of the opening and closing forces for the door which may in turn serve as one or both of the covering and uncovering forces for such a cover member. The cover system may also include the convert member coupled between the cover member and door and transforming or converting one of the foregoing movements such that the cover member and door may move along similar or different paths simultaneously or one after the other. More details of the convert member will be described below. In another example, the cover member and door may not be directly coupled to each other, whereas the cover member may be arranged to move along the covering and/or uncovering paths which are similar or identical to the opening and/or closing paths of the door. In yet another example, the cover member may be arranged to move along the covering and uncovering paths which may not generally depend upon the opening and closing paths of the door. In the latter two examples, the cover members may move by the covering and uncovering forces which may be provided directly by the operator or actuator member. In addition, the covering and uncovering paths of the cover member may include at least one linear section and/or at least one curved section each of which may be arranged to be either horizontal or vertical, forward or backward, downward or upward, rotational, extending, and/or retracting with respect to the door, door opening and/or target space, where the curved section may be circular, arcuate, elliptical, hyperbolic, and the like.

In another exemplary embodiment, such covering and/or uncovering movements, paths, and/or directions of the cover member from one to the other of its on- and off-positions may be in the spatial relation to at least a portion of the target space, with or without being related to the movements, paths, and/or directions of the door. Therefore, the covering and/or uncovering paths of the cover member may be disposed above the preset portion of the target space such that the cover member may cover and uncover such a portion of the target space from above. Alternatively, the cover member may be disposed beside the preset portion of the target space in order to cover and uncover such a portion of the target space from its side. When desirable, the cover member may also be arranged to cover and uncover the preset portion of the target space at a preset angle. It is appreciated that the cover member moving between its on- and off-positions according to such a spatial relation may or may not intersect the target space. In addition, the covering and uncovering paths of the cover member may be arranged to differ from each other and/or to intersect different portions of the target space. When desirable, the cover member may be arranged to have the covering and uncovering paths which may be different in not only their vector directions but also their amplitudes.

In another aspect of the present invention, the foregoing cover members or their cover sheets moving between their on- and off-positions may also be arranged to be in at least one complementary relation to the doors moving between their open and closed positions. In particular, at least a portion of such covering and/or uncovering forces for the cover member may be operatively coupled to and generated by the opening and/or closing forces of the door, with or without accompanying any of the foregoing temporal and/or spatial relations. To this end, a cover system may include at least one force generating member for generating, storing, and/or releasing energy which may be arranged to at least partially cause one of the covering and/or uncovering movements of the above cover members. For example, at least one of the movements of the cover member from one to the other of the on- and off-positions may be in the complementary relation to at least one of the movements of the door from one to the other of the open and closed positions. By definition, the cover member moves from its off- to on-position by a covering force, and from its off- to on-position by an uncovering force, where one of such forces may be in the complementary relation to the other of such forces. Such forces may also be extension vs. compression force, torques acting in opposite or different directions, and the like.

Various force generating members may be used in conjunction with the cover system and/or cover sheet thereof. Exemplary force generating members may include at least one elastic unit which may be arranged to couple with the cover member and/or door, to receive energy and store at least a portion thereof while being deformed from an unstressed position to a stressed position, and then to release the stored energy, while returning itself back to the unstressed position. In general, such an elastic unit may include one or more conventional springs examples of which may include, but not be limited to, cylindrical or conical coil springs, flat or curved spiral springs, leaf springs, torque springs, torsion bars, and so on. The spring may be a compression spring to be compressed in the stressed position or an extension spring to be stretched or elongated in its stressed position. The spring may be a constant force spring with a constant spring constant or a variable spring with a spring constant which varies with its length. The elastic unit may further include other elastic elements such as, e.g., cross-curve materials, snap tapes, stampings, extension round wires, compression or tension round wires, and so on (all available from Vulcan Springs Work, Telford, Pa.). The force generating member may also include at least one viscous unit which is arranged to couple with the cover member, door, and/or elastic unit, to receive energy, and to dissipate at least a portion thereof during its movement. The viscous unit may include at least one viscous dash pot, and examples of such units may include, but not be limited to, shock absorbers, fluid dampers, liquid die springs, and the like (all available from Taylor Devices, Inc., North Tonawanda, N.Y.). FIGS. 8A through 8C show exemplary embodiments of guide members and their guides according to the present invention.

In one exemplary embodiment, FIG. 8A is a schematic view of an exemplary force regenerating member exhibiting an exemplary complementary relation (or synchronization) according to the present invention. An exemplary cover system 200 typically includes at least one slidable cover member 308, a force generating member 500, and a housing 396. Such a slidable cover member 308 may have the slidable cover sheet 381, holder 382, first end 388, and second end 389 as exemplified in FIGS. 6A to 6E, while the housing 396 defines an inner space to retain an unexposed portion of the cover sheet 381 therein. The holder 382 may be implemented to one end of the housing 396 and arranged to allow movements of such a cover sheet 381 along a covering direction 383A and uncovering direction 383B therethrough. The exemplary force generating member 500 is disposed between the housing 396 and second end 389 of the cover sheet, and may include a pair of the foregoing elastic units 510 such as, e.g., the cylindrical coil springs, and at least one viscous unit 530 such as, e.g., the dash pot, in which one end of each of the elastic and viscous units 510, 530 is coupled to the housing 396, whereas the other end of each unit 510, 530 is coupled to the first end 388 of the cover member 308 50 that such units 510, 530 may be pulled or stretched to their stressed position by an external force applied by the user or actuator member, and then returned to their unstressed position thereafter.

In operation, when the door is kept in its closed position, the slidable cover member 308 and its cover sheet 381 are disposed in their off-position, and the elastic and viscous units 510, 530 thereof are disposed in their unstressed position in which they do not exert any force onto the slidable cover member 308. As the cover member 306 and its cover sheet 381 begin to move from their off-positions toward their on-positions along the covering direction 383A by the covering force which is generated by the operator or actuator member, the elastic units 510 receive energy associated with the covering force and store at least a portion of the energy while being stretched or elongated along the covering direction 383A. Therefore, the elastic units 510 may begin to exert a recoil force by pulling the cover member 308 and sheet 381 back to their off-positions along the uncovering direction 383B. When the cover sheet 381 moves to its on-position by the covering force (which of course exceeds the recoil force for the time being) and covers a preset portion of the target space, the elastic units 510 extend to their stretched positions, store at least a portion of the energy in proportion to the lengths extended beyond their unstressed lengths, and exert the recoil force. After a preset period of time or when the cover system 200 receives an uncovering signal issued by the operator and/or actuator member, the elastic units 510 may release the stored energy and begin to exert the recoil force, thereby pulling the slidable cover sheet 381 toward its off-position along the uncovering direction 383B. Therefore, such elastic units 510 of the force generating member 500 may provide at least a portion of the uncovering force according to the complementary relation to the covering force directly or indirectly supplied by the operator or actuator member. As the cover member 308 and sheet 381 reach their off-positions, the elastic units 510 may reach their unstressed positions and cease to exert the recoil force or, in the alternative, may not reach such unstressed positions but apply the recoil force of a lot less magnitude because of restoration of at least substantial portions of their lengths beyond the unstressed position, thereby uncovering the preset portion of the target space. When the force generating member 500 includes the optional viscous unit 530, the covering and/or uncovering movements of the cover sheet 381 may be adjusted or altered based upon the characteristics of the elasticity of the elastic units 510 and viscosity of the viscous unit 530 so as to exhibit overdamped, critically damped or underdamped characteristics.

In another exemplary embodiment, FIG. 8B describes a schematic view of another exemplary force regenerating member exhibiting another exemplary complementary relation (or synchronization) according to the present invention. An exemplary cover system 200 may include at least one rollable cover member 308, force generating member 500, and housing 396. The rollable cover member 308 in turn has a rollable cover sheet 361, a roller 362, a holder 382, and a second end 389 as exemplified in FIGS. 5A to 5E, while the housing 396 and holder 382 are typically identical or similar to those of FIG. 8A. More particularly, the roller 362 is retained in the housing 396 and along a length thereof to allow the rollable cover sheet 361 to roll thereonto and therefrom. The exemplary force generating member 500 also includes at least one elastic unit 510 such as the flat spiral spring or torque spring disposed in one end of the roller 362 and rotating about a longitudinal axis 364 of the roller 362. Therefore, the elastic unit 510 may be wound to its stressed position and unwound to recoil back to its unstressed position. The cover system 200 also includes at least one guide bar 369 disposed apart from the roller 362 and along the longitudinal axis 364 and guiding the rollable cover sheet 361 in a preset elevation. It is appreciated that the elastic unit 510 may include other conventional elastic articles such as, e.g., cylindrical coil springs, conical coil springs, and the like.

In operation, the rollable cover member 306 and sheet 361 are disposed in their off-positions, while the elastic unit 510 is disposed in its unstressed position. As the cover sheet 361 begins to be pulled away from the roller 362 toward its on-position along a covering direction 363A by a covering force, the spring of the elastic unit 510 is wound toward its stressed position while storing at least a portion of the energy of the covering force and exerting a recoil force in a direction opposite to such a covering direction 363A. As the cover sheet 362 moves to its on-position and covers a preset portion of the target space, the elastic unit 510 is also wound to its stressed position, stores a greater portion of the energy, and exerts a stronger recoil force. When the covering force ceases to apply, such an elastic unit 510 releases the stored energy in order to pull the cover sheet 362 toward its off-position along an uncovering direction 363B. Thereafter, the rollable cover sheet 362 returns to its off-position and uncovers the preset portion of the target space when the recoil unit 510 consumes all of stored energy or when the second end 367 is restrained by the holder 382. Further configurational and/or operational characteristics of the force regenerating member 500 of FIG. 8B are similar or identical to those of FIG. 8A.

In another exemplary embodiment, FIG. 8C is a schematic view of yet another exemplary force regenerating member for another exemplary complementary relation (or synchronization) according to the present invention. An exemplary cover system 200 includes at least one stackable cover member 304, a force generating member 500, and a housing 396. The stackable cover member 304 includes multiple stackable cover sheets (or sheds) 341, a holder 382, and a second end 344 as exemplified in FIGS. 4A to 4F, while the housing 396 and holder 382 are typically identical or similar to those of FIGS. 8A and 8B. The exemplary force generating member 500 includes a pair of elastic units 510 such as cylindrical coil spring or elastic string which may be fixated between the housing 396 and the second end 344 of the cover member 304 and coupled to at least some of the cover sheds 341 therethrough or thereon. Therefore, the elastic units 510 may be stretched and extend to their stressed positions or unstretched and recoil back to their unstressed positions. The force generating member 500 also includes one or more regulators 353A, 3538 to regulate mode of stacking and/or unstacking of such stackable cover sheds 341. For example, a first regulator 353A may be arranged to collect and push the cover shed 341 on top of the stack, to bias such a stack downward in order to increase a friction force between the cover sheds 341 and stack, and/or to provide a force resisting the covering force, thereby preventing such sheds 341 in the stack from being partially unstacked by the covering force. In contrary, a second regulator 353B may be arranged to catch outgoing edges 354 of the cover shed 341 on top of the stack, to provide the resistance force, and/or to regulate the unstacking of the shed 341. Accordingly, the cover shed 341 disposed on top of the stack may be unstacked only when the covering force may exceed the resistance forces generated by the regulators 353A, 353B. The first and second regulators 353A, 3538 may be provided with additional features to keep such resistance force within a preset range. For example, the first regulator 353A may have an adjustable height so that the downward force may be kept at a similar or identical value. The second regulator 353B may also have an adjustable height in order to maintain a similar or identical height of the cover shed 341. The housing 396 may include a spring (not shown in the figure) fixated to its bottom face to upwardly push the stack of the cover sheds 341 such that the shed 341 disposed on top of the stack may be in direct contact with the regulators 353A, 353B. In addition, such regulators 353A, 353B may engage only when the cover sheds 341 may move to unstack along a covering direction 342A and disengage when the cover sheds 341 move to stack along an uncovering direction 342B. Such an embodiment may facilitate the stack and/or unstacking of the cover sheds 341.

In operation, the stackable cover member 304 and cover sheds 341 are disposed in their off-positions, while the elastic unit 510 is disposed in its unstressed position. As the top cover shed 341 of the stack is pulled away out of the stack toward its on-position along a covering direction 342A by a covering force, the regulators 353A, 353B move the next cover shed 342A to the top of the stack. When the covering force continues to pull the second end 344 along the covering direction 342A, the next cover shed 341 unstacks and moves along the same direction 342A. The sequential unstacking of the cover sheds 341 continues until the stackable cover member 304 moves to its fully on-position and at least a substantial number of cover sheds 341 unstack out of the housing 396 and/or when the operator or actuator ceases to apply the covering force. During the covering movements of the cover member 304, the elastic unit 510 begins to be wound toward its stressed position and store at least a portion of the energy of the covering force, while exerting a recoil force along a direction opposite to the covering direction 342A. When the cover sheds 341 move to their on-positions to cover a preset portion of the target space, the elastic unit 510 is also wound to its stressed position, stores a greater portion of the energy, and exerts a stronger recoil force. As the covering force ceases to apply, the elastic unit 510 releases the stored energy so as to pull the cover sheds 341 back to the stack along the uncovering direction 342B. Thereafter, the stackable cover member 304 returns to its off-position and uncovers the preset portion of the target space when the recoil unit 510 consumes all of stored energy or when the second end 367 is restrained by the holder 382. Further configurational and/or operational characteristics of the force regenerating member 500 of FIG. 8C are similar or identical to those of FIGS. 8A and 8B.

Configurational and/or operational variations and/or modifications of the above embodiments of the exemplary cover systems having the foregoing force regenerating members described in FIGS. 8A through FIG. 8C also fall within the scope of this invention.

First of all, the force generating member may include any number (including zero) of the above elastic and viscous units. When multiple elastic and/or viscous units are provided, such units may be mechanically coupled to each other in series and/or parallel fashions so as to provide desirable force storing and/or releasing characteristics. Disposition of the elastic and/or viscous units may also vary depending upon selection of such force storing and/or releasing characteristics, detailed configuration of the cover system, and so on. Thus, such elastic and/or viscous units may be disposed outside the housing, along multiple sections of the cover member, between the holder and first end of the cover member, and so on.

The force generating members including various conventional elastic and/or viscous units may be disposed in various positions of the cover system, door, and/or article. The elastic and/or viscous units of such a force generating member are generally disposed along the covering and/or uncovering directions thereof so as to utilize the covering and/or uncovering forces to move the force generating member along the stressed and/or unstressed directions. When the force generating member has at least one conventional force transmitting device, however, such elastic and/or viscous units thereof may also be aligned off the covering and/or uncovering directions. As long as at least a portion of the covering and/or uncovering forces may be transmitted to the force generating member and the stored energy may be delivered from the force generating member to the cover member, detailed alignment of the viscous and/or elastic units may not be material to the scope of the present invention.

The force generating member may also be arranged to include multiple force generating units coupled to each other in series and/or parallel fashions or, alternatively, the cover system may include multiple force generating members to provide desirable force storing and/or releasing characteristics. Detailed configuration and/or arrangements of such multiple force generating members and/or multiple force generating units thereof, therefore, may not be critical to the scope of the present invention as long as such a member may be arranged to provide at least a portion of the energy required for one of the covering and uncovering forces.

Such an elastic unit may be arranged to store and release the energy by various embodiments. For example, the elastic unit may be triggered to recoil (e.g., extending from its compressed stressed position or retracting from its stretched stressed position) and release such stored energy in order to provide the covering force in response to one or more events such as, e.g., when the door begins to open, when the operator or object enters the target space, when the cover member receives the user input signal, and the like. The elastic unit may then be arranged to recoil to their unstressed position and to consume all or at least a substantial portion of energy stored therein as the cover sheet moves to its fully on-position and covers the preset portion of the target space. The elastic unit may also be triggered to be stressed (e.g., extended, stretched or compressed toward its stressed position) and begin to store the energy in response to one or more events supplying energy thereto such as, e.g., when the door begins to close, when the operator or object leaves the target space, when the cover member receives another user signal, and so on. The elastic unit may then deform to its fully stressed position and store a maximum amount of such energy as the cover sheet moves to its fully off-position and uncovers the preset portion of the target space, thereby getting ready to supply another covering force for the next cycle. In a reverse example, the elastic unit may be arranged to store energy while recoiling to its unstressed position, and to release such stored energy while deforming to its stressed position.

Contrary to the foregoing embodiments, the force generating member may also be arranged in a reverse fashion such that the elastic unit thereof may be compressed (or stretched) to its stressed position when the cover member is in its off-position and recoil back to its unstressed position when the cover member is in its on-position. Furthermore, the elastic unit may also be arranged to have its unstressed position when the cover member is disposed between its on- and off-positions or when the door is disposed between its open and closed positions. In the alternative, the elastic unit may be arranged to be in a partially stressed or unstressed position as the cover member is in its off- or on-position. Thus, selection of the unstressed and/or stressed positions of the force generating member is not generally critical to the scope of the present invention as long as the force generating member is arranged to store at least a portion of the energy supplied thereto by the user or actuator member and to release the stored energy to generate at least a portion of the covering or uncovering movement of the cover member. In general, designers may select one of the operating modes of the above force generating members so that he or she may arrange the force generating member to release the stored energy to automatically move the cover member from its on- to off-position or vice versa.

The foregoing elastic units may have configurations different from those described heretofore. For example, the elastic unit may include at least one elastic structure which may include non-elastic materials arranged to exhibit apparent elasticity through such a structure. When desirable, the force generating member may include at least one break unit arranged to lock the elastic unit in its stressed position such that the elastic unit may hold its energy stored therein. As the brake unit receives the user command to release such energy, such a unit may disengage the elastic unit to allow release of such energy therefrom and to generate the covering or uncovering movement of the cover member. Detailed configurations of such a break unit generally depend upon operational and/or configurational characteristics of the cover member.

Conventional mass-spring-dash pot analogs may be employed to simulate and design desirable dynamic characteristics of the cover member so that its cover sheet exhibits desirable displacements, speeds, accelerations, and/or oscillations which may be at least partially determined by, e.g., masses of the cover member and/or door, spring constants of the elastic unit, viscosities of the viscous unit, and so on. Accordingly, the elastic and/or viscous units may be connected in series or in parallel with each other and any desirable number of such units may be included in the force generating member. It is appreciated that any elastic units may be disposed in almost any locations of the cover systems, that such elastic and/or viscous units may be employed in any number or arrangement as far as such units may generate at least a portion of one of the covering and uncovering forces in response to the other of such forces, and that such units may not interfere the covering and uncovering movements of the cover member and/or opening and closing movements of the door. It is further appreciated that the force generating member may not require any viscous unit when the door-door opening assembly includes at least one door check to dampen the movements of the cover member and/or door.

In another aspect of the present invention, a cover system may include various guide members arranged to couple with the foregoing cover members and to support and/or to guide the above cover members during their covering and/or uncovering movements. When desirable, the guide member may be specifically arranged to facilitate the spatial relation between the foregoing cover members and the door and/or target space. Such a guide member typically includes one or more guides arranged to be fixedly coupled to the door and/or article or, in the alternative, to extend and retract according to one of the above spatial relations to the opening and/or closing movements of the door and/or to the preset portion of the target space. In the latter embodiment, the guides may be arranged to extend along the covering direction in order to guide the foregoing cover members from their off- to on-positions and/or to retract along the uncovering direction in order thereto. Depending on the desirable covering and/or uncovering directions, such guides may be arranged to move along, transverse to or at a preset angle with respect to such covering and uncovering directions. Following FIGS. 9A to 9J denote exemplary embodiments of guide members and their guides for facilitating the spatial relation (or synchronization) of the cover member with the door and/or target space.

For example, FIGS. 9A and 9B are schematic views of an exemplary guide member including horizontally and arcuately sliding guides which are respectively disposed in their off-position and on-position according to the present invention. An exemplary guide member 400 includes a first part 411, a second part 421, and multiple guides 431 one ends of which may be fixedly coupled to the first part 411, while the other ends of which may be movably coupled to the second part 421 through holes 432 provided in appropriate portions of the second part 421. The exemplary guides 431 may be arcuately curved and arranged in parallel with each other and, accordingly, the holes 432 may also be arranged to be arcuately curved and to extend across an entire width of the second part 421. It is appreciated that configurations of the guides 431 may also depend at least partially upon covering and uncovering movements of the cover member so that, e.g., the curved guides 431 of the exemplary guide member 400 are suitable to support and/or guide the cover member moving along the arcuate covering and/or uncovering directions (or paths). The guide member 400 may include at least one optional stopper 451 disposed in one end of each guide 431 and arranged to restrain the movement of the guide 431.

In operation, the first and second parts 411, 421 are disposed adjacent to each other in an off-position of the guide member 400 such that substantial portions of the guides 431 are disposed behind the second part 421 and generally inside the interior of the article (not shown in the figure). When the first part 411 begins to move directly by the operator and/or along with the door which may be moved by the operator and/or actuator member apart from such a second part 421 along an arcuate covering direction 441, the guides 431 may move with the first part 411 along the same direction by sliding out through the holes 432. When the door moves to its (fully) open position, the guides 431 also move to their (fully) on-position in which substantial portions of the guides 431 are exposed between the first and second parts 411, 421 while guiding and supporting the foregoing cover members, cover sheets, and/or cover sheds. As the first part 411 begins to move back from its on-position to its off-position toward the second part 421, the guides 431 also move along an arcuate uncovering direction 442 by sliding inwardly into and beyond the second part 421 through the holes 432. It is appreciated that the guide member 400 may perform different functions depending upon coupling modes between such a guide member 400 and the cover sheets or sheds. For example, the guides 431 may be arranged to merely mechanically support the cover sheet or shed by being disposed thereunder but without being affixed thereto. The cover sheet or shed may then slide over the guides 431 along the covering and uncovering directions 441, 442 while being supported and guided thereby. Such guides 431 may be arranged to extend from the off-position to the on-position before the movement of the cover sheet or shed by a preset period, immediately before such a movement, during the movement, immediately after the movement or after such a movement by a preset period. In the alternative, the guides 431 may be arranged to be woven through or otherwise at least partially movably coupled to the cover sheet or shed to support and/or guide the cover sheet or shed. In such an embodiment, the movements of the guides 431 may also be temporarily synchronized with the movements of the door but not necessarily simultaneous therewith. In the alternative, such guides 431 may be affixed to, glued to or otherwise incorporated into the cover sheet or shed to move in unison therewith. The second part 421 may then be provided with a slit or an opening elongated along the length of the second part 421 (instead of the holes 432) through which the guide-cover sheet (or shed) assembly may slide through.

In another example, FIGS. 9C and 9D are schematic views of another exemplary guide member having horizontally and arcuately moving guides which are respectively retracted in their off-position and extended in their on-position according to the present invention. An exemplary guide member 400 similarly includes a first part 411 and a second part 421 both of which are identical to those of FIG. 9A and 9B. The guide member 400 may include multiple guides 433 arranged to extend and retract similar to a conventional antenna, to be disposed parallel to each other, to be fixedly coupled to the first part 411, and to be movably coupled to the second part 421 through multiple holes 432 provided in such a second part 421. Contrary to the holes of FIGS. 9A and 9B, the holes 432 of FIGS. 9C and 9D do not traverse across a width of the second part 421. Rather, such holes 432 extend into the second part 421 by a preset distance which may be just enough so as to retain one end of each guide 433 therein. Therefore, such guides 433 disposed in their off-position do not hang behind the second part 421, but at least substantial portions thereof are to be retained inside the holes 432 after being retracted down to their uncovering lengths. Such guides 433 may be arranged to be curved in order to accommodate such curved covering and/or uncovering movements along the covering and/or uncovering directions 441, 442. Further configurational and/or operational characteristics of the guide member 400 of FIGS. 9C and 9D may be similar or identical to those of FIGS. 9A and 9B, except that the guides 433 of FIGS. 9C and 9D change the lengths of their exposed portions through their movements along their covering and uncovering directions 441, 442.

In another exemplary embodiment, FIGS. 9E and 9F are schematic views of an exemplary guide member including horizontally extending guides in their off- and on-positions, respectively, according to the present invention. An exemplary guide member 400 also includes a first part 411 and a second part 421 both of which are identical to those of FIG. 9A through 9D. The guide member 400 may also include multiple guides 434 arranged to be disposed parallel to each other, to be fixedly coupled to the first and second parts 411, 421, and to fold and unfold at or around their middle portions respectively in off- and on-positions thereof. When desirable, such guides 434 may be arranged to fold and unfold in other portions thereof as far as they may attain different lengths in their off- and on-positions so as to guide the cover member moving between their off- and on-positions.

In operation, the first and second parts 411, 421 are disposed adjacent to each other in an off-position of the guide member 400 so that such foldable guides 434 may be kept folded and unexposed between the first and second parts 411, 421. When the first part 411 begins to move by the operator or along with the door in an arcuate covering direction 441 and apart from the second part 421, such guides 434 begin to unfold and move outward with respect to the door and/or target space. When the first part 411 moves to its (fully) open position, the foldable guides 434 may also move to their (fully) on-position where substantial portions thereof extend and are exposed between the first and second parts 411, 421 to guide and support the foregoing cover members, cover sheets, and/or cover sheds. As the first part 411 begins to move back to its off-position toward the second part 421, such guides 434 also move along an arcuate uncovering direction 442 by being folded inwardly between the first and second part 411, 421. Other configurational and operational characteristics of the guide member 400 of FIGS. 9E and 9F may be similar or identical to those of FIGS. 9A to 9D.

In another exemplary embodiment, FIGS. 9G and 9H describe schematic views of an exemplary guide member having vertically extending guides in their off- and on-positions, respectively, according to the present invention. An exemplary guide member 400 includes a first part 411 and a second part 421 both of which are identical to those of FIG. 9A to 9F. The guide member 400 also includes multiple guides 435 which are similar to those of FIGS. 9E and 9F but arranged to fold outward while exposing at least portions thereof in their off-positions. Other configurational and/or operational characteristics of the guide member 400 of FIGS. 9G and 9H may be similar or identical to those of FIGS. 9A to 9F.

In another exemplary embodiment, FIGS. 91 and 9J are schematic views of an exemplary guide member with vertically and upwardly sliding guides respectively disposed in their off-position and on-position according to the present invention. An exemplary guide member 400 includes a first part 411 and a second part 421 both of which are similar to those of FIG. 9A through 9H, however, the second part 421 defines multiple channels 424 disposed along an axial direction thereof and arranged to have cross-sections shaped and sized to slidingly pass guides 436 therethrough, while twisting the guides 436 in an upright fashion by about 90 degrees therealong in a covering direction 441 and then twisting such guides 436 by the same angle but in an opposite direction along an uncovering direction 442. In order to accommodate such twisting configurational changes, the guides 436 may include ot be made of at least one rigid or elastic material which may be curved at a desirable curvature. Therefore, such guides 436 are preferably disposed horizontally behind the second part 421 in their off-positions, and then vertically and upwardly in front of the second part 421 in their on-positions. It is appreciated that such guides 436 may have different arcuate lengths and/or curvatures in order to accommodate the movement paths having different lengths.

In operation, the first and second parts 411, 421 are disposed adjacent to each other in an off-position of the guide member 400 such that substantial portions of the guides 436 are disposed behind the second part 421 extending at least substantially horizontally. As the first part 411 begins to move apart from the second part 421 directly by the operator or along with the door moved by the operator and/or actuator member along the arcuate covering direction 441, the guides 436 may move with the first part 411 along the same direction while sliding out through the second part 421 and being twisted thereby about 90 degrees. When the first part 411 moves to its (fully) open position, such guides 436 also move to their (fully) on-position in which substantial portions of the guides 431 extend vertically and upwardly to the highest elevation while guiding and supporting the above cover members, cover sheets, and/or cover sheds. As the first part 411 begins to move back to its off-position toward the second part 421, the guides 436 also move along the arcuate uncovering direction 442 while sliding through the channels 424, while being twisted again in the opposite direction by 90 degrees from the upright arrangement to the horizontal arrangement. When desirable, end portions of the guides 436 may be arranged to be rolled, folded, stacked, and/or otherwise deformed in order to save the space required for the unexposed portion of the guides 436 inside the article. Further configurational and/or operational characteristics of the guide member 400 of FIGS. 9I and 9J may also be similar or identical to those of FIGS. 9A to 9H.

Configurational and/or operational variations and/or modifications of the above embodiments of the exemplary cover systems having the foregoing guide members described in FIGS. 9A through FIG. 9J also fall within the scope of this invention.

Such guides of the guide member may be arranged to have various shapes, sizes, mechanical and/or chemical properties, and so on. Such guides may have identical or different configurations and such configurations may be uniform or vary along their lengths or widths. As described above, such guides may be fixedly or movably coupled to the cover member, cover sheet, and/or cover shed. For example, such guides may be fixedly oe movably woven through the cover members as exemplified in FIGS. 3F. 4F. 5E. and 6E or may be coupled thereto by other conventional devices in order to support and guide the cover member or sheet thereby. In such an embodiment, the movements of the guides are typically temporally and/or spatially synchronized with those of the door and/or cover member, but not necessarily simultaneously therewith. Such guides may be affixed to, glued onto or otherwise incorporated into the cover member such that the guides may move in unison with the cover member between their on- and off-positions. Therefore, such guides and cover member may fold and unfold, stack and unstack, roll and unroll, or slide in and out together. The second part of the guide member may be provided with a slit or opening instead of the holes or channels through which the guide-cover sheet assembly may move. It is appreciated that the cover system may not require any guide member when such a cover sheet may be arranged to have sufficient rigidity and/or configurations providing sufficient integrity capable of withstanding their weights, weights of precipitation, wind force, and so on. The guide members may also be arranged to move between their on- and off-positions according to one of the foregoing spatial and/or complementary relations. Alternatively, the guide members may be arranged to operate without resorting to any of the foregoing temporal, spatial, and complementary relations.

The foregoing guide members may be arranged to be in one of the above temporal relations to the covering and/or uncovering movements of the cover member. For example, in an embodiment with the cover member coupled to the door and article, the guides may move simultaneously with the door and/or cover member. In the alternative, the guides may be arranged to first extend out horizontally or vertically, and the cover member may be unfold, unstacked, unrolled or sliding out after or immediately after the guides move from their off-positions to their on-positions. Thereafter, the guides may retract horizontally or vertically before, simultaneous with or after the uncovering movements of the cover member. In another embodiment where the cover member is coupled to the article but not to the door, the guide member and/or their guides may be arranged to extend out horizontally or vertically prior to the covering movement of the cover member and/or opening movement of the door and to retract after the uncovering movement of the cover member and/or closing movement of the door. The guides may also be arranged to move in different temporal relations, e.g., simultaneously with or after the covering movement of the cover member and/or before or simultaneously with the uncovering movement of the cover member. In any of these embodiments, the guide members and their guides may also operate between their on- and off-positions by conventional on-off devices and/or by the sensor members.

The above covert member may also be incorporated into the guide member in order to generate various movements of the guide member. Such a convert member may be incorporated directly to the guide member so as to provide the covering and uncovering movements of the convert member which may be different from the opening and closing movements of the door, the covering and uncovering movements of the cover member, and the like. Such a convert member may include conventional gear units in order to change a speed and/or direction of the movements of the cover member and/or door. For example, the convert unit may move the guide member at a higher or lower speed than the door or cover member, may alter the direction of the movements of the door to a desirable direction of such a guide member, and the like. The convert member may include at least one elastic unit and/or at least one viscous unit so as to attain desirable viscoelastic responses and/or to change transfer functions such as, e.g., a ratios of an input movement of the door to an output movement of the guide member. It is appreciated that such a convert member may also be used to alter the direction and/or speed of the movements of the door, and to generate the movements of the cover member with the desirable direction and/or speed therefrom.

The above guide members may be arranged to include an arbitrary number of guides therein. Thus, such a guide member may include more than two linear and/or curved guides in order to support and guide the cover member thereby. In the alternative, the guide member may include a single guide for the same purpose. As far as the guide member may properly guide and support the movements of the cover member, detailed number of the guides or their configurational or operational characteristics may not be material to the scope of the present invention.

In another aspect of the present invention, the foregoing cover members (including their cover sheets and/or sheds) may be arranged to move between their off- and on-positions by various force sources driving such cover members along the covering and uncovering directions (or paths). Such force sources may include the operator of the cover member and/or door, various actuator members which may be any of the electrical, mechanical, pneumatic, or magnetic type as described heretofore, foregoing force generating members, and a combination thereof.

In one exemplary embodiment, such a cover system may be arranged to receive the covering and/or uncovering forces from the operator thereof. For example, the cover system may include an on-off device capable of activating and deactivating the cover member in order to cover and uncover the preset portion of the target space. An exemplary on-off device may include a mechanical handle or lever manipulatable by the operator such as those conventionally employed as handles or levers of windows or sunroofs of various vehicles. With such a device, the operator may provide both of the covering and uncovering forces to the cover member. Another exemplary device may be arranged to allow the operator to provide only one of the covering and uncovering forces, while the other of such forces may be provided by the operator moving the door, actuator member, force generating member, and the like. In such an embodiment, the cover member may not be coupled to the door and/or article, because the operator may move the cover member independent of the movements of the door. Thus, the cover member may or may not move according to the foregoing temporal and/or complementary relations to the door.

In another exemplary embodiment, the cover system may be arranged to receive the covering and/or uncovering forces from the operator of the door. To this end, the cover member may typically be coupled to the door and/or article in order to receive at least a portion of energy of the opening or closing forces applied to the door by the operator. Therefore, when the operator moves the door, he or she may provide one of the opening and closing forces of the doors which may in turn provide one of the covering and uncovering forces of the cover member. The cover system may be arranged to receive only one of such forces, while the other of such forces from the operator moving the cover member, actuator member, and/or force generating member as described above. It is appreciated that the coupling between the cover member and door renders their movements interdependent such that the cover member may move according to one of the foregoing temporal relations.

In yet another embodiment, the actuator member may also be arranged to provide the covering and/or uncovering forces for the cover member to provide the covering and/or uncovering movements of such a cover member along the covering and/or uncovering directions (or paths). Examples of the actuator members may include, but not be limited to, electrical motors or actuating devices, mechanical or pneumatic actuating devices, magnetic actuating devices, and the like. The actuator member may be activated and/or deactivated by a command signal issued by the operator. In this context, the above embodiment may merely amount to an automatic counterpart of the manual on-off device as described above.

The actuator member may or may not be in the temporal and/or complementary relations to the movements of the door and/or disposition of the target space. In the alternative, the actuator member may be activated and/or deactivated based upon the opening and/or closing movements of the door or the positions of the door. To this end, the cover system may include at least one sensor unit including one or more sensors as described heretofore. Therefore, the actuator member is activated to move the cover member to its on-position along the covering direction upon detecting the opening movement of the door, and then deactivated to move the cover member to its off-position along the uncovering direction upon detecting the closing movement of the door. The precise timings of the covering and/or uncovering movements of the cover member may be adjusted to precede, to coincide with or to follow the opening and/or closing movements of the door, respectively. Accordingly, the cover member may be in the temporal relations to the door movements and/or disposition of the target space.

In another alternative, such an actuator member may be activated and/or deactivated based on the presence and/or absence of the operator and/or object in the target space. Such a cover system may also include at least one sensor member including one or more sensors to detect such presence and/or absence as described above. Thus, the actuator member may be activated to move the cover member to its on-position upon detecting such presence, while may be deactivated to move the cover member to its off-position upon detecting such absence. The timings of such movements of the cover member may be adjusted to precede, coincide with or follow the movements of the door according to one of the above temporal relations.

In yet another alternative, the actuator member may be activated and deactivated based upon the exterior weather conditions such as rain or snow. In this embodiment, such a cover system may include at least one sensor member to measure the precipitations, humidity, temperature, illumination, wind speed, and so on, as described heretofore. The actuator member may be activated to move the cover member to its on-position upon detecting one or more of such weather conditions and to its off-position upon detecting cessation of such weather conditions. It is appreciated that such an actuator member may be preferably used in conjunction with other sensors described above. For example, the motion sensor for detecting the movements of the door and the precipitation sensor for detecting the rain or snow may be used such that the actuator member is activated only when the door moves to its open position and when it rains or snow, but not activated when it does not rain or snow or when the door is kept in its closed position. The timings of the covering and uncovering movements of the cover member may be adjusted to precede, to coincide with or to follow the opening and closing movements of the door, respectively, according to the above temporal relations as well.

In yet another embodiment, the actuator member may be activated and deactivated based upon the timings of the movements of the doors and/or cover members, durations of the doors in their open and/or closed open positions, and/or durations of the cover members in their on- and/or off-positions. For example, the cover system may have at least one sensor member including one or more sensors for detecting the timings of such movements, durations, and so on. It is appreciated that the foregoing actuator member may be arranged to provide the covering and/or uncovering forces directly to such cover members or, alternatively, to provide the opening and/or closing forces directly to the the doors which may in turn deliver the covering and/or uncovering forces to the cover members. The actuator member may also be arranged to generate both of the covering and uncovering forces for the cover members. Alternatively, the actuator member may provide merely one of the covering and uncovering forces, while the cover system may be arranged to receive the other of the forces from the operator who moves the door and/or cover member, from the force generating member described above, and the like.

In yet another embodiment, the force generating member may also be arranged to provide such covering and/or uncovering forces in order to generate the covering and/or uncovering movements of the cover member along the covering and/or uncovering directions (or paths), where the details of the force generating members have been provided in conjunction with FIGS. 8A through 8C. Such a force generating member may also be used along with the actuator member such that the force generating member may receive at least a portion of the energy associated with the covering and/or uncovering forces, store the portion of the energy, and release such a portion of the energy to provide the other of the forces according to one of the above complementary relations. In the alternative, such a force generating member may receive at least a portion of the energy associated with such forces supplied by the operator, store the portion of the energy, and generate at least a portion of the other of such forces by one of the above complementary relations. As described above, the operator may supply the energy, e.g., through the opening and/or closing forces applied directly to the door and/or through the covering and/or uncovering forces applied directly to the cover member. It is preferred that such covering and/or uncovering forces generated by the force generating member be sufficient to move the cover member from one to the other of its on- and off-positions. When the force generated by the force generating member may not amount to the required value, the cover system may be arranged to receive a remaining portion of such forces from the operator, actuator member, and the like.

In another aspect of the present invention, the cover systems and/or their cover members or sheds may be coupled to the door and/or article by various modes. In one exemplary embodiment, the cover member may be coupled to both of the door and article, e.g., by coupling one end of the cover member to the door and the other end thereof to the article. The cover system may also include a first end and a second end, where one side of the first end is arranged to couple with one end of such a cover member, where the other side of the first end is arranged to couple with the door, where one side of the second end is arranged to couple with the other end of the cover member, and where the other side of the second end is arranged to couple with the article. In another exemplary embodiment, the cover member may be arranged to couple with only one or none of the door and/or article. In this embodiment, the cover system may include only one or none of the first and second ends. The cover system may also include at least one engaging unit for engaging and/or disengaging the cover member to or from the door such that the cover member may or may not move with the door, respectively. The engaging unit may be arranged to couple one end of the cover member to the door, thereby engaging the cover member to the movements of the door, and then uncouple such an end of the cover member from the door so as to disengage the cover member therefrom. When the cover system includes the first end, the engaging unit may couple the first end to the door in order to engage the cover member and then uncouple the first end from the door to disengage such. Such an engage unit may be used to engage and disengage the second end from the other end of the cover member.

Configurational and/or operational variations and/or modifications of the above embodiments of the exemplary cover systems described in FIGS. 1A through FIG. 9J further fall within the scope of the present invention.

The foregoing cover system may be manufactured as a part of a door-door opening assembly by being incorporated thereinto. Therefore, such a cover system may be arranged to form an unitary article with the door or may be fixedly incorporated thereinto. When desirable, the door-door opening assembly may be manufactured to include various coupling means which may later be used to install the cover system thereto. In the alternative, the cover system may be arranged to be retrofit into an existing door-door opening assembly of the vehicle or structure. In this embodiment, the cover system may be manufactured in various shapes and/or sizes in order to be fit into different models of vehicles and/or structure. The cover system may also be arranged to have an universal shape and/or size but to have an adjustable shape and/or size in order to be retrofit into different vehicles and/or structures. Thus, the cover member of such a cover system may be arranged to be folded or unfolded, stretched or unstretched, rolled or unrolled, cut or otherwise deformed to fit into the space of a preset shape or size. Other auxiliary members such as the guide members may similarly be arranged to have variable shapes, sizes, and/or operating ranges to this end.

It is appreciated that the above cover members including the cover sheets and sheds thereof, actuator members, force generating members, convert members, guide members, sensor members, and their constituent units may be used and/or combines interchangeably in order to provide various cover systems which may be generally different from those exemplified in this description. In addition, the cover system including the above members may be disposed or installed in locations in and around the article other than those described in this description. Numerous factors, however, may have to be considered in order to select a desirable location of the cover system and its various members and/or units, where examples of such factors may include, but not be limited to, the shapes and/or sizes of the target space, shape and/or sizes of the operator and/or object to be disposed in the target space, the shapes, sizes, and/or orientation of the door and movements directions (or paths) thereof, shapes and/or sizes and so on. Accordingly, the cover system may be coupled to various locations such as, e.g., between the top portion of the door and article, to the door but not to the article (i.e., preferably at a portion immediately above the door opening) but not to the door, to an additional support member which may be in turn coupled to the door and/or article, and so on.

The shapes and/or sizes of the foregoing members and/or units of the cover system may vary or be adjusted as long as the cover members may cover and uncover the preset portion of the target space. Thus, the cover members and their cover sheets (or sheds) may have any two-dimensional or three-dimensional shapes. In addition, such cover members and/or their sheets and/or sheds may move along the covering and/or uncovering directions which may be different from those described in the foregoing figures. For example, the foregoing cover sheets generally move with door away from the door opening along their covering paths and then move back toward the door opening along their uncovering paths. However, the cover members may also be arranged to move with the door away from the article along their covering paths and thereafter move further toward the door (e.g., into the housing or roller disposed at or adjacent to the door) along their uncovering paths. Accordingly, while the door moves to its closed position, the cover member may move to its off-position where the entire portion of the cover sheet thereof may be included on the door side. As the door is shut to its closed position, the cover member may engage the holder which is installed on the article and catch one end of the cover sheet or shed. Thereby, such a cover member becomes ready for the next opening of the door.

The foregoing cover sheets and/or sheds may define multiple openings or apertures thereon in order to provide air passages therethrough. The cover sheets and/or sheds may also include flaps in order to reduce hydraulic resistance thereof. These embodiments offer the benefit of stabilizing such cover sheets (or sheds) against winds as well as preventing the cover sheets (or sheds) from being accidentally flipped over by the winds. The cover sheets (or sheds) may also be arranged to define fluid passages thereon for facilitating disposal of water precipitated thereon. The fluid passages may be provided not only on their surfaces but also around the cover system or other desirable locations. A caution should be given to the cover system such that its cover sheet (or sheds) is not damaged by sudden movements of the door. In particular, when the cover member is coupled to the door, sudden opening and/or closing movements of the door may not provide sufficient time interval for such cover members to move their cover sheets (or sheds), thereby tearing, breaking or otherwise mechanically damaging such sheets (or sheds). Accordingly, the cover system may include at least one elastic unit and/or viscous unit in series and/or in parallel with the cover members and/or doors in order to protect the cover system from such damages.

It is to be understood that, while various aspects and embodiments of the present invention have been described in conjunction with the detailed description thereof, the foregoing description is intended to illustrate and not to limit the scope of the invention, which is defined by the scope of the appended claims. Other embodiments, aspects, advantages, and modifications are within the scope of the following claims.

1. A cover system for a door-door opening assembly with at least one door and at least one door opening, said door movably coupling with an article and said door opening defined through said article, to be used as at least one of an entrance to an interior of said article and an exit to an exterior of said article, and to define a target space adjacent thereto, said cover system comprising:
at least one cover member which is configured to be installed to at least one of said door and article, to cover at least a portion of said target space when a person is placed in said portion of said target space, and to uncover said portion of said target space when said person is no longer in said portion of said target space.

2. The cover system of claim 1, wherein at least a portion of said cover member is configured to respectively fold and unfold so as to cover and uncover at least a portion of said target space.

3. The cover system of claim 1, wherein at least a portion of said cover member is configured to respectively roll and unroll so as to cover and uncover at least a portion of said target space.

4. The cover system of claim 1, wherein at least a portion of said cover member is configured to respectively stack and unstack in order to cover and uncover at least a portion of said target space.

5. The cover system of claim 1, wherein at least a portion of said cover member is configured to at least one of rotate, pivot, and slide between different positions thereof so as to cover and uncover at least a portion of said target space.

6. The cover system of claim 1, wherein at least a portion of said cover member is configured to respectively deform and then to restore its original configuration in order to cover and uncover at least a portion of said target space.

7. The cover system of claim 1, wherein said cover member is configured to provide at least one covering movement in a covering timing and at least one uncovering movement in an uncovering timing so as to cover and uncover at least a portion of said target space, respectively, wherein at least one of said covering and uncovering timings is configured to depend at least partially and respectively on at least one of an opening timing and a closing timing of movement of said door in order to unobstruct and obstruct at least a portion of said door opening, respectively.

8. The cover system of claim 1, wherein said cover member is configured to provide at least one covering movement along a covering path and at least one uncovering movement along an uncovering path so as to cover and uncover at least a portion of said target space, respectively, wherein at least one of said covering and uncovering paths is configured to depend at least partially and respectively on at least one of an opening path and a closing path of said door along which said door is configured to move to unobstruct and obstruct at least a portion of said door opening, respectively.

9. The cover system of claim 1, wherein said cover member is configured to provide at least one covering movement through a covering force and at least one uncovering movement by an uncovering force in order to cover and to uncover at least a portion of said target space, respectively, wherein at least a portion of one of said forces is configured to be at least partially provided by an opening force and a closing force of said door through which said door is configured to open and to close said door, respectively.

10. The cover system of claim 1 further comprising at least one first end and at least one second end, wherein said first and second ends are configured to couple with opposing ends of said cover member, wherein said first end is also configured to couple with said door, and wherein said second end is also configured to couple with said article.

11. The cover system of claim 1, wherein said cover member is configured to move between at least one on-position and at least one off-position in order to respectively cover and uncover at least a portion of said target space.

12. The cover system of claim 11, wherein at least a portion of said cover member is configured to be disposed at least one of above and next to said portion of said target space in said on-position and to be removed therefrom in said off-position

13. The cover system of claim 11, wherein said cover member is configured to be disposed in a plurality of said on-positions in at least two of which said cover member is further configured to cover different portions of said target space.

14. The cover system of claim 11, wherein said cover member is configured to generate at least one covering movement to be disposed to said on-position, and to generate at least one uncovering movement to be disposed in said off-position.

15. The cover system of claim 14, wherein at least one of said movements of said cover member is configured to be generated by an operator of at least one of said cover member and door.

16. The cover system of claim 1 further comprising at least one guide member configured to guide and support said cover member during its movement between said positions.

17. A door-door opening assembly comprising:
at least one door configured to movably couple with an article;
at least one door opening configured to be defined through said article, to be used as at least one of an entrance to an interior of said article and an exit to an exterior of said article, and to define a target space adjacent thereto; and
at least one cover member configured to be installed to at least one of said door and article, to cover at least a portion of said target space when an object is placed in said target space, and then to uncover said portion of said target space when said object is removed from said target space.

18. The assembly of claim 17, wherein said cover member is configured to move between at least one on-position and at least one off-position, to uncover at least a portion of said target space in said off-position, and to cover said portion of said target space in said on-position.

19. The assembly of claim 17, wherein said cover member is configured to move between at least one off-position for uncovering at least a portion of said target space and at least one on-position for covering said portion of said target space in at least one of a temporal, spatial, and complementary relation to said door which is configured to move between at least one open position for unobstructing at least a portion of said door opening and at least one closed position for obstructing said portion of said door opening.

20. A method of moving at least one cover member for covering and uncovering at least a portion of a target space defined adjacent to a door opening of a door-door opening assembly which includes at least one door and is installed to an article, said method comprising the steps of:
movably installing at least one cover member to at least one of said door and article;
moving at least a portion of said cover member toward said portion of said target space in at least one of a complementary, spatial, and temporal relation to at least one of said door, door opening, article, and target space; and
removing said portion of said cover member therefrom in at least one of said complementary, spatial, and temporal relation to said at least one of said door, door opening, article, and target space.
